(19) United States
(12) Patent Application Publication
(10) Pub. No.: US 2006/0105303 A1
(43) Pub. Date: May 18, 2006

(54) System and method for teaching a writing process

(76) Inventors: Leah Ames, Leoti, KS (US); Kelly Burgess, Charlotte, NC (US); Melinda Burgess, Charlotte, NC (US); Benjamin Alan Wilson, Charlotte, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 10/990,841

(22) Filed: Nov. 17, 2004

(51) Int. Cl. G09B 11/04; G09B 11/06

(52) U.S. Cl. 434/165

(57) ABSTRACT

A computer-based system and method, and a computer readable medium containing computer software, for teaching a writing process to a plurality of users. A writing process component provides to a user a plurality of writing type options and receives from the user a writing type selection. The writing process component receives from the user a writing topic selection for the writing type selection and receives from the user a first draft about a writing topic selection. Guidance is provided to the user for self evaluating the first draft and the user is prompted to revise the first draft responsive to the user's self evaluation. The revised first draft about the selected topic is received from the user and the user is prompted to wait a predetermined period of time. The user is prompted to read aloud the revised first draft to a second person and to obtain feedback from the second person responsive to the reading aloud of the revised first draft. The user is prompted to prepare a final draft by revising the revised first draft responsive to the feedback obtained from the second person, and the final draft about the selected topic is received from the user and stored. A user management component is provided for managing a plurality of users.

A portion of this disclosure contains material that is subject to copyright protection. The copyright owner consents to the reproduction of the disclosure, as it appears in the Patent and Trademark Office patent files or records, but otherwise reserves all copyright rights whatsoever.

### FIELD OF THE INVENTION

The present invention generally relates to a computer-based system and method for teaching a writing process.

### BACKGROUND OF THE INVENTION

There are many known systems and methods for teaching writing processes. Conventional methods tend to be teacher directed in terms of the content and the audience. Conventional methods of teaching writing typically use generic graphic organizers and the focus is on the first draft and the last draft of the written work product. Certain conventions are used in editing, and the teacher guides the process of revising the written work product and evaluating and assessing the final work product. The process for revising and editing of work product tends to be specific to a particular teacher, rather than being a uniform process regardless of the content of the written product or the grade level of the student. Students often disregard the corrections and suggestions on their teacher edited drafts, and are often confused by vagueness and inconsistencies in teacher comments.

In addition, conventional methods of teaching writing are limited to planning, writing and revising. This focuses on the first draft and the last draft but does not assist students in improving their writing. Other known methods for teaching writing are based on the steps of prewriting, writing, revising, editing, and publishing. These programs do not include all elements of steps that are necessary for effectively teaching writing nor do they use a web based system.

Thus, what is needed is a system and method for teaching the writing process that overcomes the disadvantages associated with known systems and methods. The system and method of the present invention is student directed in terms of the content and audience, and provides genre specific organizers. The system and method of the present invention allows students to evaluate, revise and edit the writing and is self-guided. The student and the teacher also can collaboratively evaluate and assess the writing work product using uniform guidelines, regardless of content or student's grade level.

### BRIEF DESCRIPTION OF THE DRAWINGS

FIG. 1 is a flow chart of the processing logic of an embodiment of the present invention.

FIG. 2 is a screen shot of an exemplary home page for the system and method of the present invention.

FIG. 3 is a screen shot of an exemplary main menu for the system and method of the present invention.

FIG. 4 is a screen shot of an exemplary web page for the prewrite, organize and write step for a haiku.

FIG. 5 is a screen shot of an exemplary web page for the prewrite, organize and write step for a diamante.

FIG. 6 is a screen shot of an exemplary web page for the prewrite, organize and write step for a limerick.

FIG. 7 is a screen shot of an exemplary web page for the evaluate and revise step for a poetry writing type option.

FIG. 8 is a screen shot of an exemplary web page for the wait step.

FIG. 9 is a screen shot of an exemplary web page for the read aloud and input step for a haiku.

FIG. 10 is a screen shot of an exemplary tackle final flaws step window for a poetry writing option.

FIG. 11 is a screen shot of an exemplary web page for the end with perfect copy step.

FIGS. 12A and 12B are screen shots of an exemplary web page for the prewrite, organize and write step for a persuasive essay.

FIGS. 13A and 13B are screen shots of an exemplary web page for the evaluate and revise step for a persuasive essay.

FIG. 14 is a screen shot of an exemplary web page for the read aloud and input step for nonpoetry writing options.

FIG. 15 is a screenshot of an exemplary tackle final flaws window for nonpoetry writing options.

FIG. 16 is a screen shot of an exemplary web page for the prewrite, organize and write step for a creative story.

FIGS. 17A and 17B are screen shots of an exemplary web page for the evaluate and revise step for a creative story.

FIG. 18 is a screen shot of an exemplary web page for the prewrite, organize and write step for a personal narrative.

FIGS. 19A and 19B are screen shots of an exemplary web page for the evaluate and revise step for a personal narrative.

FIG. 20 is a screen shot of an exemplary web page for the prewrite, organize and write step for an essay.

FIGS. 21A and 21B are screen shots of an exemplary web page for the evaluate and revise step for an essay.

FIG. 22 is a screen shot of an exemplary web page for the prewrite, organize and write step for a report.

FIGS. 23A and 23B are screen shots of an exemplary web page for the evaluate and revise step for a report.

FIG. 24 is a screen shot of an exemplary web page for the prewrite, organize and write step for a letter.

FIGS. 25A and 25B are screen shots of.an exemplary web page for the evaluate and revise step for a letter.

FIG. 26 is a screen shot of an exemplary web page for the read aloud and input step for a letter.

FIG. 27 is a screenshot of an exemplary tackle final flaws window for a letter.

FIG. 28 is a screen shot of an exemplary web page for the student/teacher assessment step.

FIG. 29 is an screen shot of an exemplary main menu to the User Management Component of the present invention.

### DETAILED DESCRIPTION

Reference will now be made in detail to the presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention cover such modifications and variations as come within the scope of the appended claims and their equivalents.

Also, as can be appreciated, the processing logic of the invention can be implemented with either software or hardware, or a combination of the two. That is, the specification provides sufficient information to those skilled in the art to implement the invention using one or more general purpose computers programmed with software, and/or one or more specialized devices using discrete circuitry.

The present invention brings together the writing process in a way that no other program does. It encompasses not only standard writing process steps but also ones that many teachers leave out because the text books do not put it into the writing process framework. While some textbooks might teach one or more of the steps of the method of the present invention, they do not teach all of the steps and they do not teach them within the framework of the present invention. Conventional methods for teaching a writing process are paper-based, which require students to navigate a handbook or textbook to find the sections that apply to the type of writing they are learning. It is difficult for students to remember each of the steps that are required in the writing. The system and method of the present invention holds the process together for the students and guides the students through the steps with strategies that are specific to the type of writing they are learning.

In a preferred embodiment, the system and method of the present invention can be implemented by an individual teacher, by a school for one or more teachers, or by a school system for one or more schools.

The system and method of the present invention uses a web browser and a web server for implementing the steps discussed above. The system and method is comprised of static and dynamic web pages. Static web pages are web pages that cannot be edited by the user and are useful for distributing information to the student. Dynamic web pages are forms based pages that have fields for text entry and/or selection checkboxes. Dynamic pages serve as workbooks or exercises that can be saved to or retrieved from a file server at any time.

The system and method of the present invention includes a writing process software component and a user management software component, each of which will be discussed in more detail below. The software components can be web applications developed using, for example, ColdFusion MX 6.1, which is a web application development platform available from Macromedia, Inc. of San Francisco, Calif.

The exemplary embodiment described is a client-server web application that uses HTTP as its transport protocol. Multiple remote clients can access the system via a web browser. While a client-server web application is one embodiment of the invention, as those skilled in the art can appreciate, the invention is not limited to the use of client-server architecture, and other software architectures are within the scope of the present invention.

1. The Writing Process Component

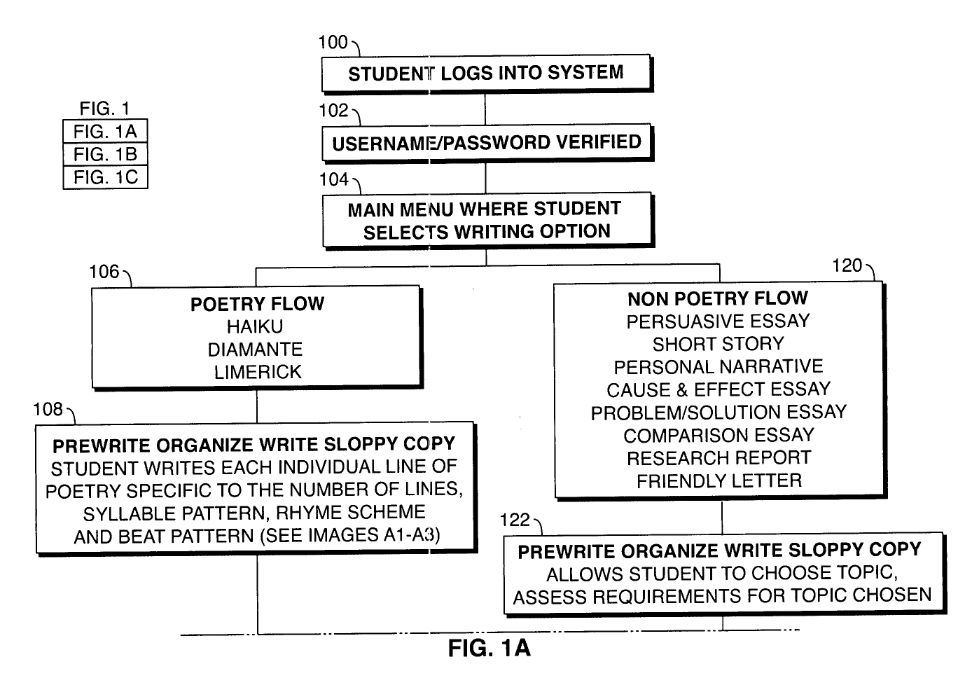

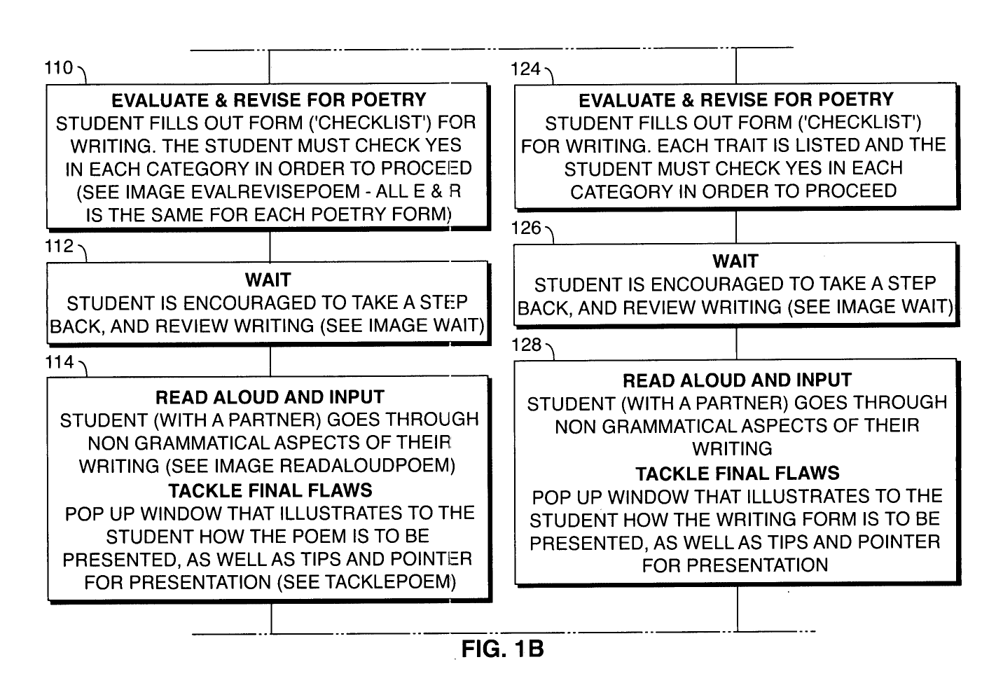

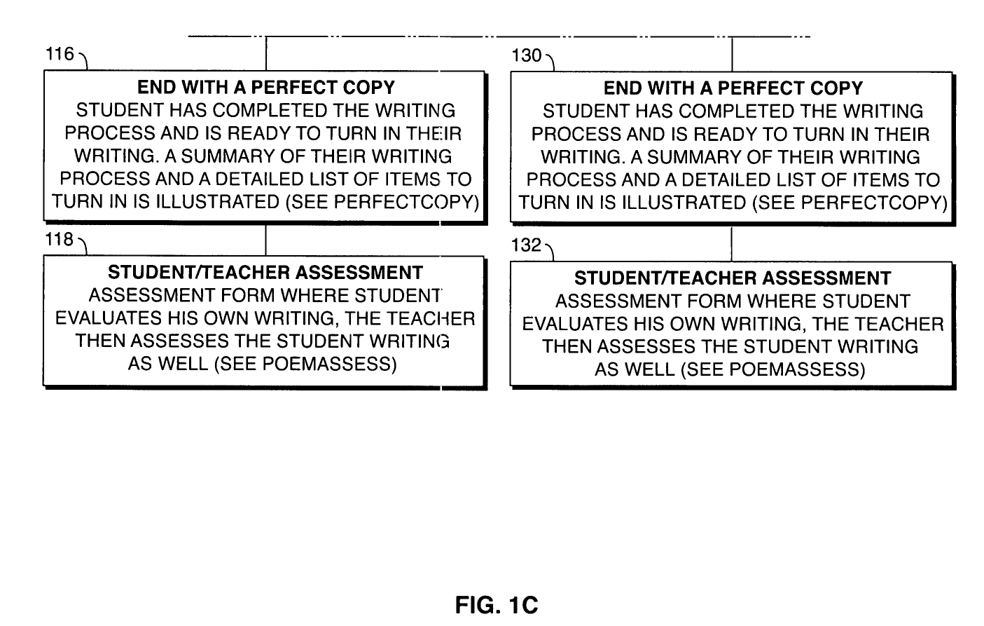

The processing logic for the Writing Process Component is illustrated in FIG. 1. In one aspect of the invention, the Writing Process Component runs on a web server, which is accessed by a user, such as a student, via a web browser.

As can be seen in FIG. 1, the system and method of the present invention for teaching a writing process includes the following steps: prewriting, organizing, writing a rough draft, evaluating, revising, waiting, reading aloud, obtaining input and feedback, and correcting final flaws, each of which is discussed in more detail below.

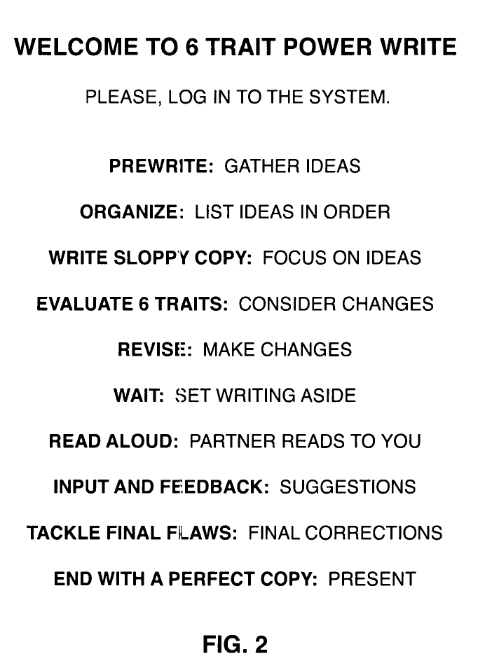

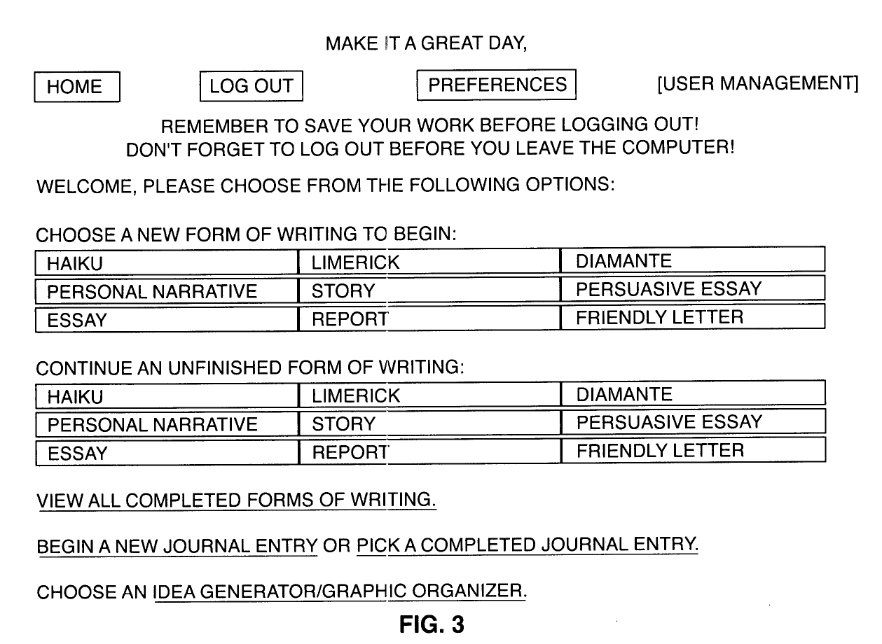

The user may access the system by entering a predetermined URL into the user's web browser, in which case the system will display a home page. A screen shot of an exemplary home page is illustrated in FIG. 2A. At the home page, and as can be seen from FIG. 1, a user (e.g., a student) logs into the system (block 100) by providing a user name and password. The username and password is verified (block 102) and a main menu is displayed, which is illustrated by FIG. 3. The main menu allows a user to select a writing option (block 103). In selecting among various writing options, a user may choose either to begin a new writing or to continue an unfinished, previously saved writing. The main menu also may be configured to allow a user, either a student or teacher, to access completed forms of writing, to begin a journal entry or to select an existing completed journal entry, or to choose an idea generator. The main menu may allow a user to set certain preferences, including username, password and time zone. Finally, the main menu may allow access to the user interface to the User Management Component, which is discussed in more detail below.

As illustrated in FIG. 1, after a user makes a writing option selection, the processing logic is bifurcated between a poetry flow (blocks 106-118) and a nonpoetry flow (blocks 120-132).

A. Poetry Flow

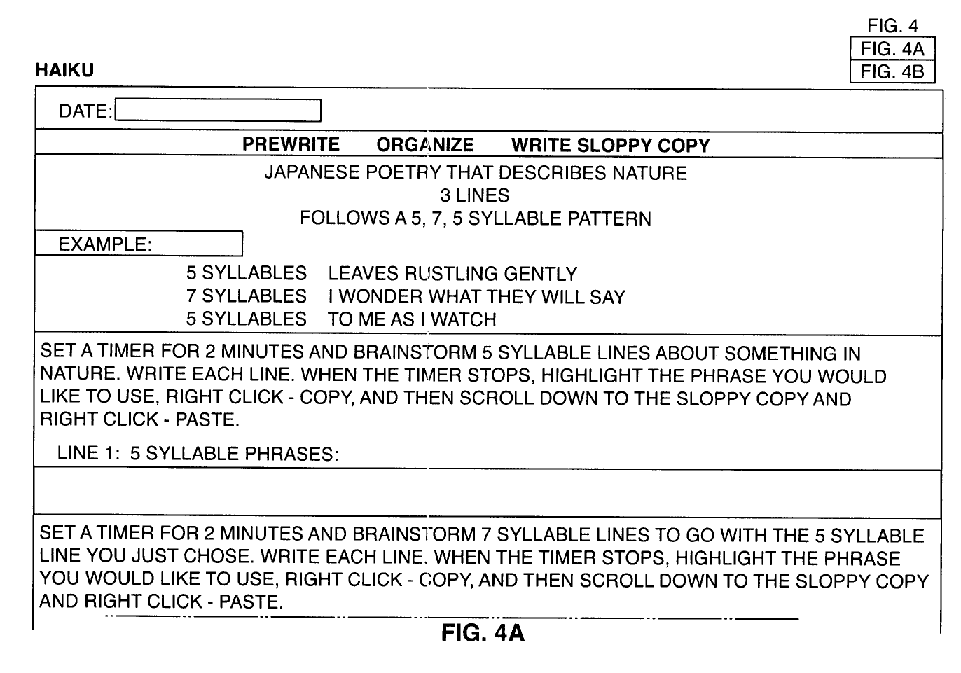

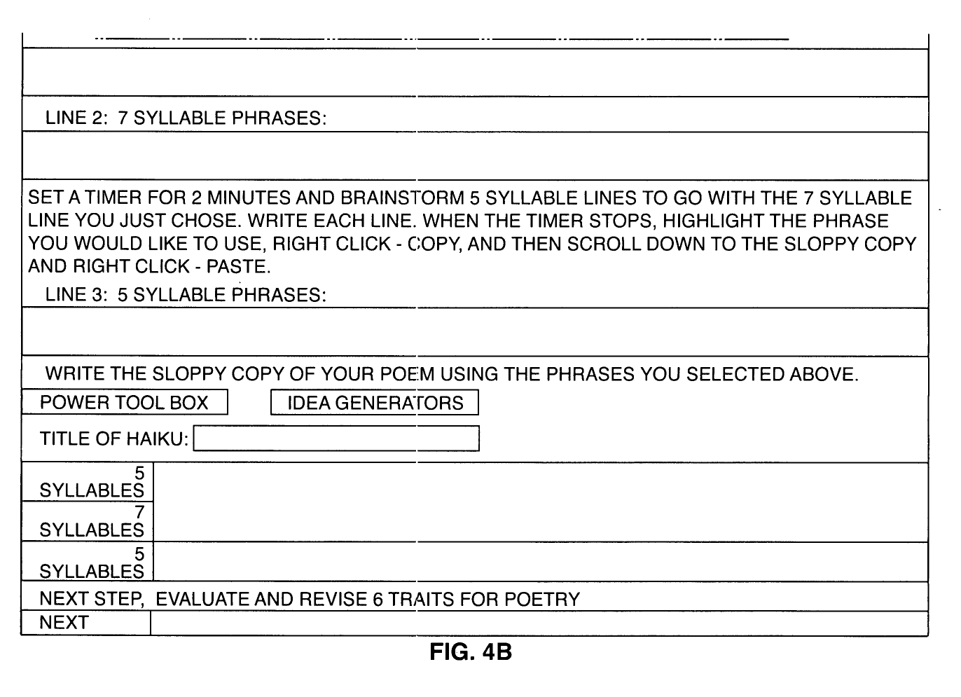

As illustrated by block 106, a user may select a poetry writing option, such as, a haiku, diamante, or limerick, after which processing control is transferred to block 108, which is the prewrite, organize and write step. If, for example, the user selects haiku, the system displays the prewrite, organize and write web page for a haiku, which is illustrated by FIG. 4. During the prewrite, organize and write step, the system uses a combination of static and dynamic web pages that assist a student in extracting and expressing their thoughts in the context of the writing option selected. For example, as shown in FIG. 2A, the web page provides an explanation of the selected poetry writing option and provides an example of a haiku. A user is then prompted to write as many 5-syllable phrases for line 1 as possible during a predetermined time period, and then to select one of the 5-syllable phrases for a rough draft. Similarly, the user is prompted to write as many 7-syllable phrases for line 2 as possible during a predetermined time period that are related to the 5-syllable phrase selected for line 1, and to then select a 7-syllable phrase for line 2. Finally, the user is prompted to write as many 5-syllable phrases for line 3 as possible during a predetermined time period that are related to the 7-syllable phrase selected for line 2, and to then select a 5-syllable phrase for line 3.

The system can be configured so that the user's input in connection with the prewrite, organize and write step is validated, and the user cannot proceed past the prewrite, organize and write step until such validation has occurred. For example, referring to FIG. 4, if the user does not enter a 5-syllable phrase for line 1, the user will not be allowed to proceed unless and until the user enters a 5-syllable phrase for line 1.

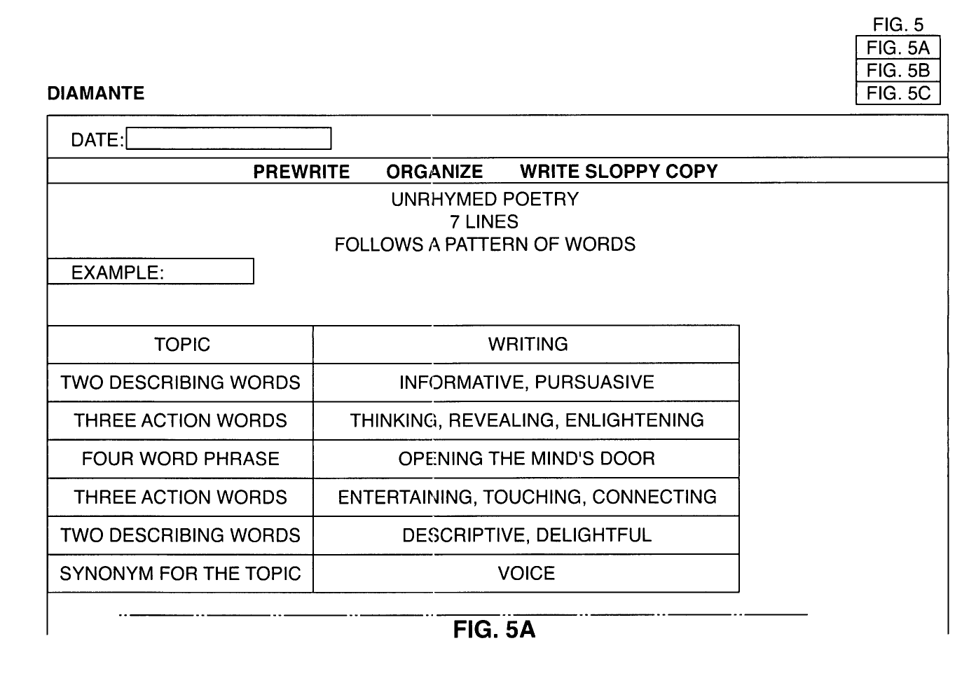

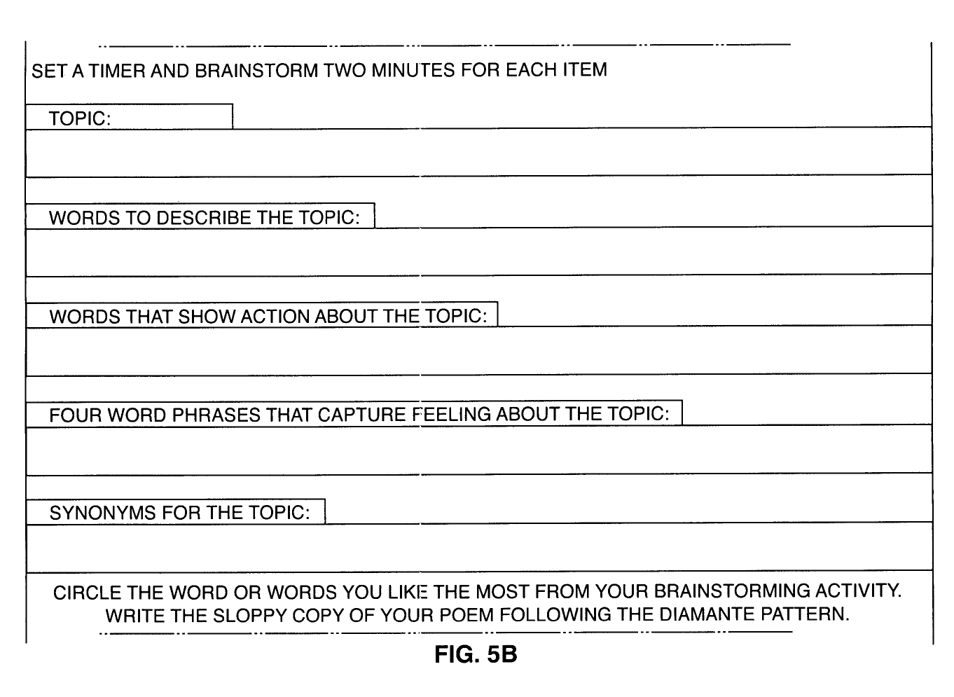

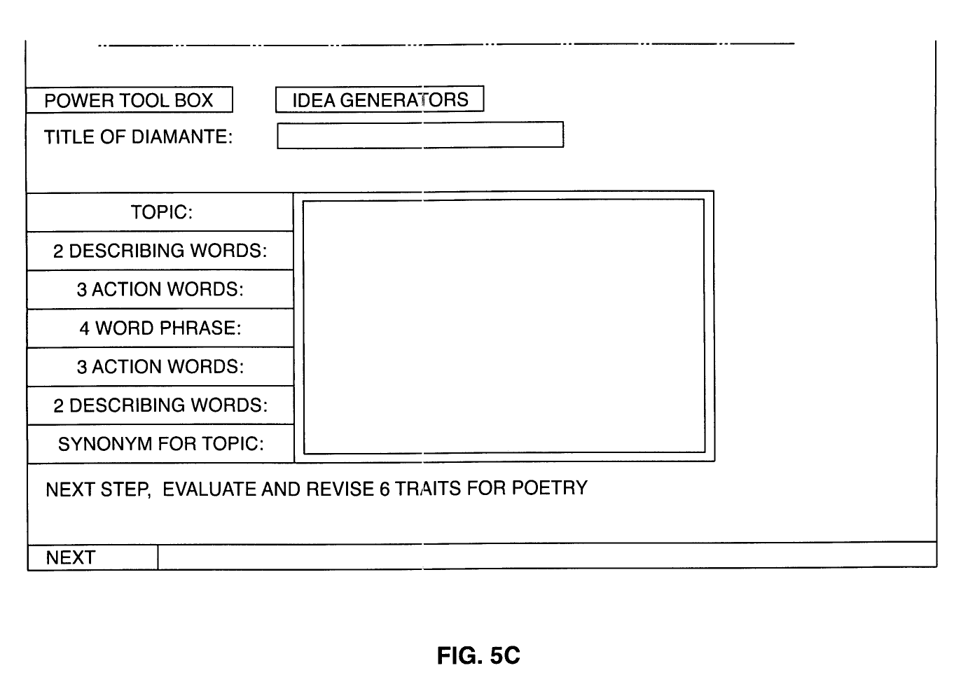

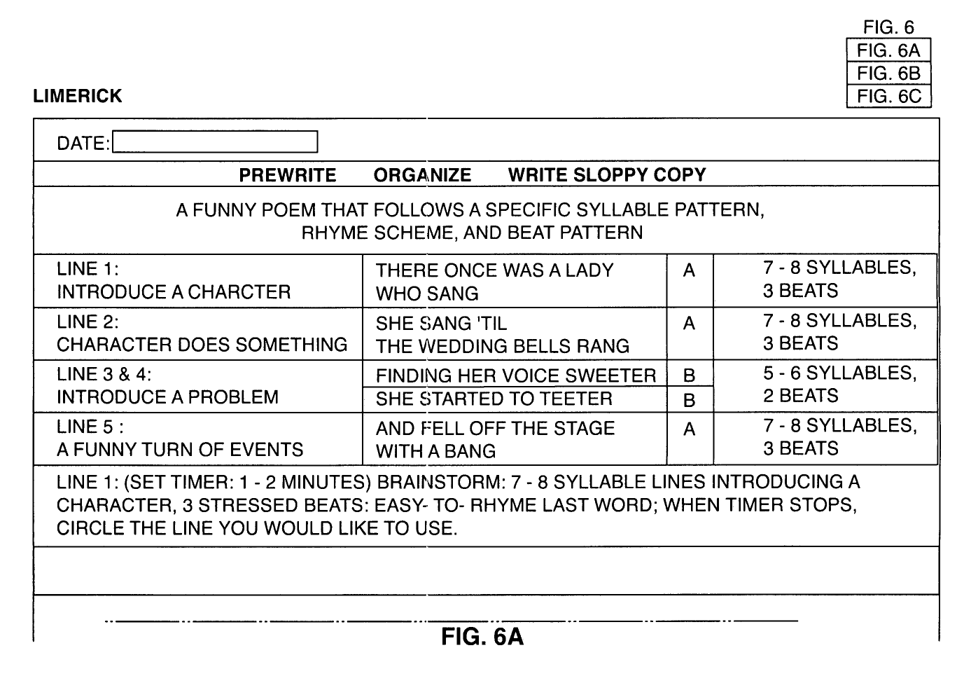

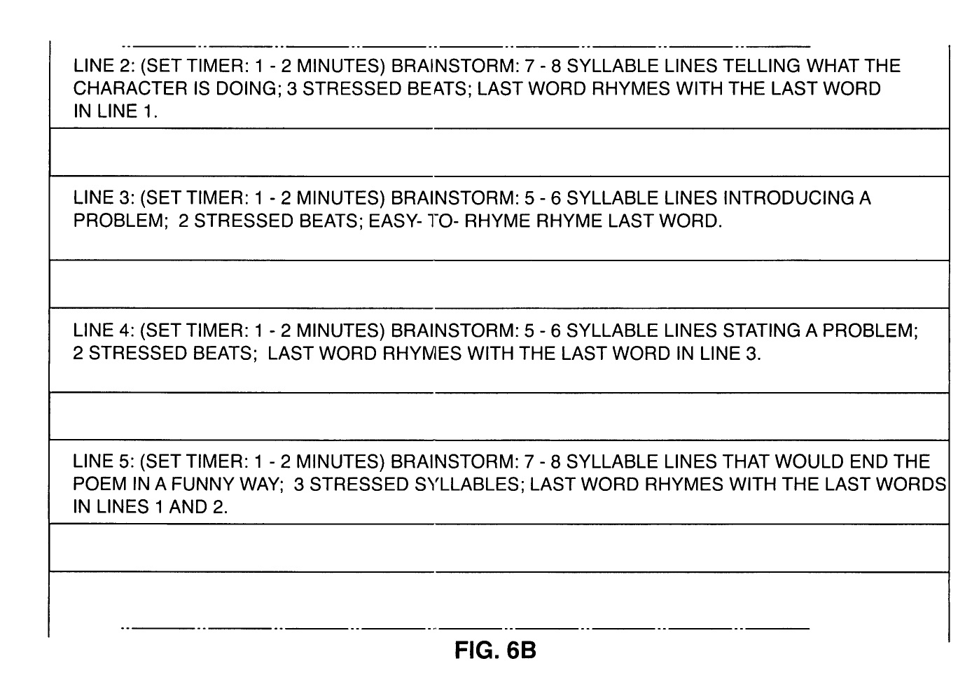

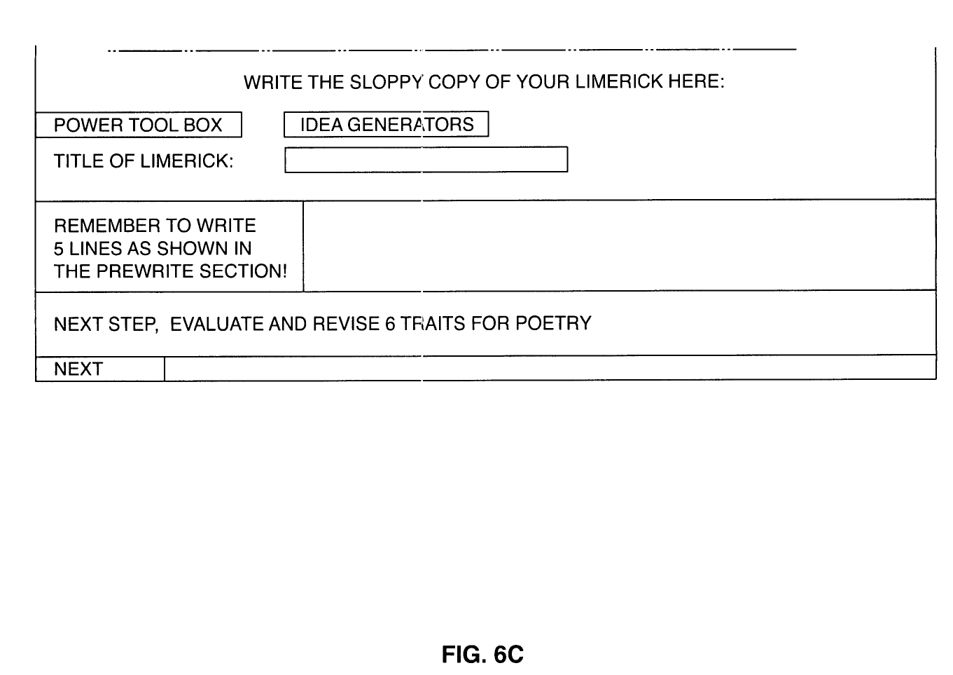

FIGS. 5 and 6 illustrate the web pages for the prewrite, organize and write step for a diamante and a limerick, respectively.

Returning to FIG. 1, after a user completes the prewrite, organize and write step (block 108) for the selected poetry writing option, the user may continue to the next step in the processing logic, which is the evaluate and revise step (block 110). The evaluate and revise step prompts a user to complete an evaluation form, or checklist, which is based on the 6 Trait method for evaluating writing. The 6 Trait method is available from the Northwest Regional Educational Library of Portland, Oreg. The same evaluation form may be used for a haiku, diamante or limerick.

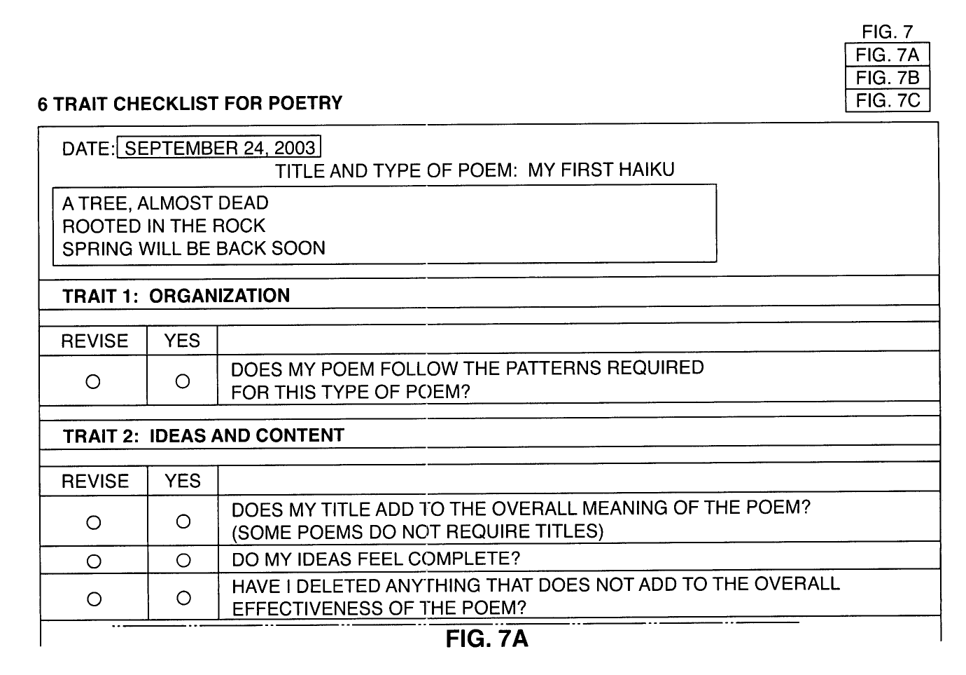

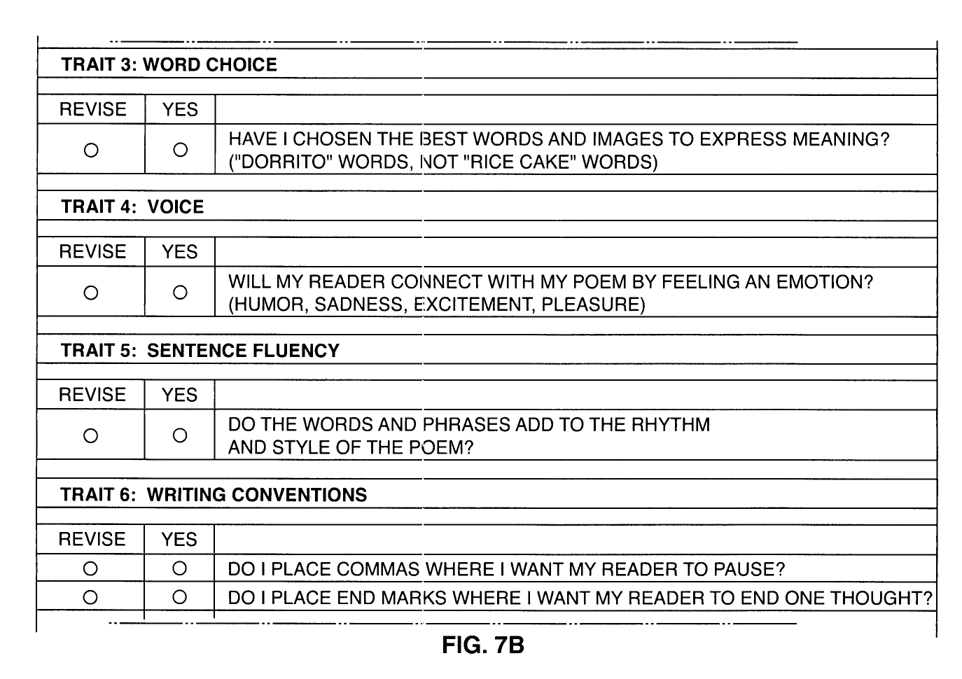

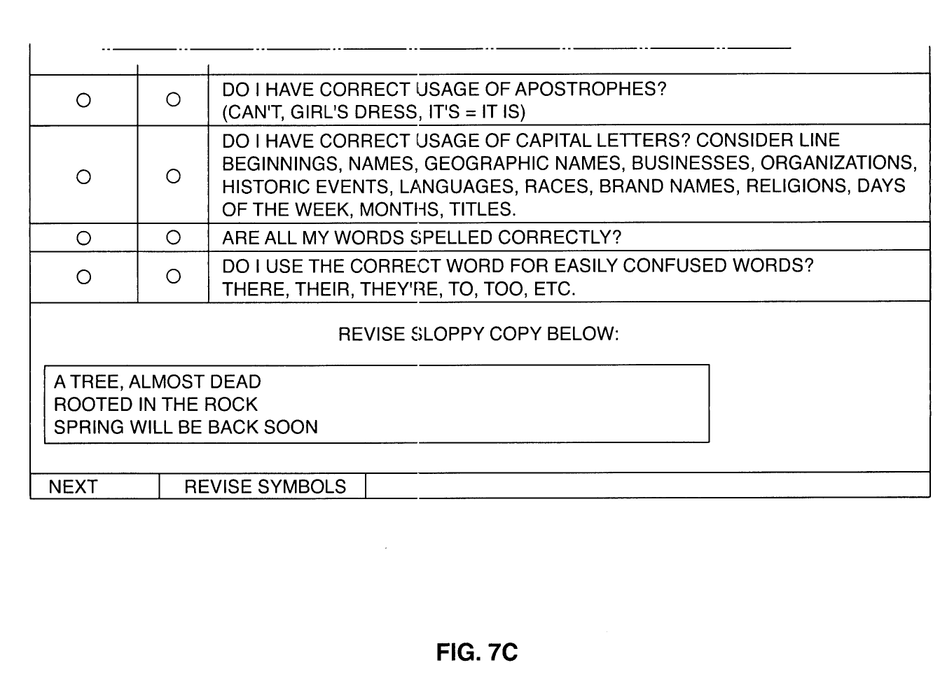

FIG. 7 illustrates an exemplary web page for the evaluate and revise step for a poetry writing option. As illustrated in FIG. 7, the evaluate and revise step uses the 6 Trait method of evaluating writing. The traits to be evaluated are organization, ideas and content, word choice, voice, sentence fluency and writing conventions. For each trait, the user is asked one or more questions about the rough draft and may be prompted to revise the rough draft based on the answers to the questions.

The system can be configured so that the user's responses to the questions asked in connection with the evaluate and revise step have been validated. For example, the system can be configured so that the user cannot proceed past the evaluate and revise step until all questions are answered properly and/or correctly. For example, referring to FIG. 7, if the user does not answer “yes” to the question “Does my poem follow the patterns required for this time of poem,” the user will not be allowed to proceed unless and until the poem does follow the required patterns and the user selects the “yes” option in answer to this question.

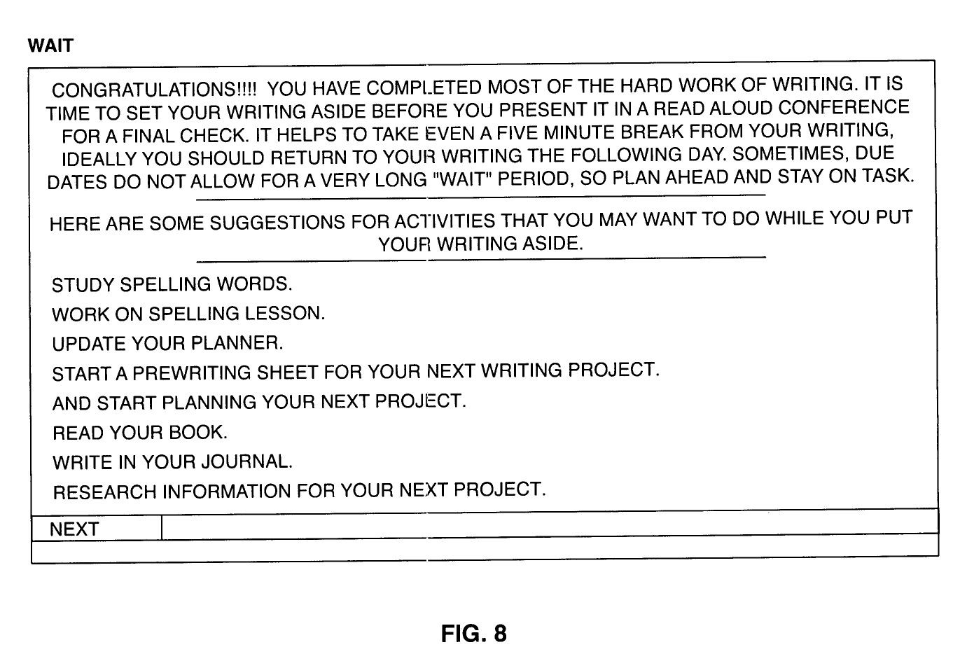

Returning to FIG. 1, after a user completes the evaluate and revise step (block 110) for the selected poetry writing option, the user may continue to the next step in the processing logic, which is the wait step (block 112). The wait step prompts a user to wait and then review the revised draft. FIG. 8 is a screenshot to an exemplary web page displayed during the wait step. As seen in FIG. 8, the web page may include suggestions for activities that a student may engage in during the wait step. The same web page for the wait step can be displayed for all writing options, both poetry and nonpoetry.

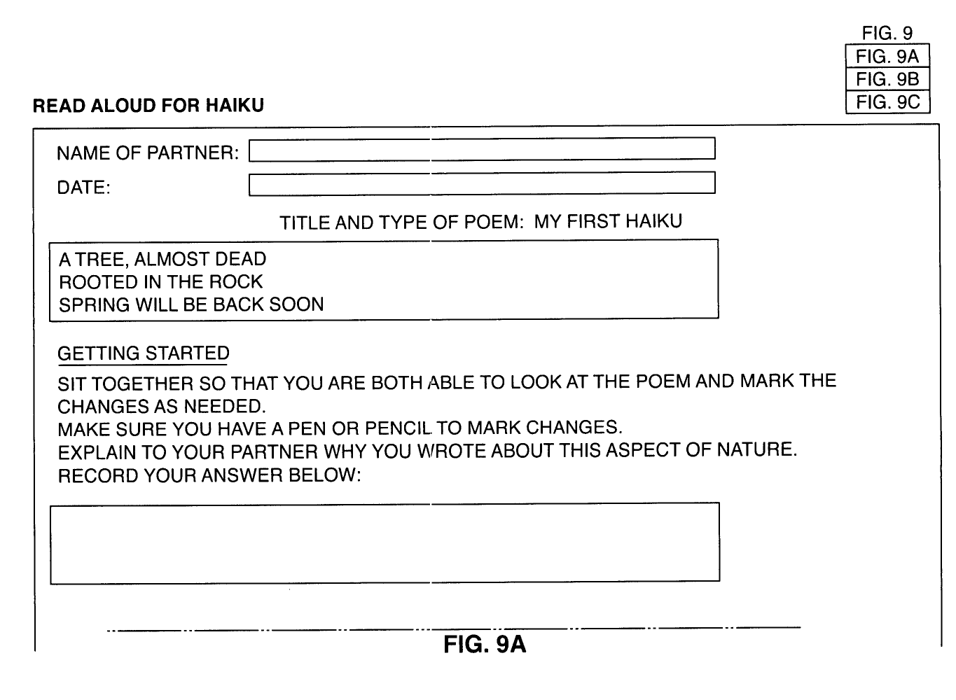

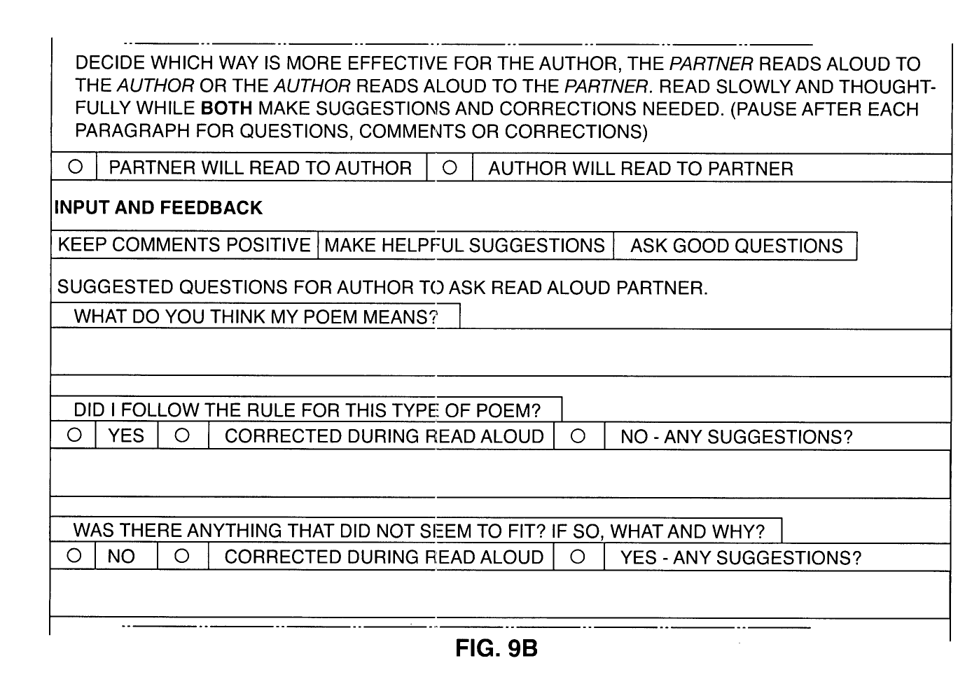

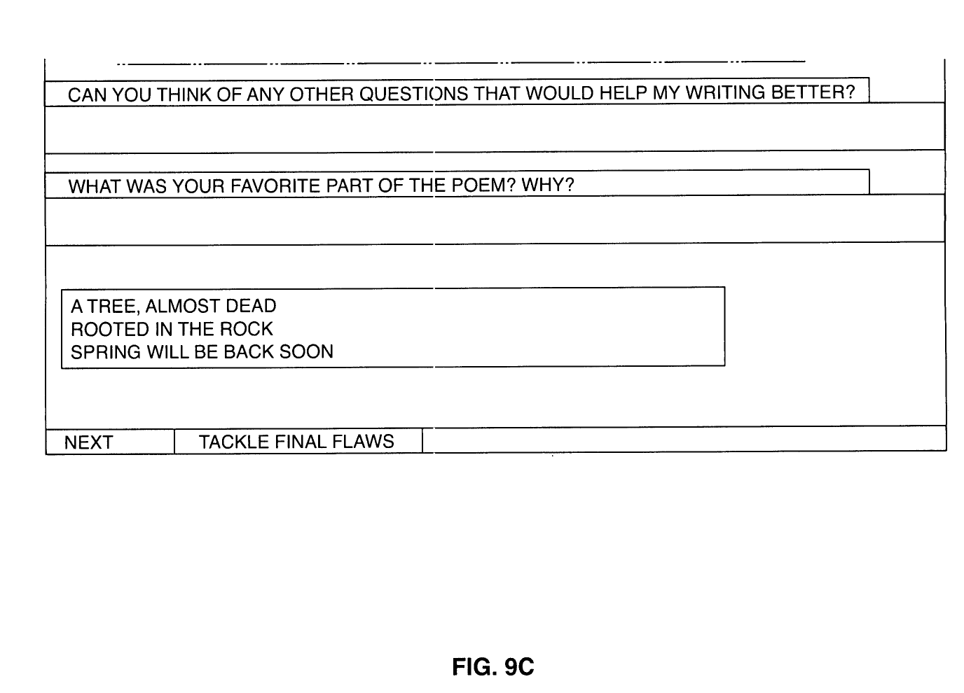

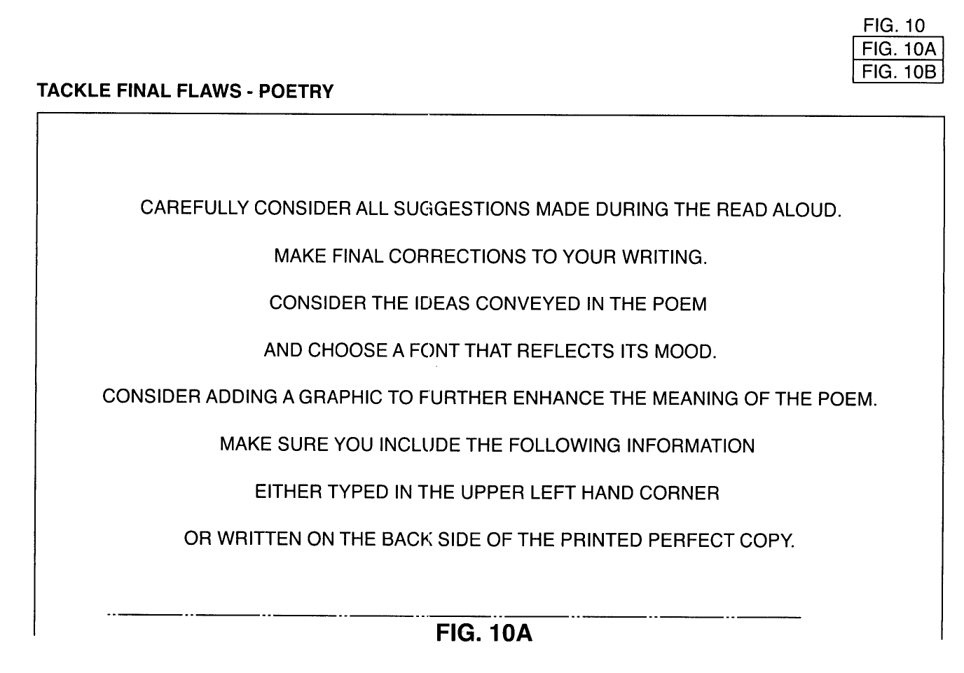

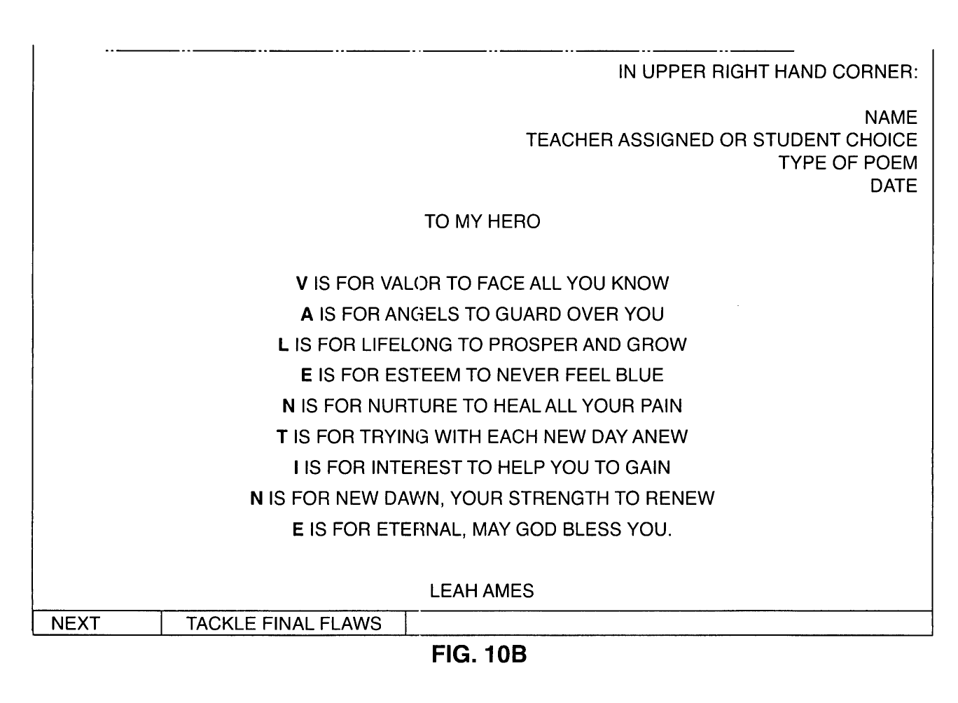

Returning to FIG. 1, after the wait step (block 112), the user may continue to the next step in the processing logic, which is the read aloud and input step (block 114). The read aloud and input step prompts the user to review the non grammatical aspects of the writing by reading the revised draft aloud to a partner and obtaining input and feedback from the partner based on a series of predetermined questions. FIG. 9 is a screenshot of an exemplary web page for the read aloud and input step for a haiku. As can be seen from FIG. 9, the read aloud and input web page allows for the entry of answers to the series of predetermined questions about the writing and revising the writing based on the input received. Similar web pages may be provided for the read aloud and input step for a diamante and a limerick. As can be seen from FIG. 9, the read aloud and input web page includes a button for tackling finalfinal flaws. Selecting the tackle finalfinal flaws button may cause a pop up window to be displayed that illustrates how the poem is to be presented, including tips and pointers for the presentation. FIG. 10 is a screenshot of an exemplary tackle finalfinal flaws window for a poetry writing type option.

The system can be configured so that the user's responses to the questions asked in connection with the read aloud and input step have been validated. For example, the system can be configured so that the user cannot proceed past the read aloud and input step until all questions are answer properly and /or correctly. For example, referring to FIG. 9, if the user does not provide an answer in response to the question “What do you think my poem means,” the user will not be allowed to proceed unless and until the user provides an answer to this question in the designated space.

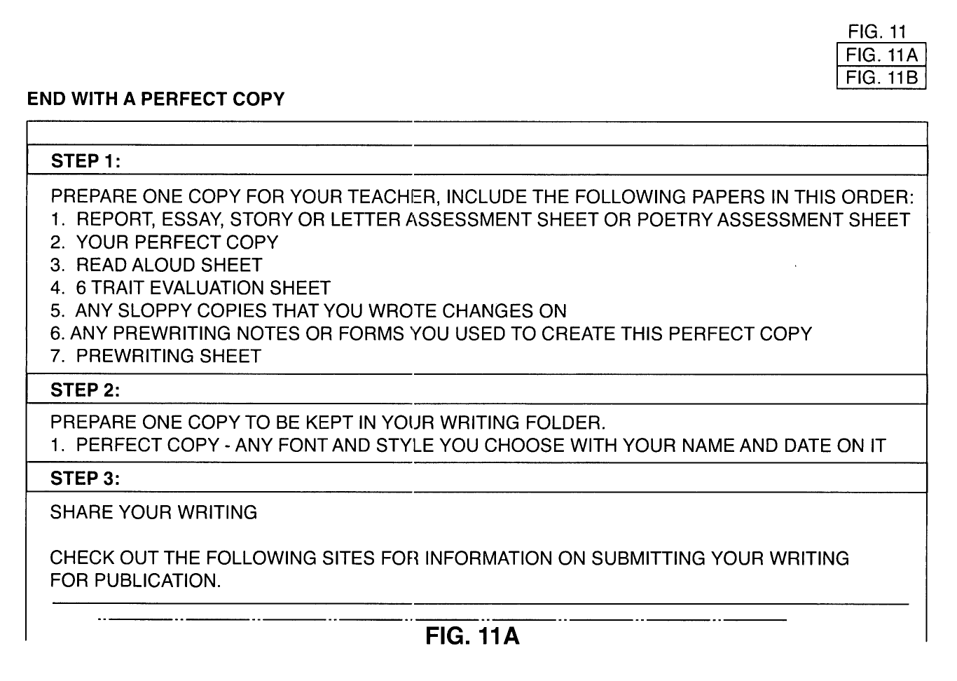

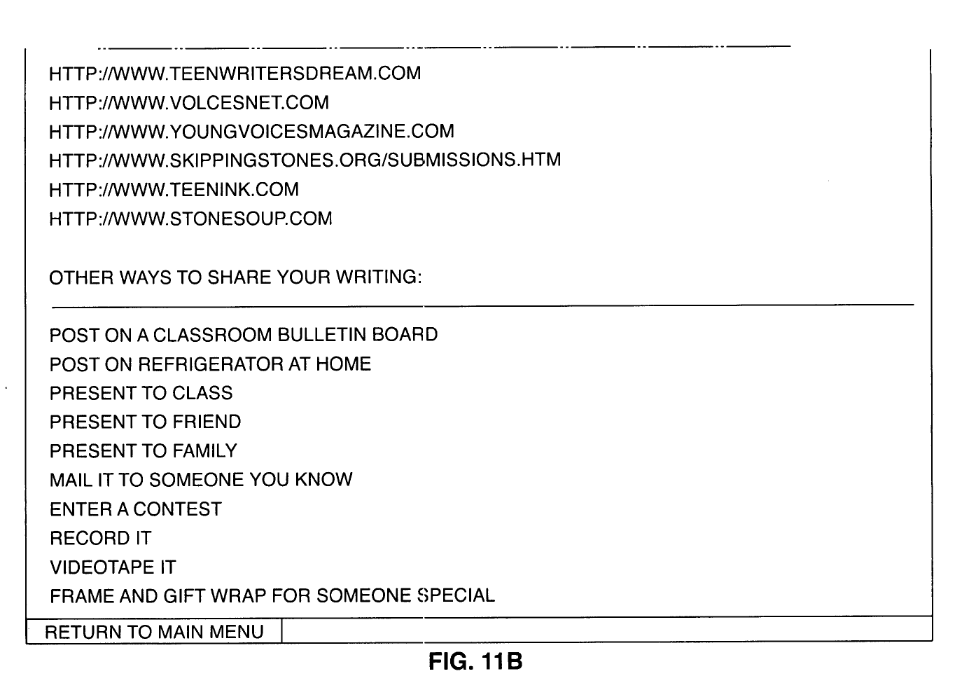

Returning to FIG. 1, after the read aloud and input step (block 114), the user may continue to the next step in the processing logic, which is the end with perfect copy step (block 116). FIG. 11 is a web page for the end with perfect copy step. As illustrated in FIG. 11, the end with perfect copy step prompts the user to submit a perfect copy, or final draft, of the writing to a teacher, along with other materials generated during the process, including, an assessment sheet, a perfect copy, i.e., final draft, a read aloud sheet, a 6 Trait evaluation sheet, sloppy copies (rough drafts) with revisions, prewriting notes or forms and a prewriting sheet. The same web page for the wait step can be displayed for all writing options, both poetry and nonpoetry.

Returning to FIG. 1, after the end with perfect copy step (block 116), the user may continue to the next step in the processing logic, which is the student/teacher assessment step (block 118). The student/teacher assessment step will be discussed more detail below in connection with the discussion of the nonpoetry flow.

B. Nonpoetry Flow

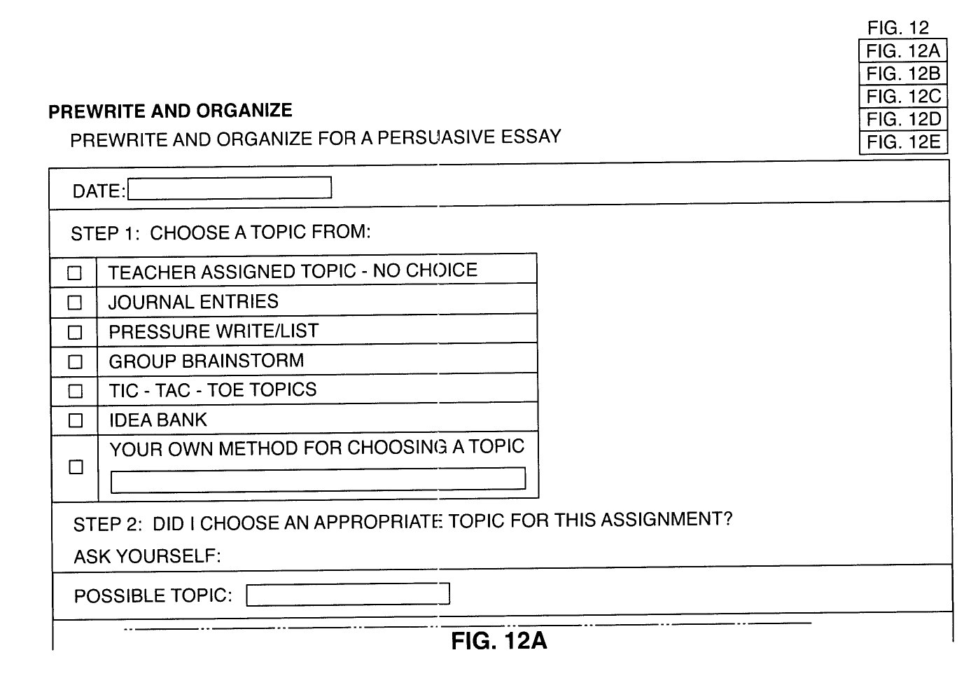

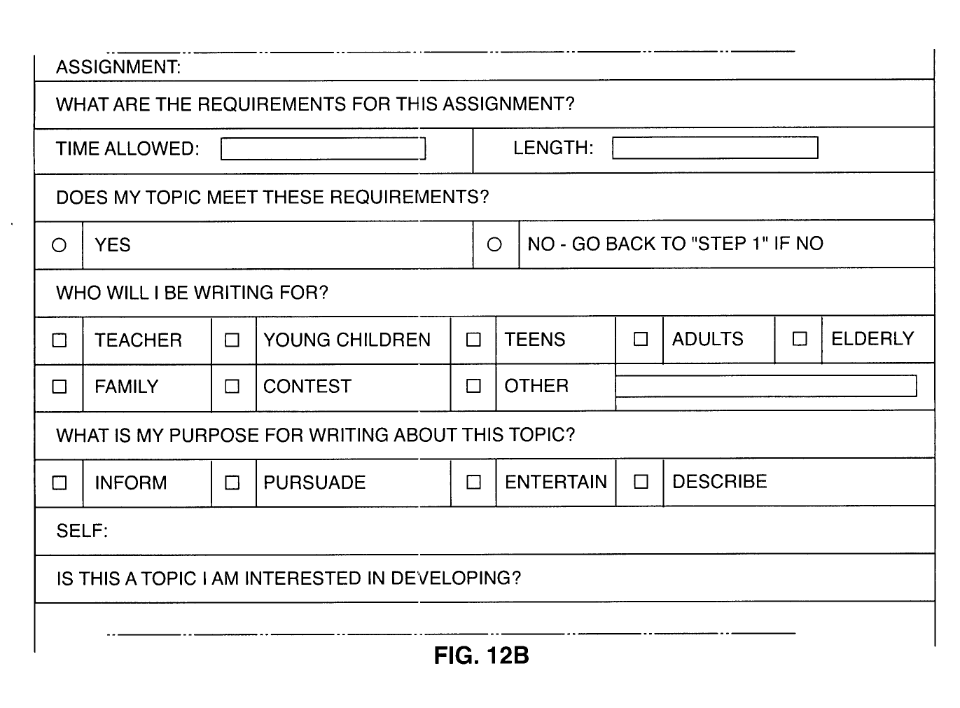

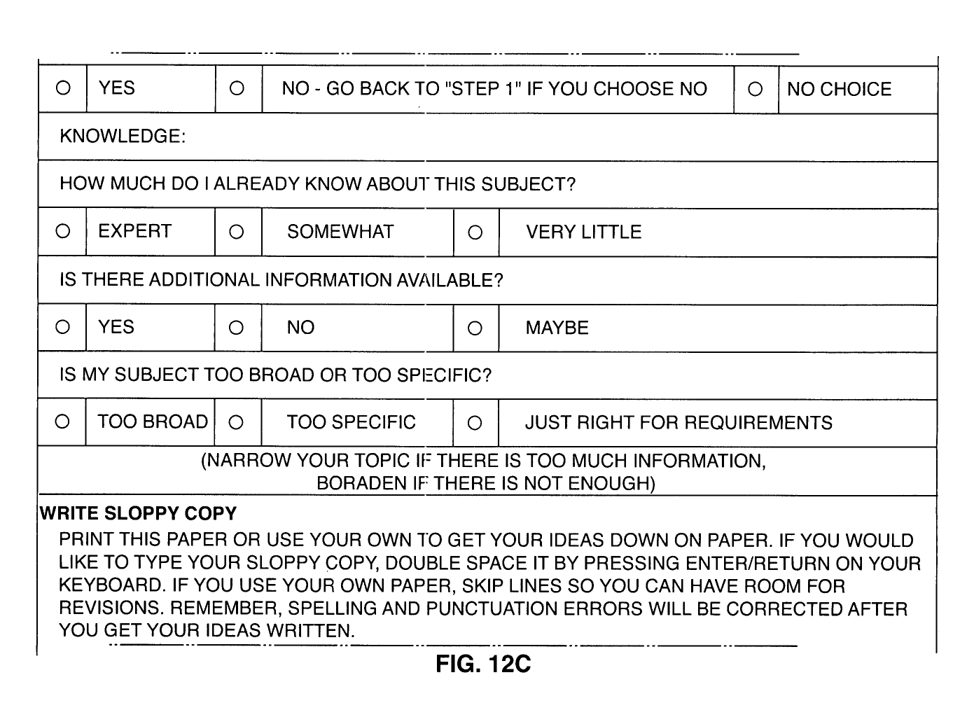

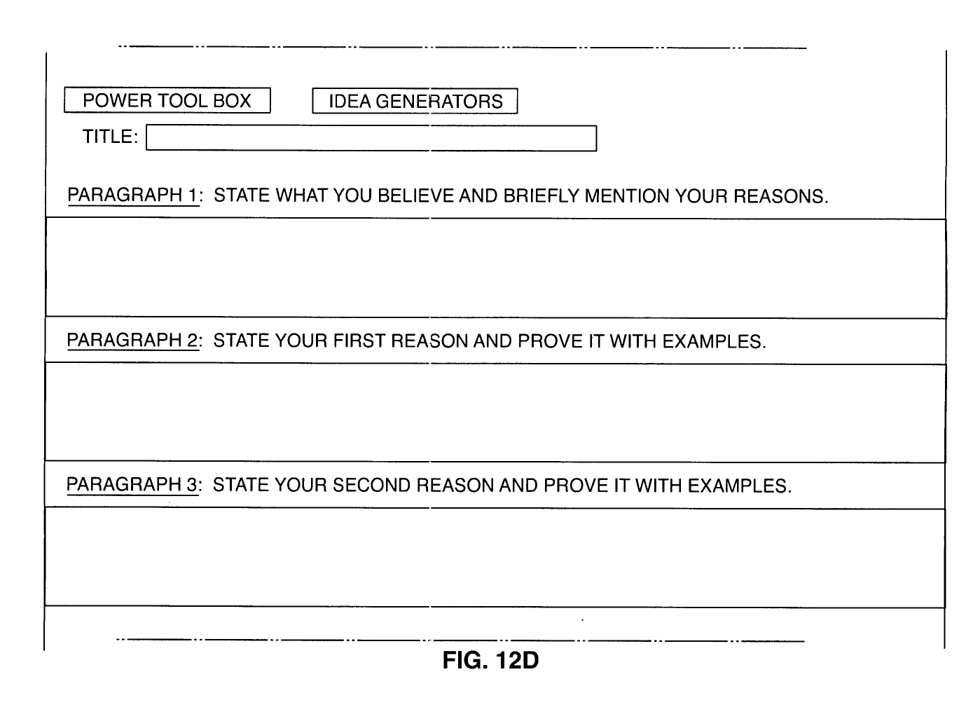

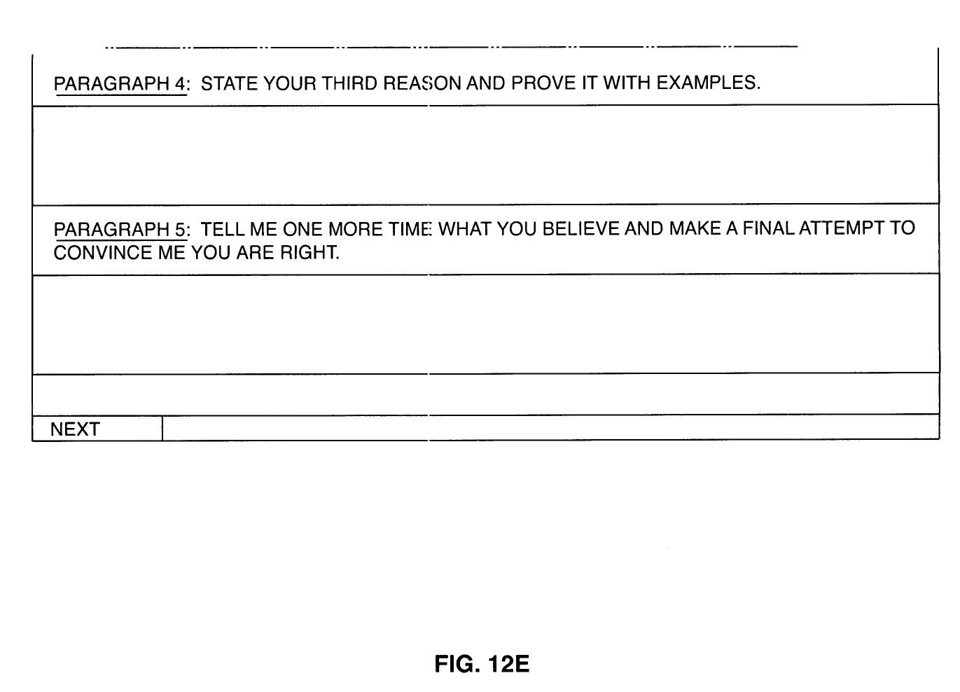

Returning to FIG. 1, as illustrated by block 120, a user may select a nonpoetry writing option, such as, a persuasive essay, short story, personal narrative, cause and effect essay, problem/solution essay, comparison essay, research report, or friendly letter, after which processing control is transferred to block 122. If, for example, the user selects persuasive essay, the system displays the prewrite, organize and write web page for a persuasive essay, which is illustrated by FIGS. 12A and 12B. During the prewrite, organize and write step, the system uses a combination of static and dynamic web pages that assist a student in extracting and expressing their thoughts in the context of the writing option selected. For example, as shown in FIG. 12A, a user may choose one of the following methods for determining a writing topic: a teacher assigned topic, a journal entry, pressure write/list, group brainstorm, “tic-tac-toe” topics, idea bank or a user's own method for selecting a topic.

The prewrite, organize and write web page may be configured so that the name of each method of determining a writing topic is a hypertext link to additional information about that method. For example, a user may select a Journal Entries link, in which case the system would display ajournal web page. The journal web page allows the user to scan previously saved journal entries for writing topic ideas. A user also may create and save a new journal entry via the journal web page. Similarly, selecting the Pressure Write/List link displays a web page that prompts a user to write about a topic for a predetermined amount of time (e.g., two minutes) and to save the writing to an idea bank. Selecting the Group Brainstorm Topics link, displays a group brainstorm web page, which prompts the user to choose two or three people who will be able to help brainstorm ideas, to set a time limit for brainstorming, and to record the ideas. Selecting the Tic-Tac-Toe Topics link, displays a tic-tic-toe topics web page, which prompts a use to write about predetermined topics, such as places, people, things, memories, animals, opinions, dreams, events, holidays, etc. Selecting the Idea Bank link displays an idea bank web page, which allows a user to create and save, or view previously created and saved, ideas for writing topics. Such topics may include story ideas, research topics, poetry ideas, persuasive topics, people to write to, etc.

As illustrated in FIG. 12A, after selecting a topic, a user is prompted to answer a series of questions to determine if the topic chosen is appropriate. Based on the answers to these questions, the user may narrow or broaden the topic.

After a user has determined that the selected topic is appropriate, the user is prompted to write “sloppy copy,” or a rough draft, about the selected topic. As illustrated in FIGS. 12A and 12B, the prewrite, organize and write web page for a persuasive essay, prompts the user to write rough draft, which may include a title, a first paragraph about the user's beliefs about the topics and the reasons for those beliefs, a separate additional paragraph about each reason, including examples, and a concluding paragraph repeating the user's belief and the reasons the user's belief is correct.

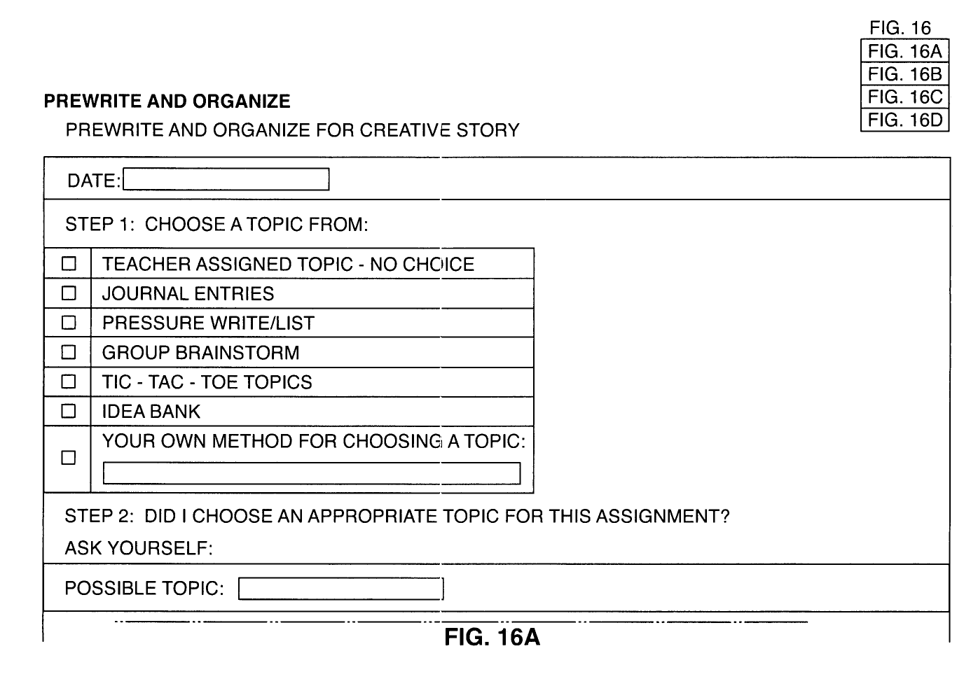

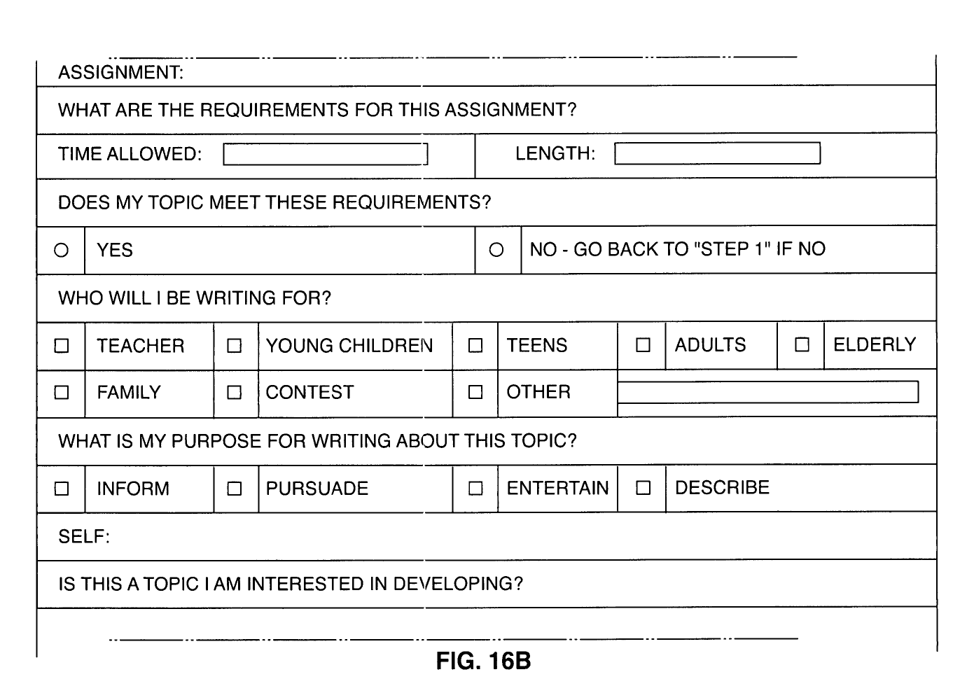

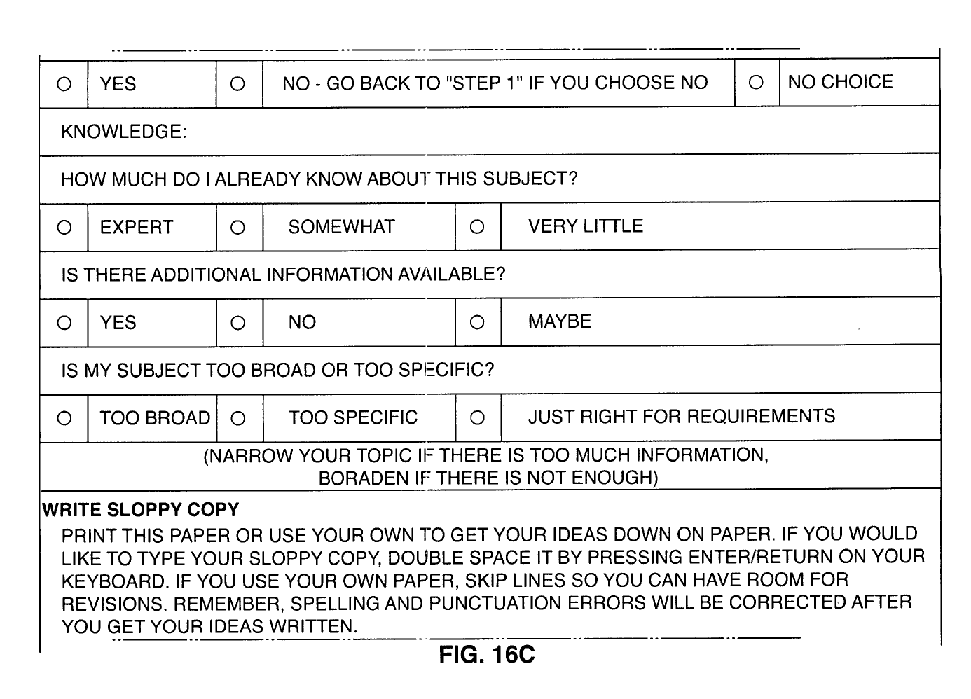

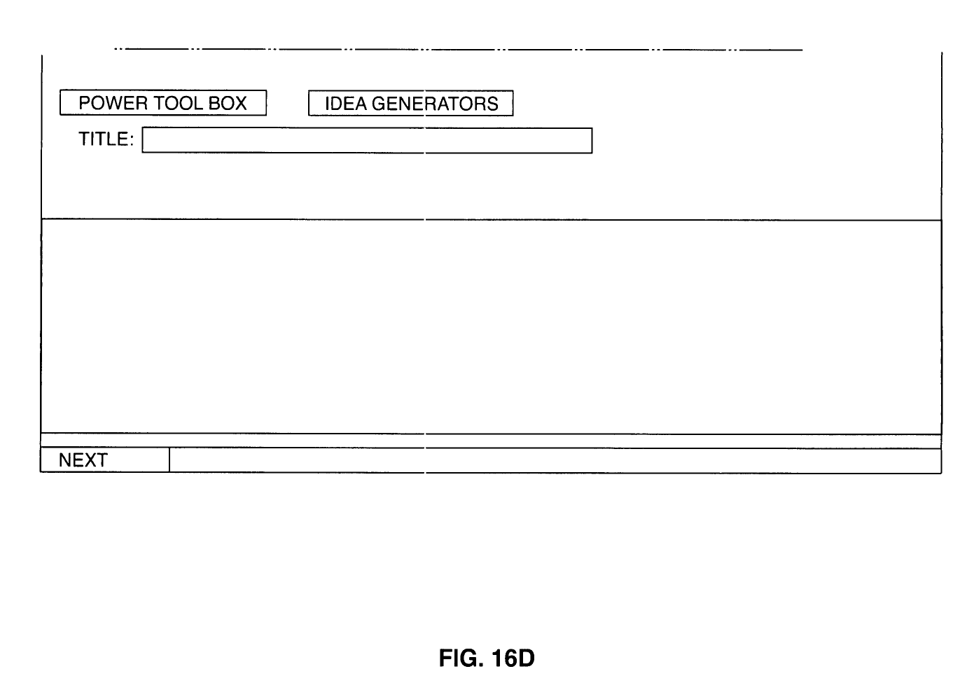

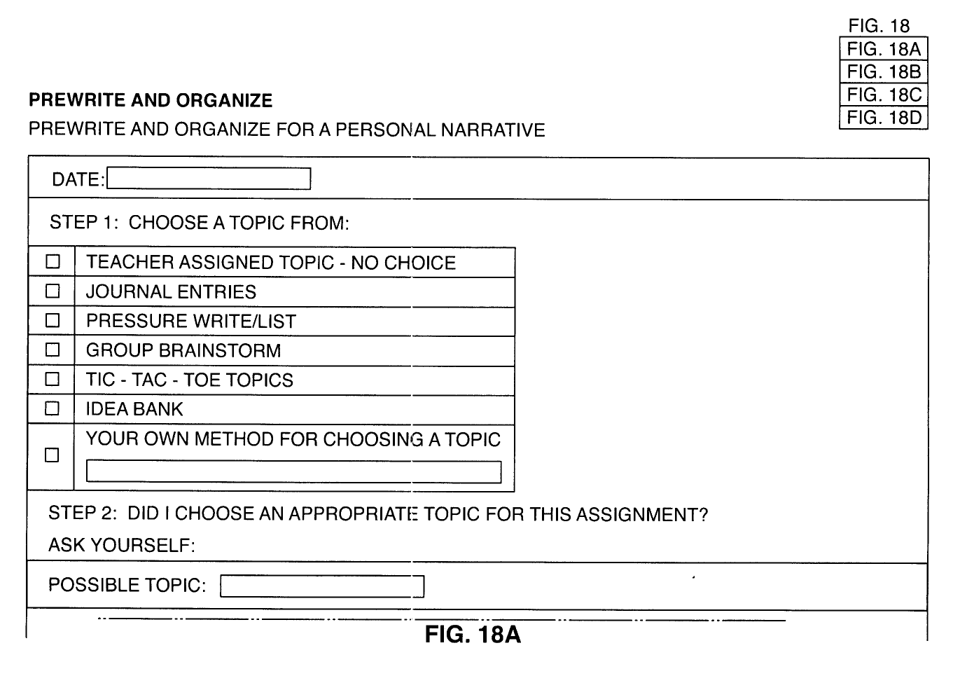

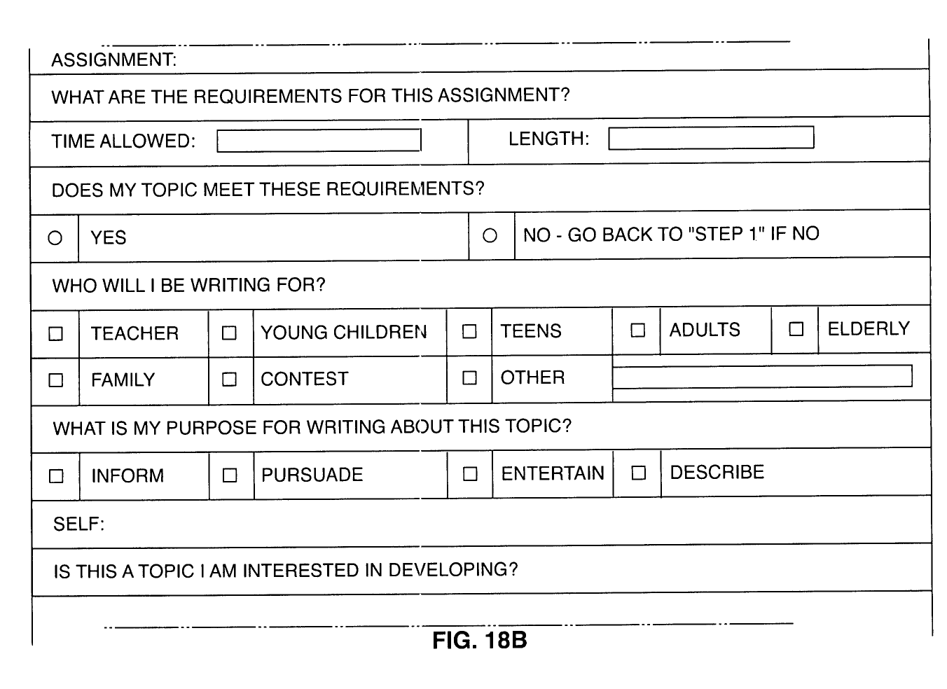

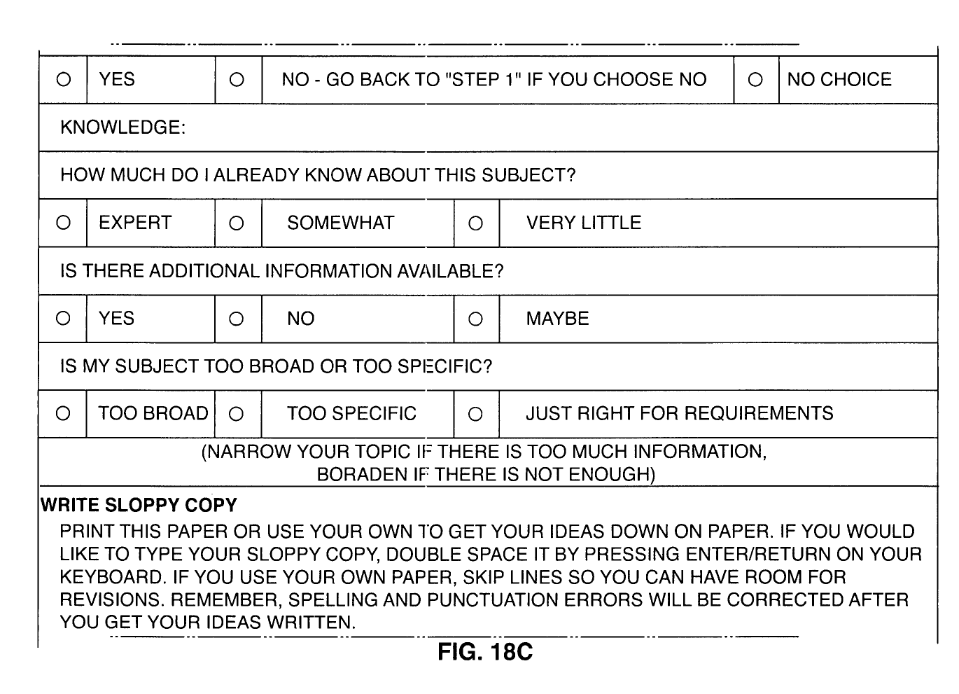

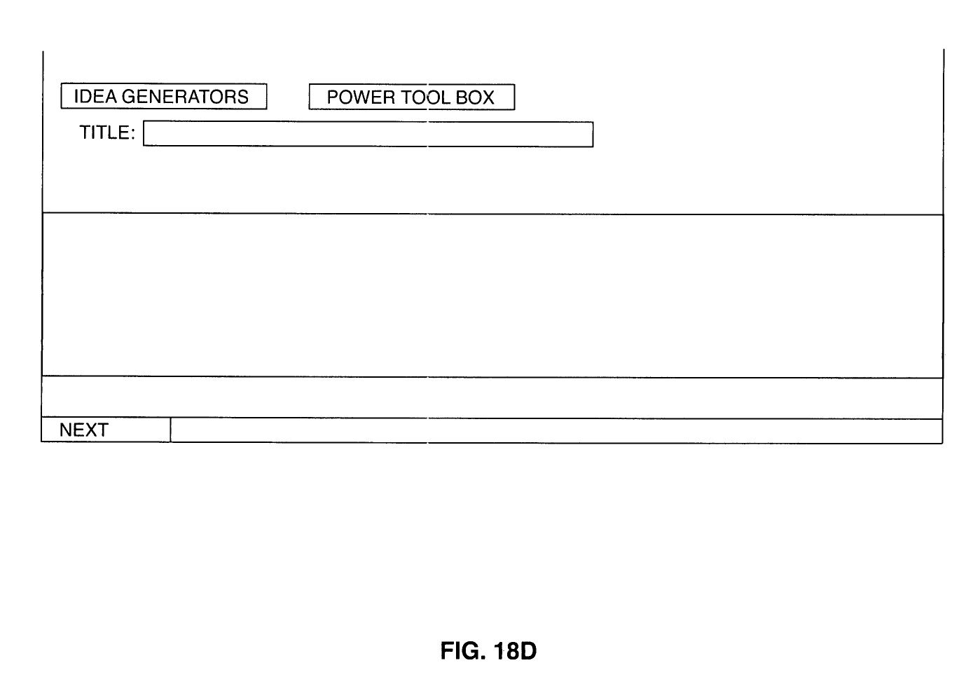

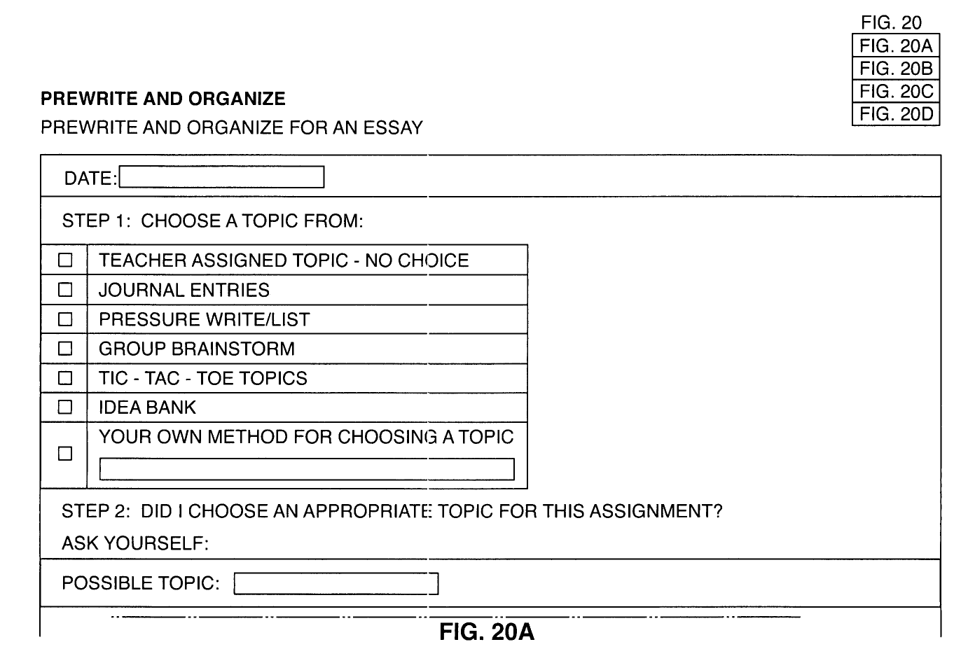

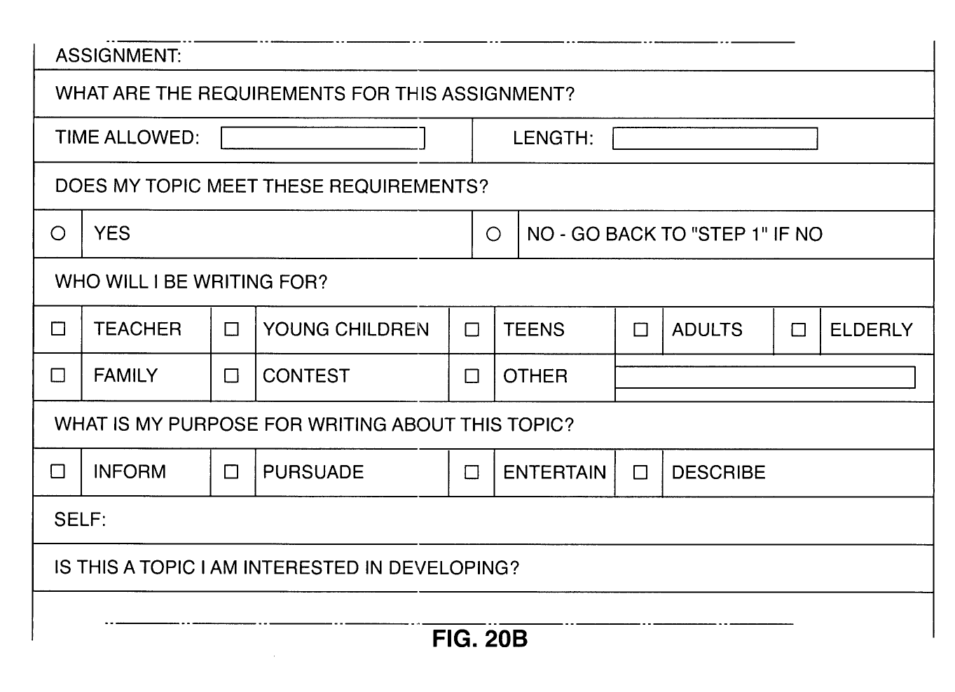

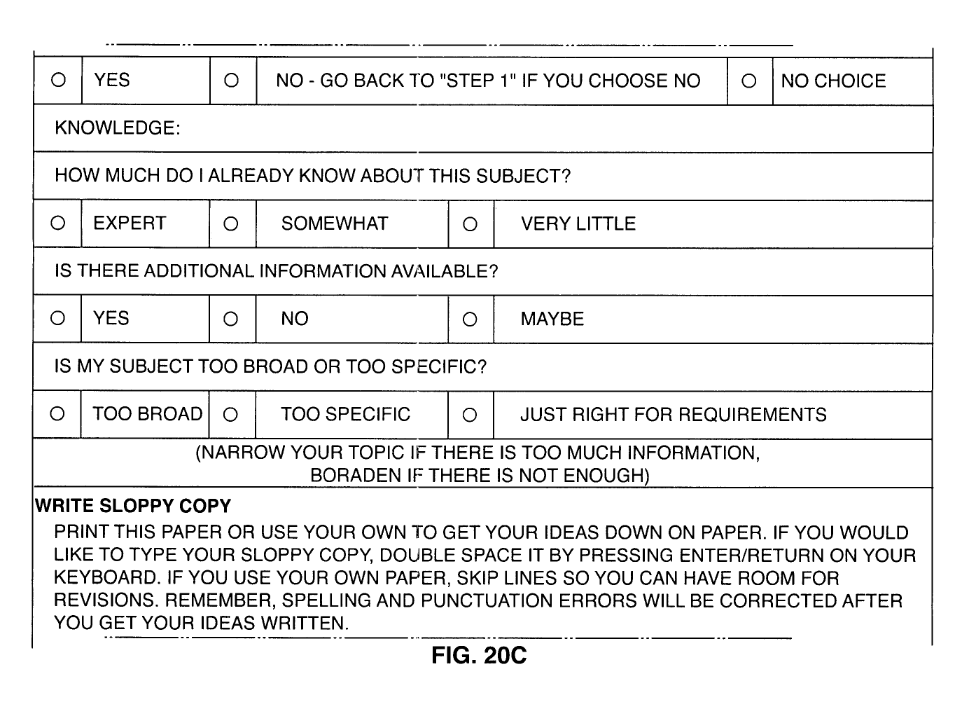

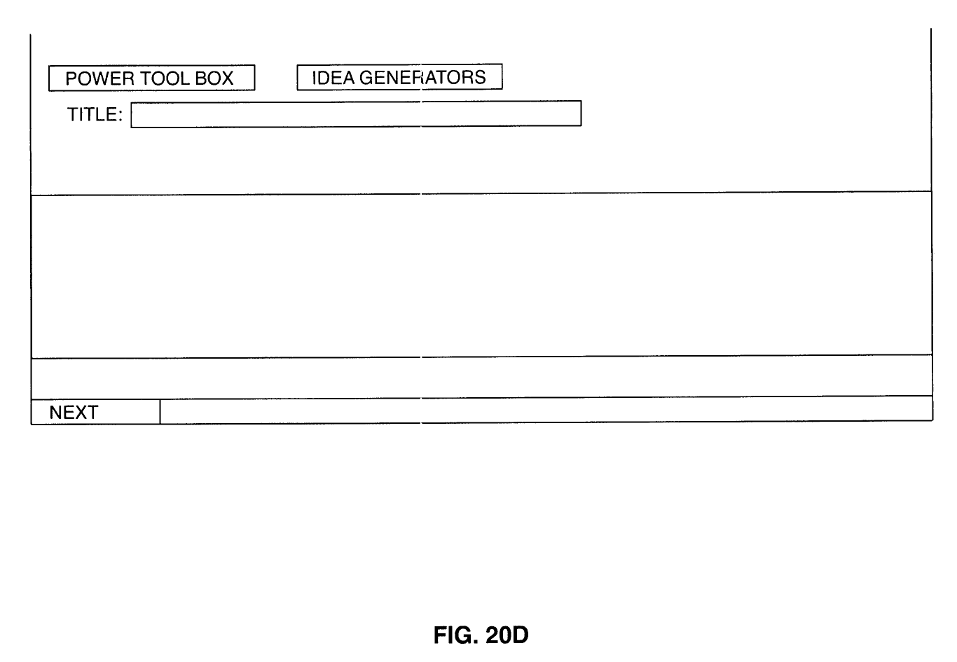

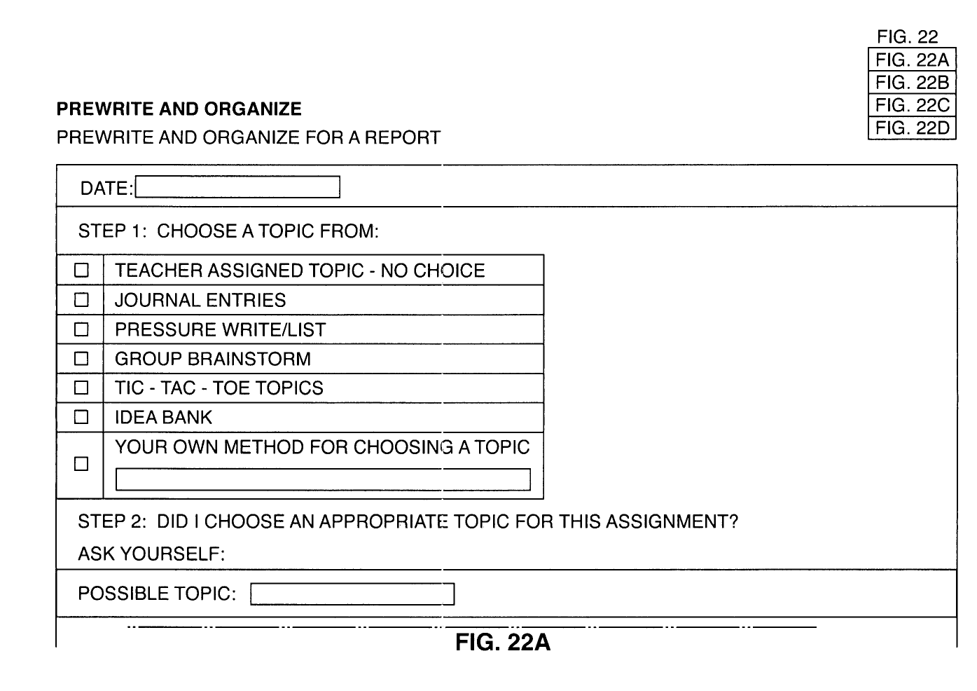

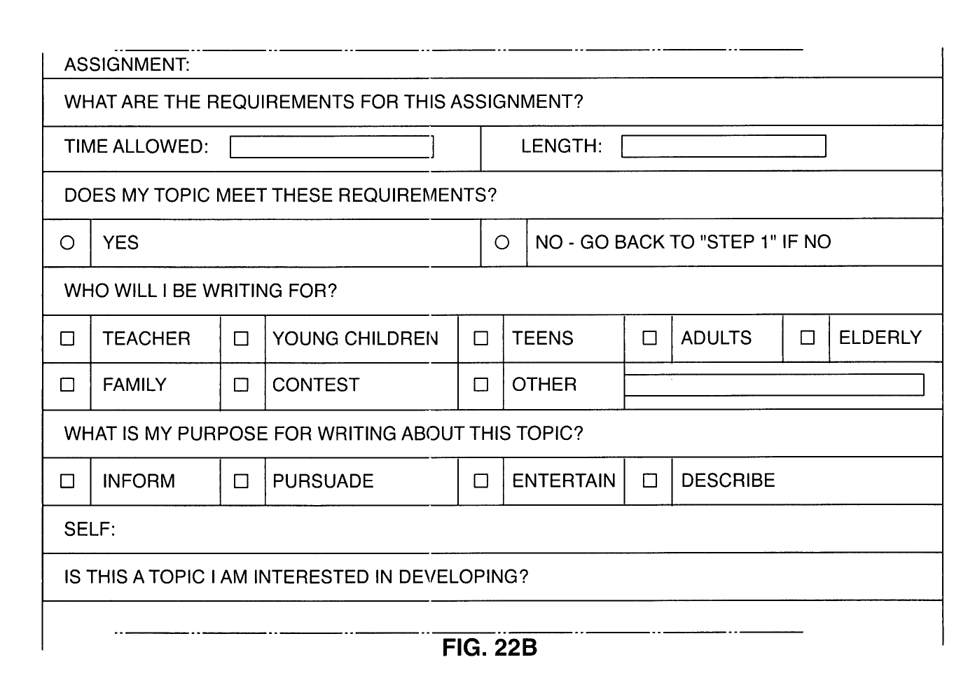

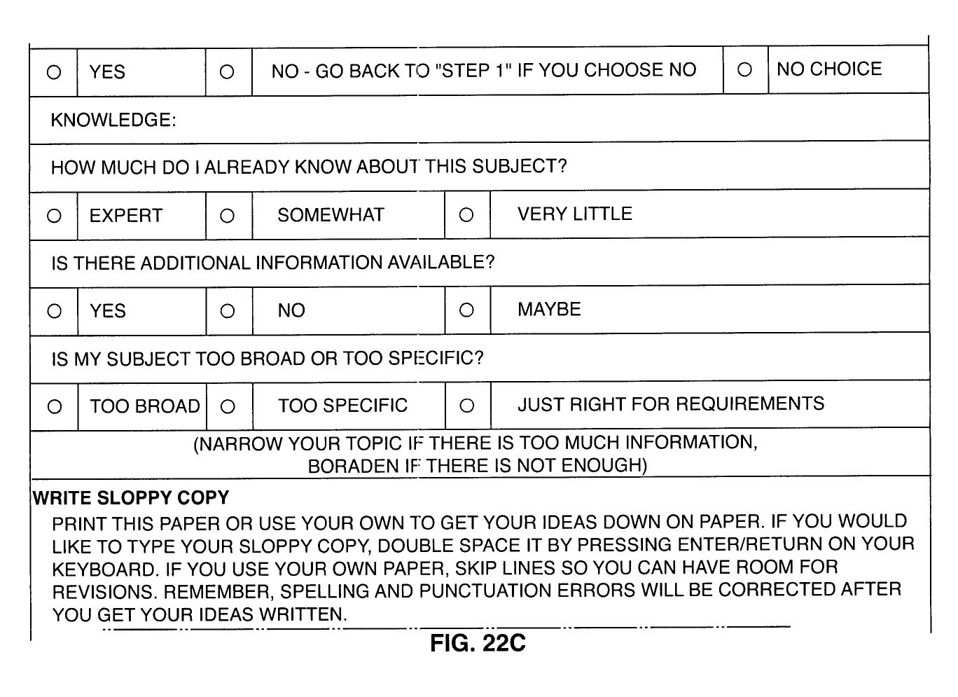

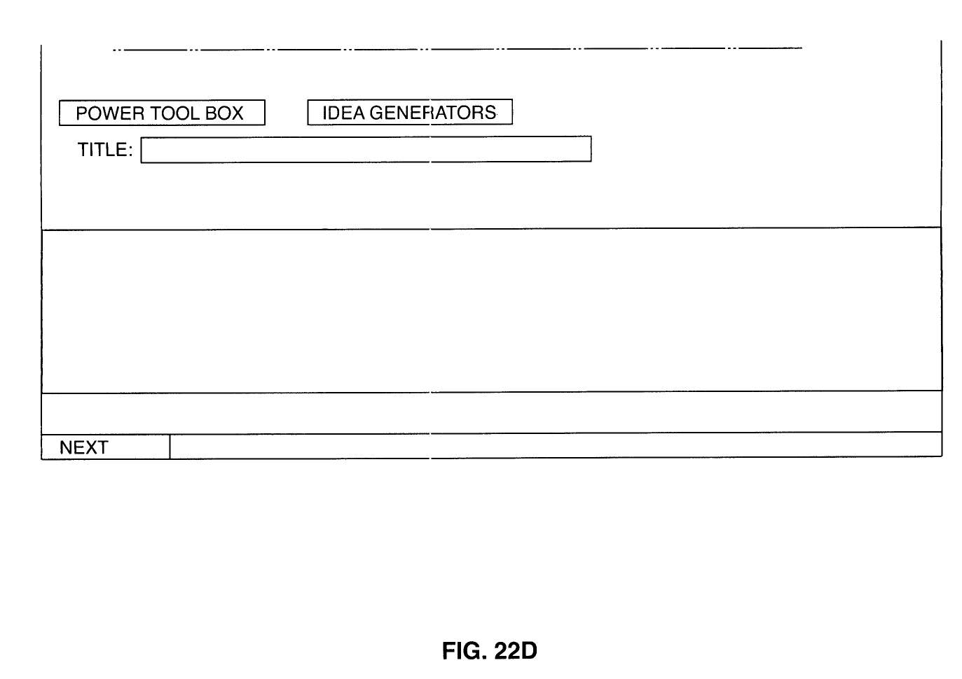

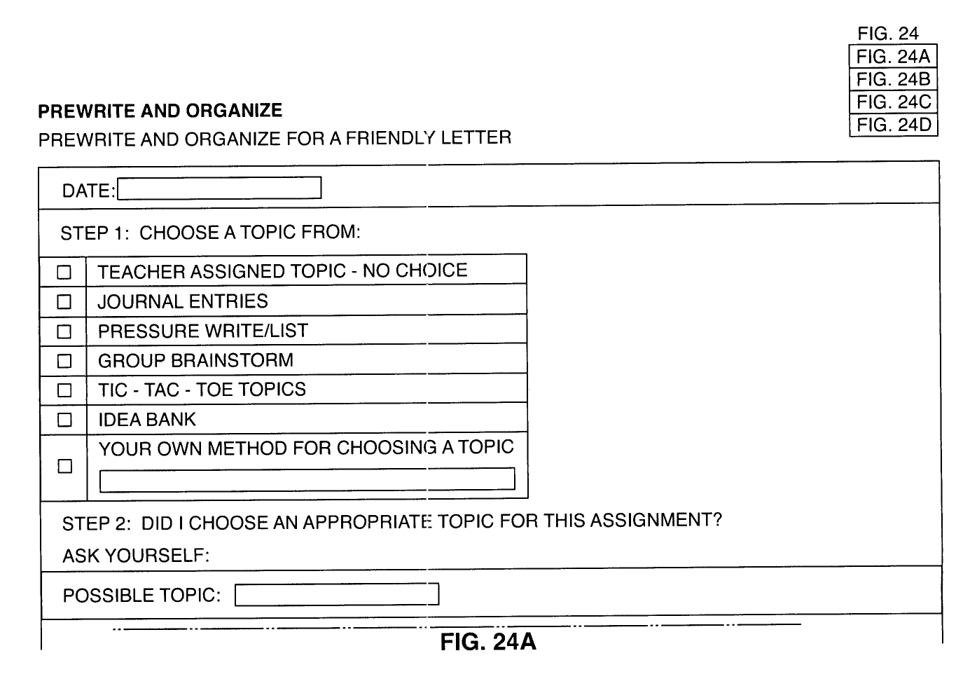

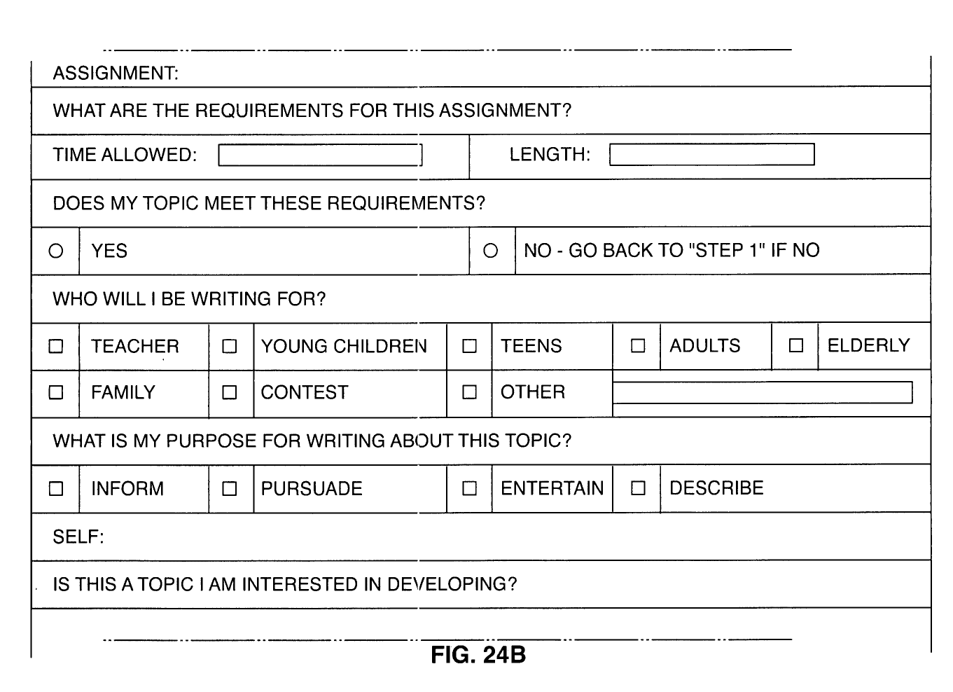

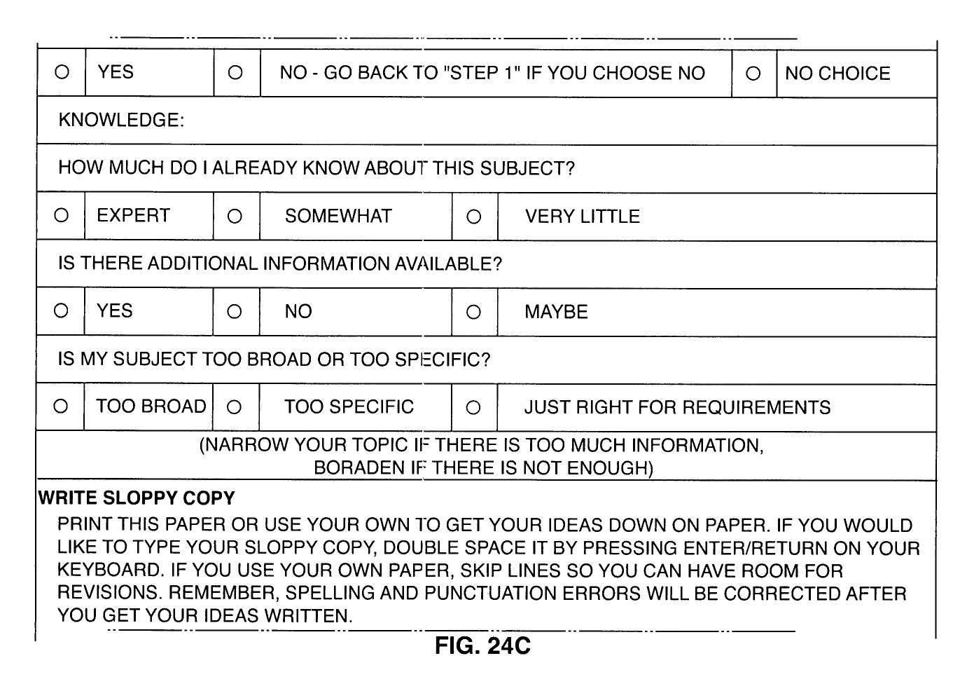

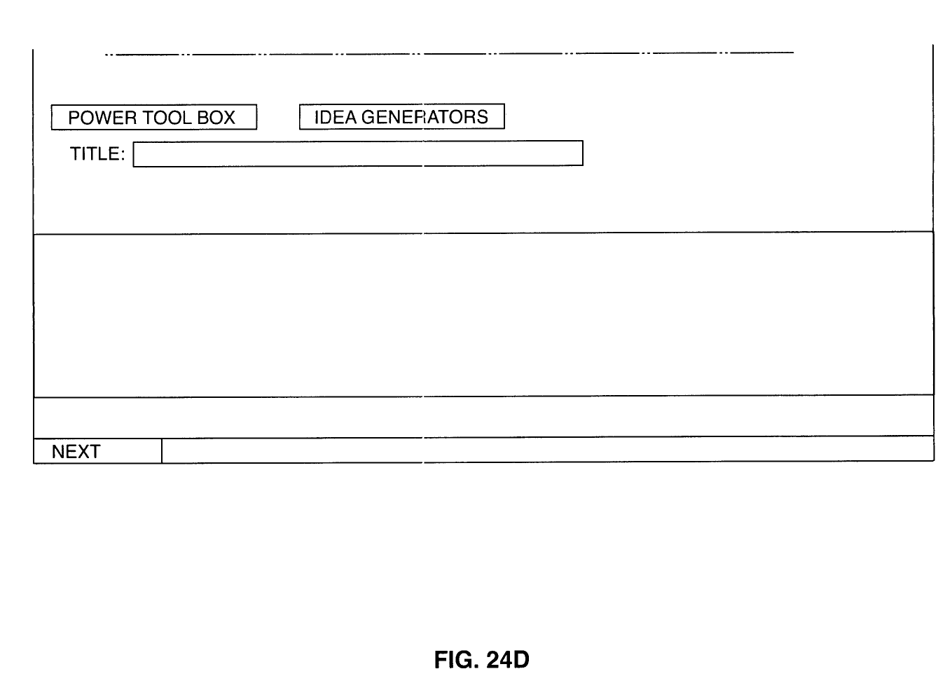

The web pages for the prewrite, organize, write step for the other nonpoetry writing options are similar in content and structure to the web pages for the persuasive writing option. More specifically, the web pages for the prewrite, organize, write step for the creative story, personal narrative, essay, report, and friendly letter writing options are illustrated by FIGS. 16, 18, 20, 22 and 24, respectively.

The system also may provide an idea generator in connection with the prewrite, organize and write step. The idea generator may provide for both generic idea generators, which may be suitable for use in connection with any writing option selected by the user, and specific idea generators, which may be suitable for a particular writing option. In one aspect, idea generators consist of one or more web pages that guide the user through a series of steps and/or questions to generate an idea for writing.

As is the case with the poetry flow, the system can be configured so that the user's input in connection with the prewrite, organize and write step is validated, and the user cannot proceed past the prewrite, organize and write step until such validation has occurred.

Returning to FIG. 1, after a user completes the prewrite, organize and write step (block 122), the user may continue to the next step in the processing logic, which is the evaluate and revise step (block 124). The evaluate and revise step prompts a user to complete an evaluation form, or checklist, which is based on the 6 Trait method for evaluating writing. An evaluation form is provided for each of the various writing options, such as, poetry, letter, persuasive essay, research report, personal experience narrative, essay or short story.

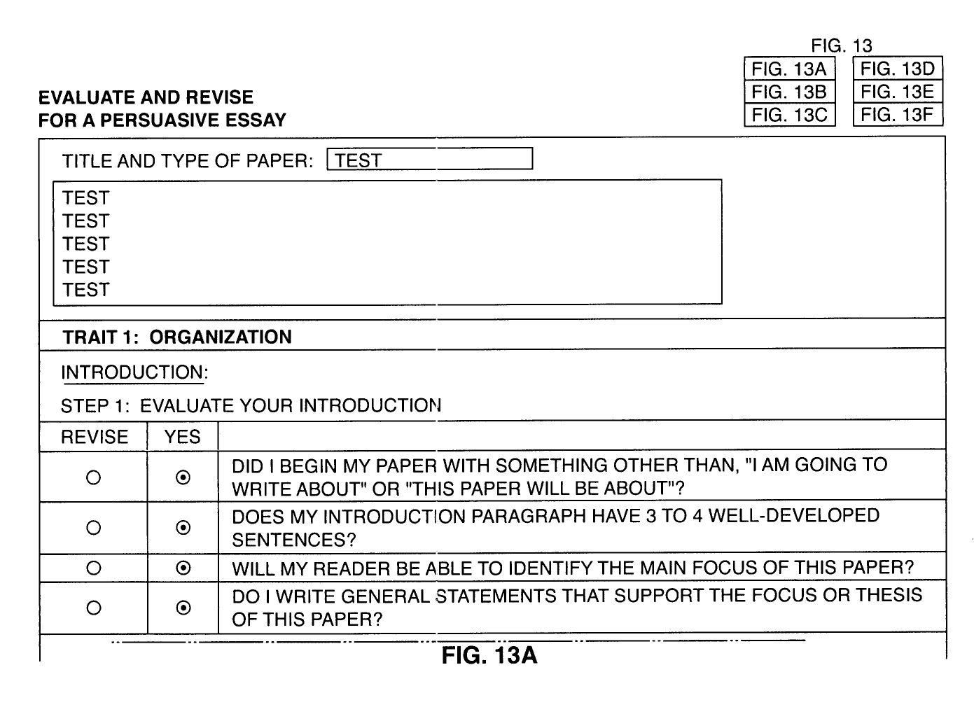

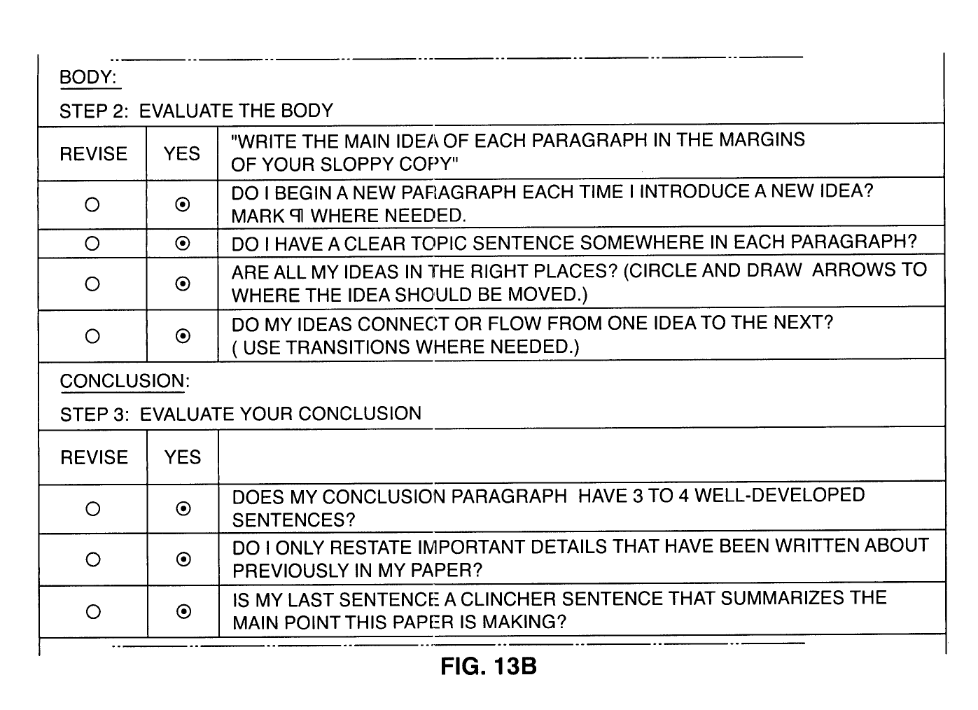

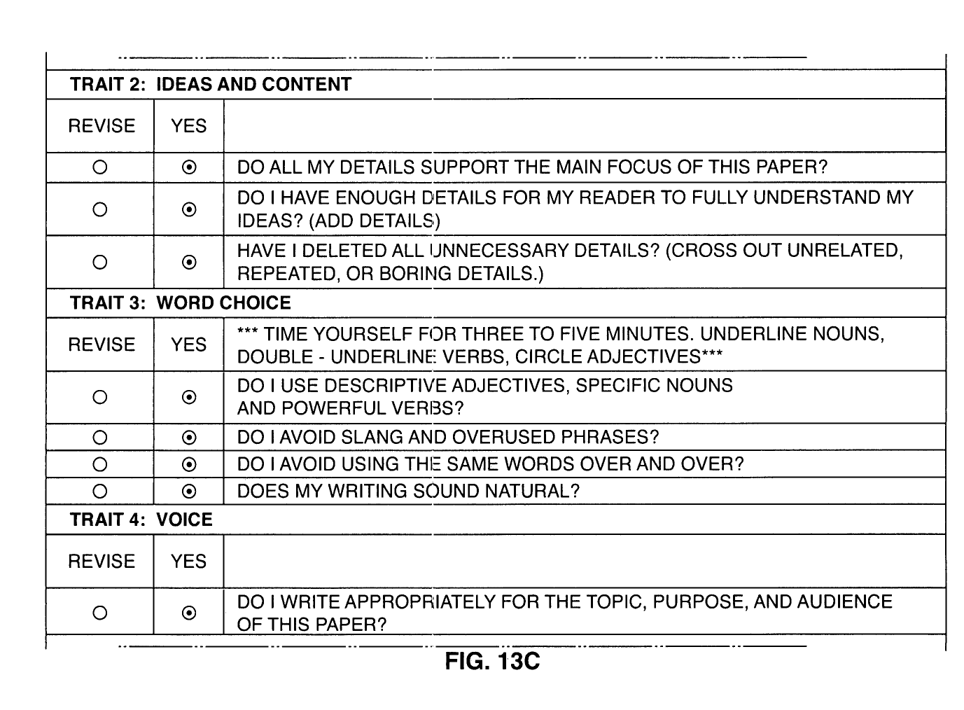

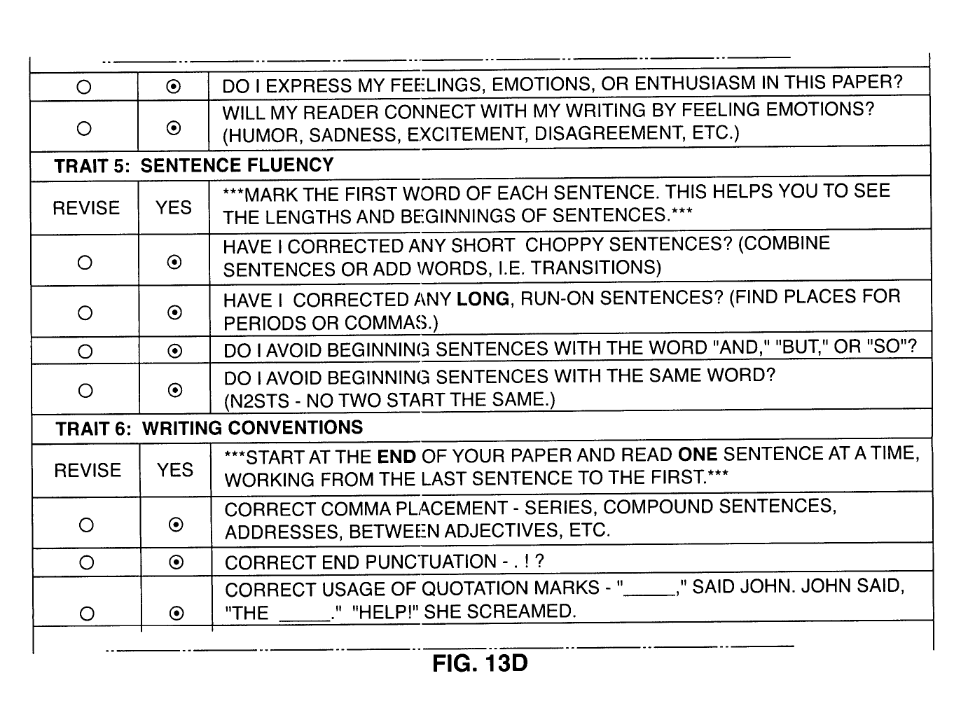

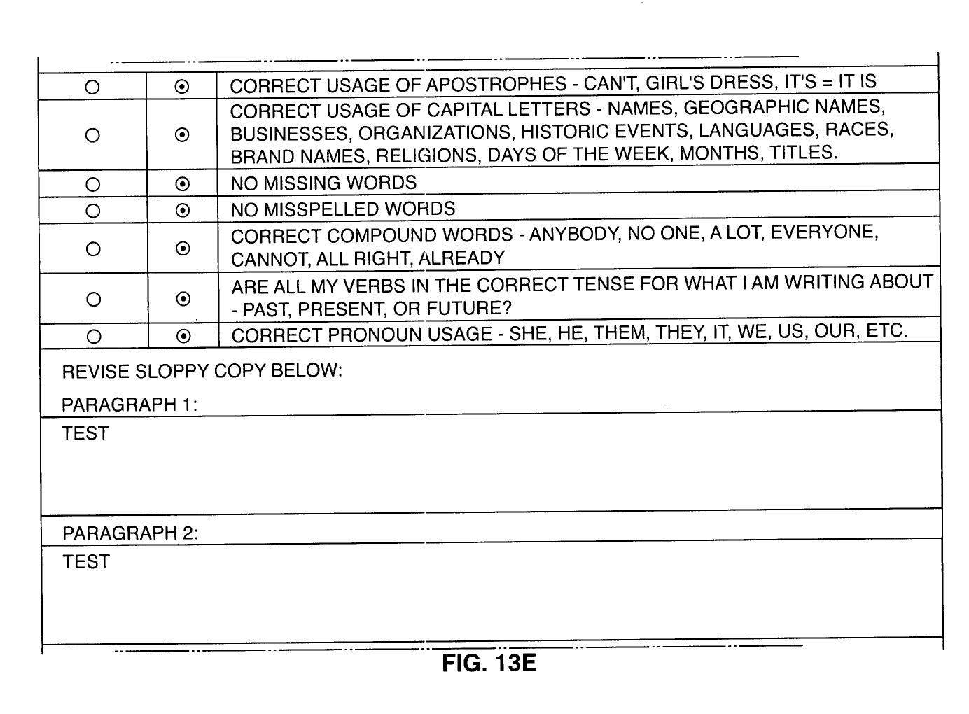

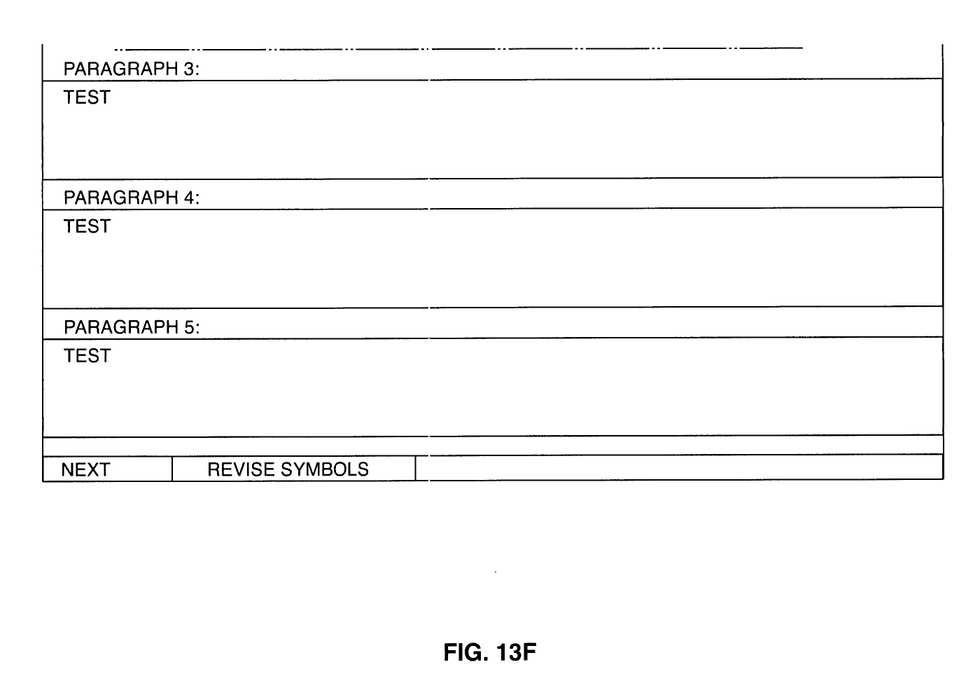

FIGS. 13A and 13B illustrate exemplary web pages for the evaluate and revise step for the persuasive essay writing option. As illustrated in FIGS. 13A and 13B, the evaluate and revise step uses the 6 Trait method of evaluating writing. The traits to be evaluated are organization, ideas and content, word choice, voice, sentence fluency and writing conventions. For each trait, the user is asked one or more questions about the rough draft and may be prompted to revise the rough draft based on the answers to the questions.

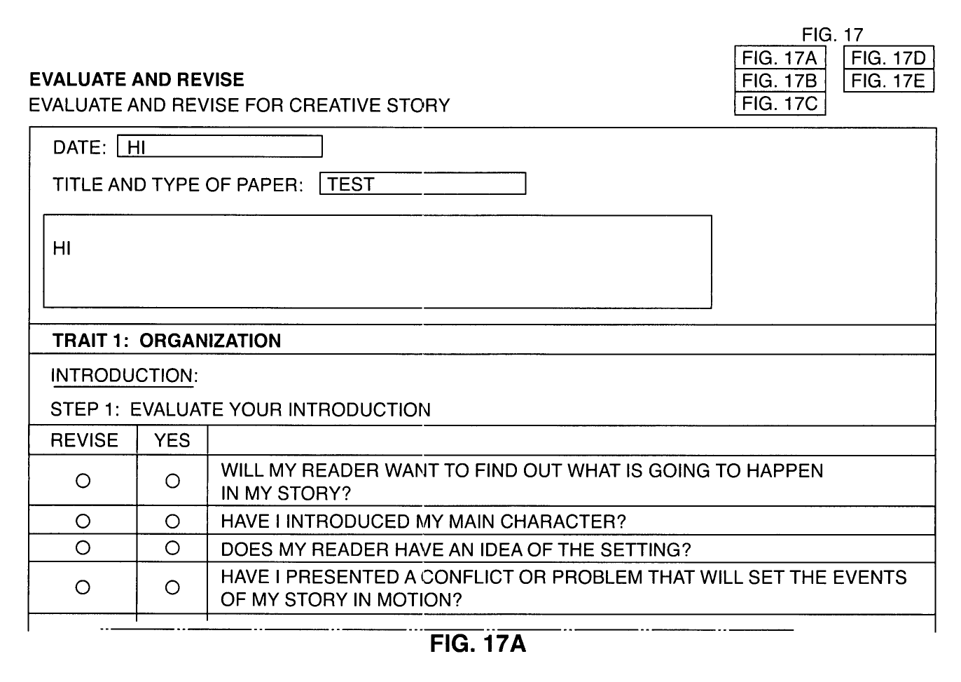

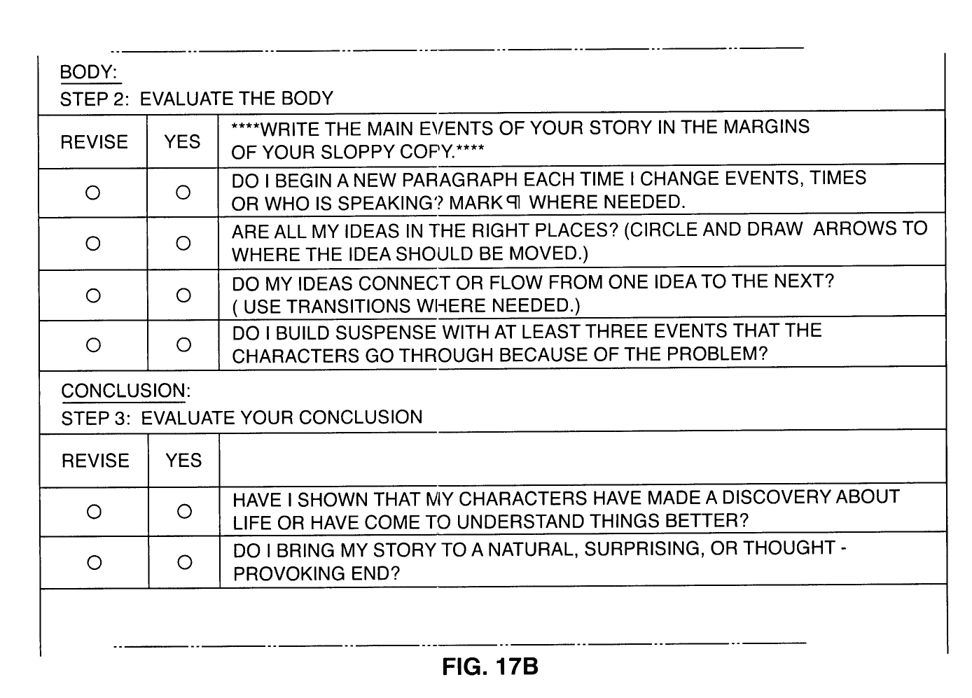

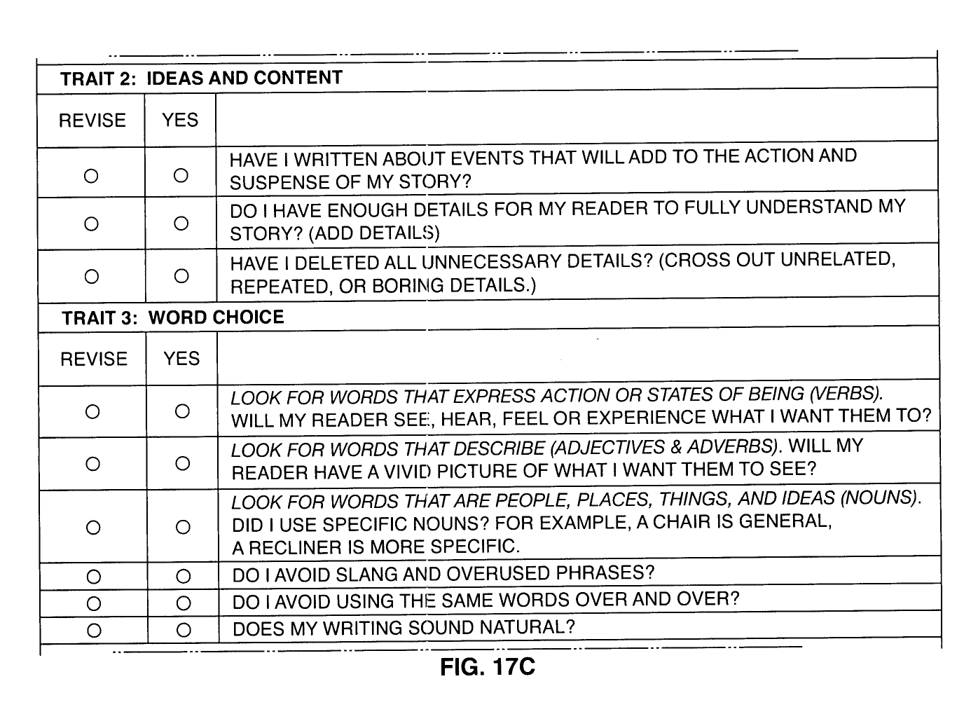

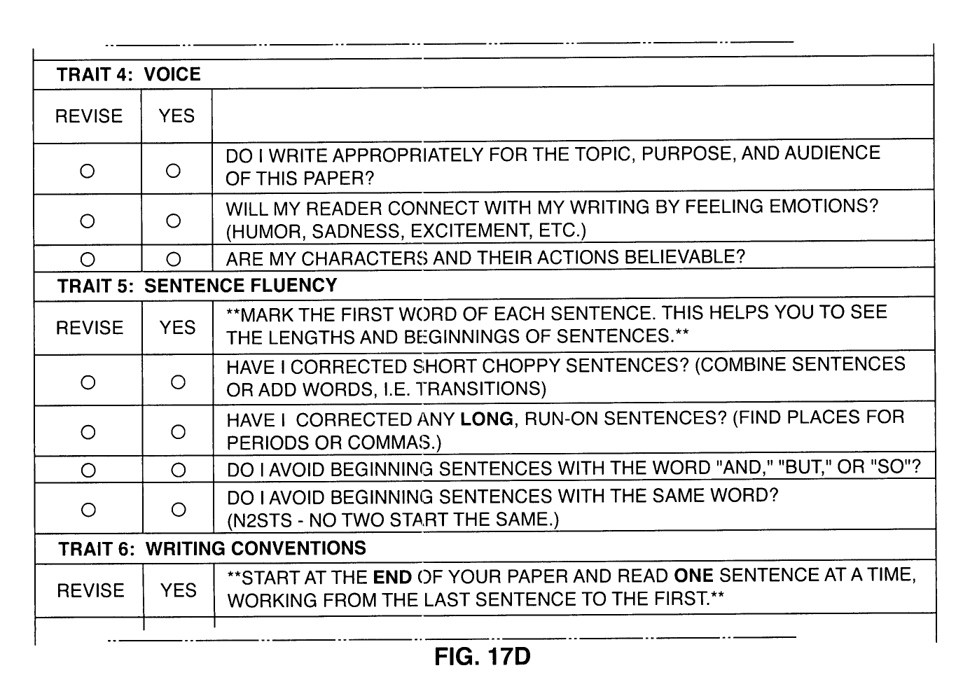

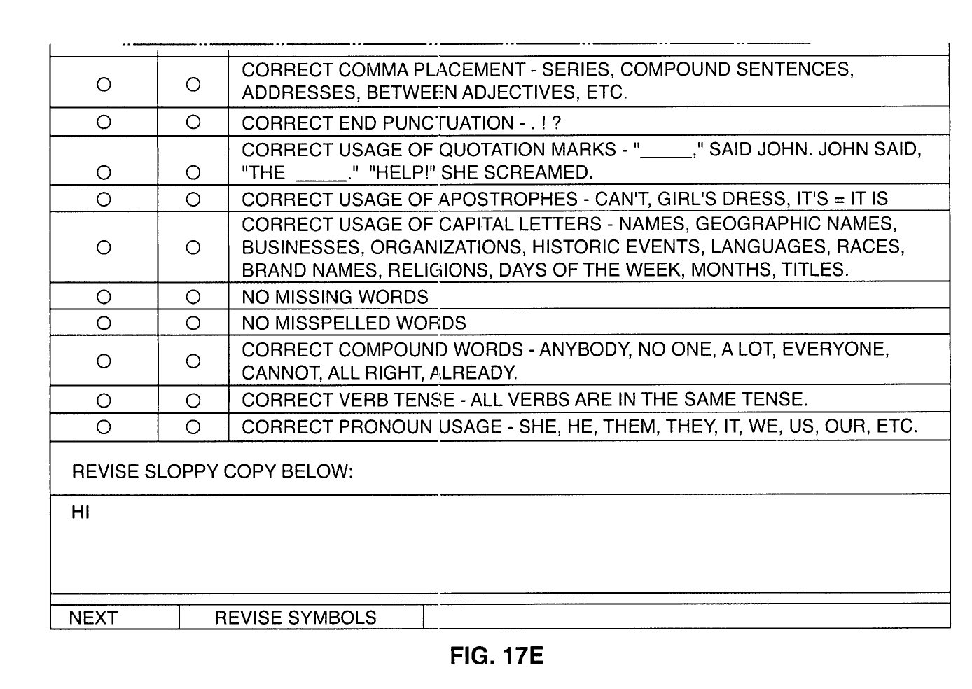

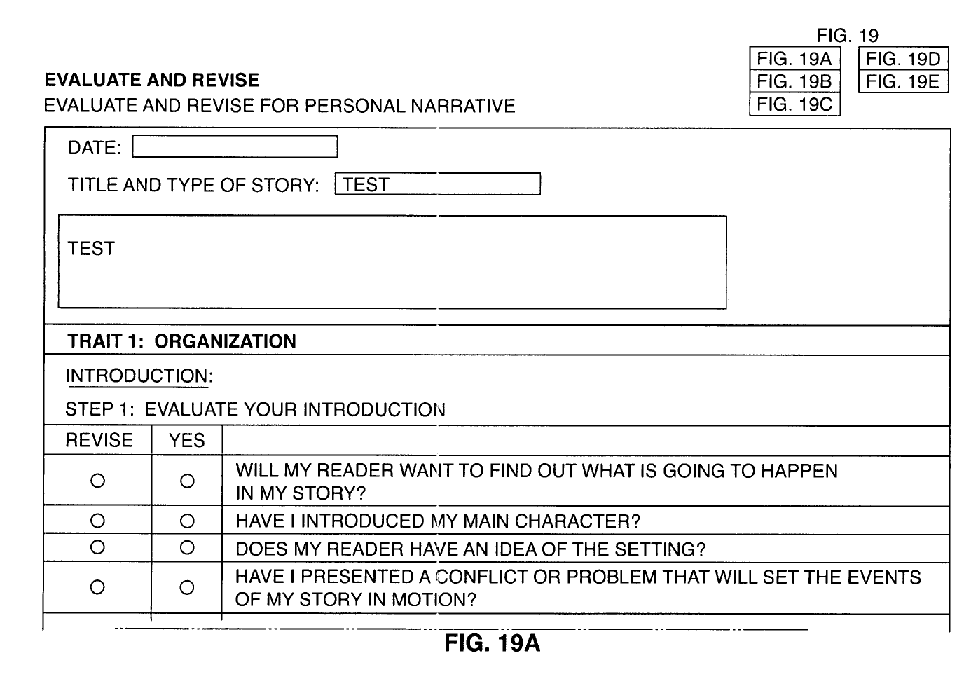

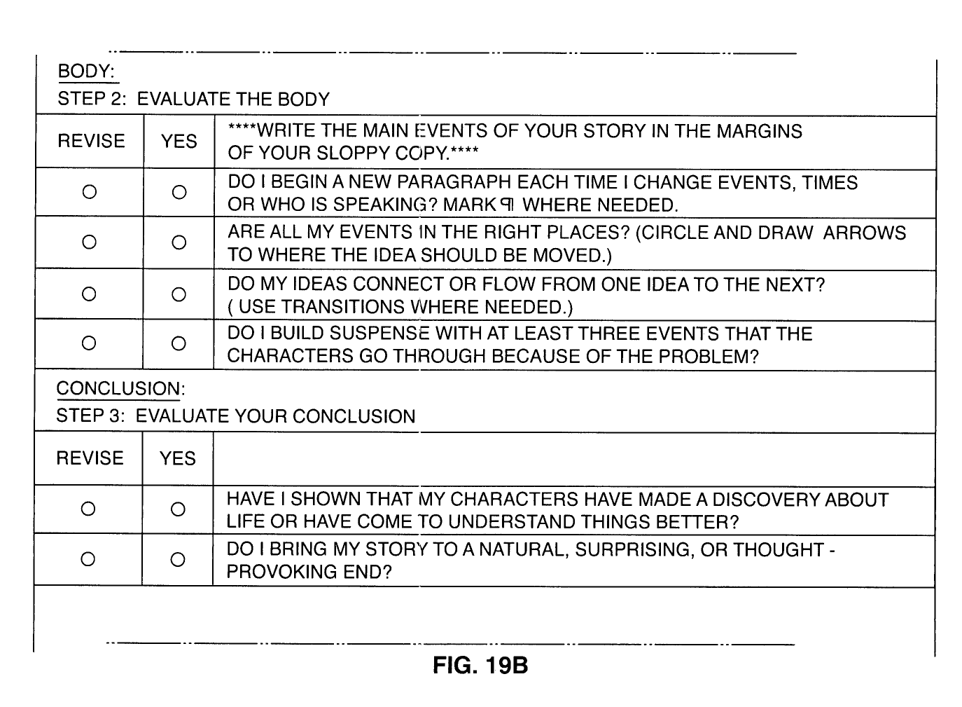

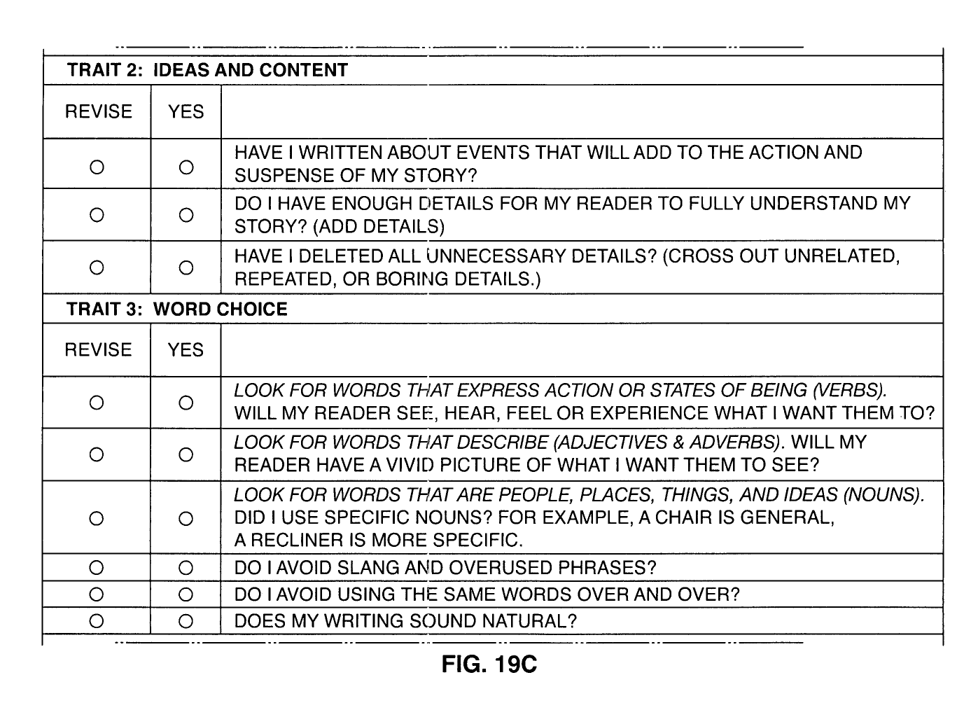

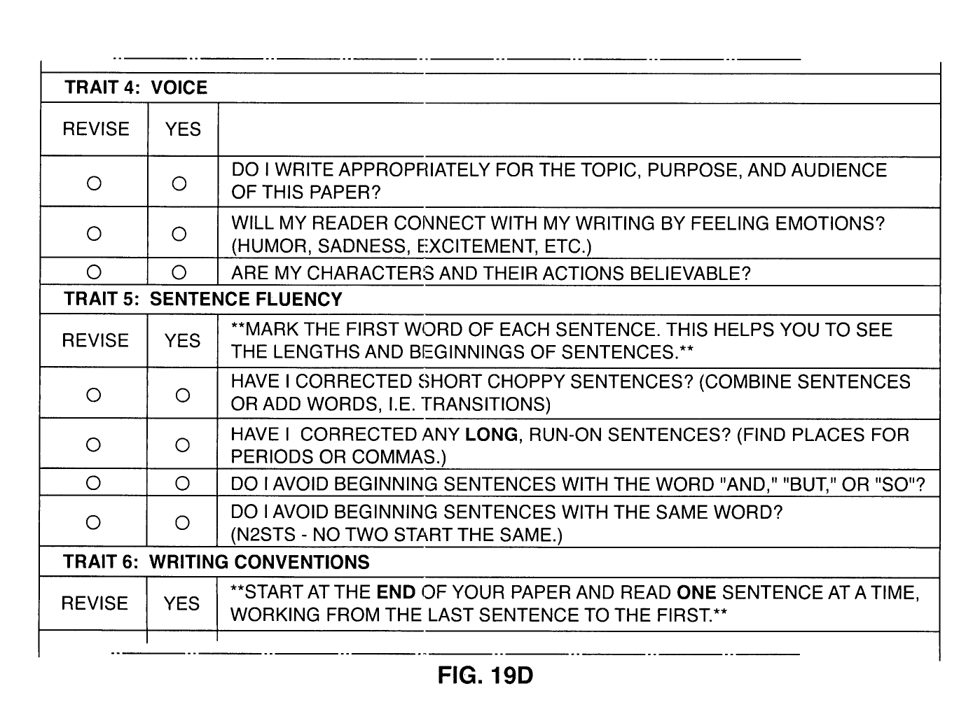

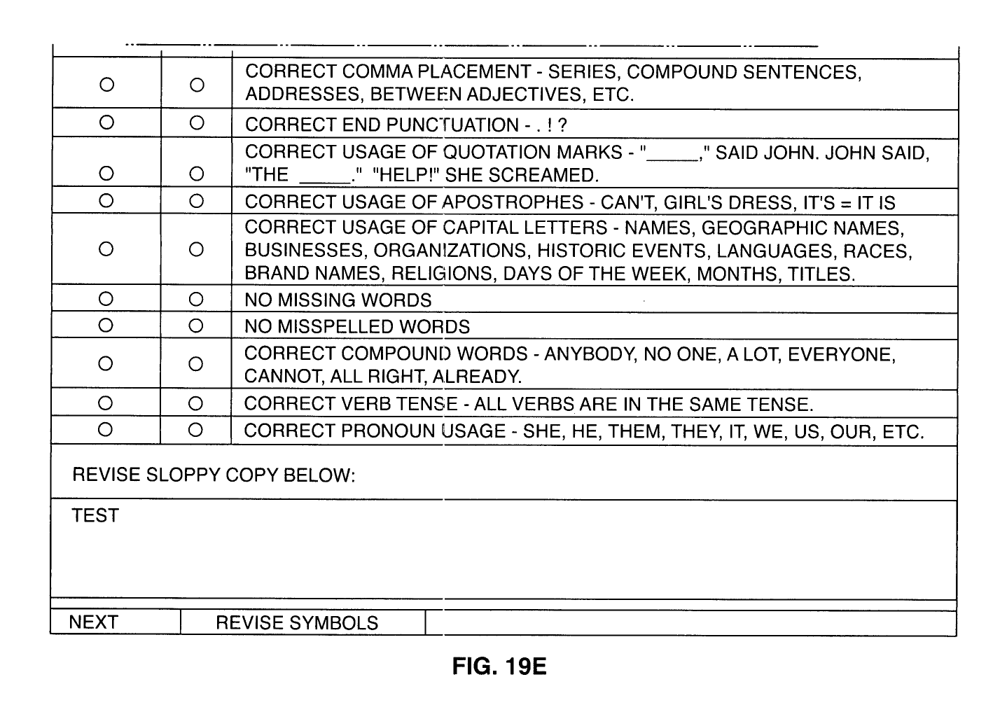

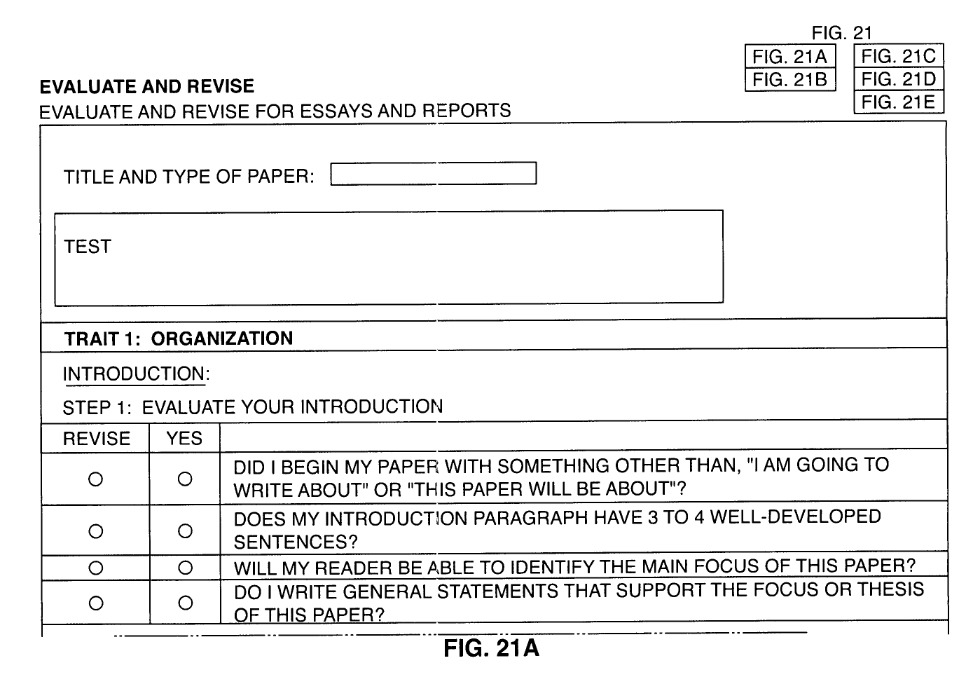

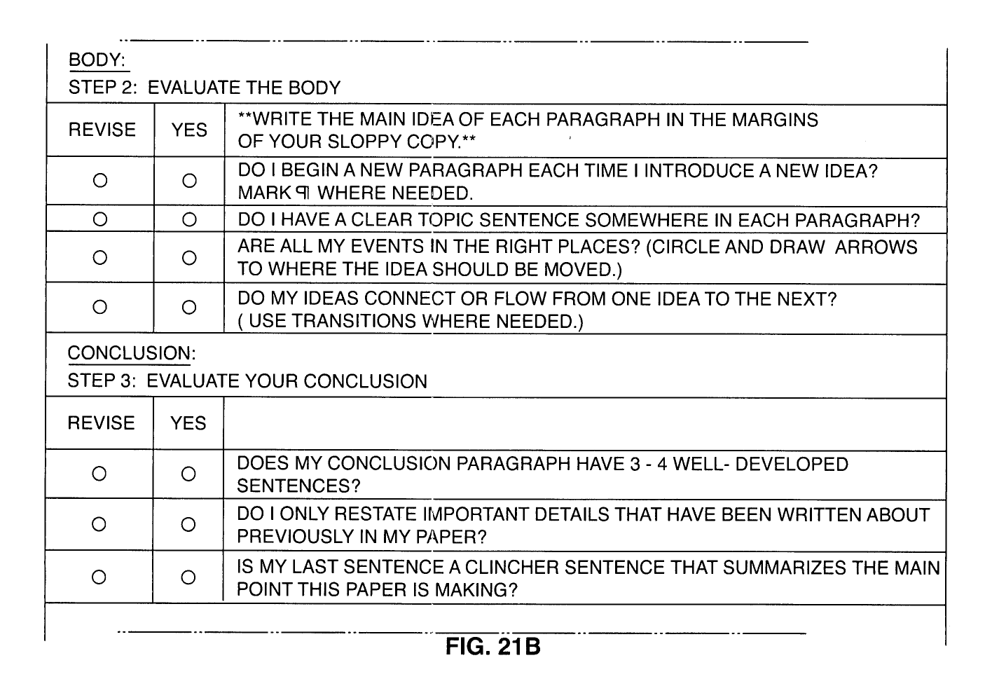

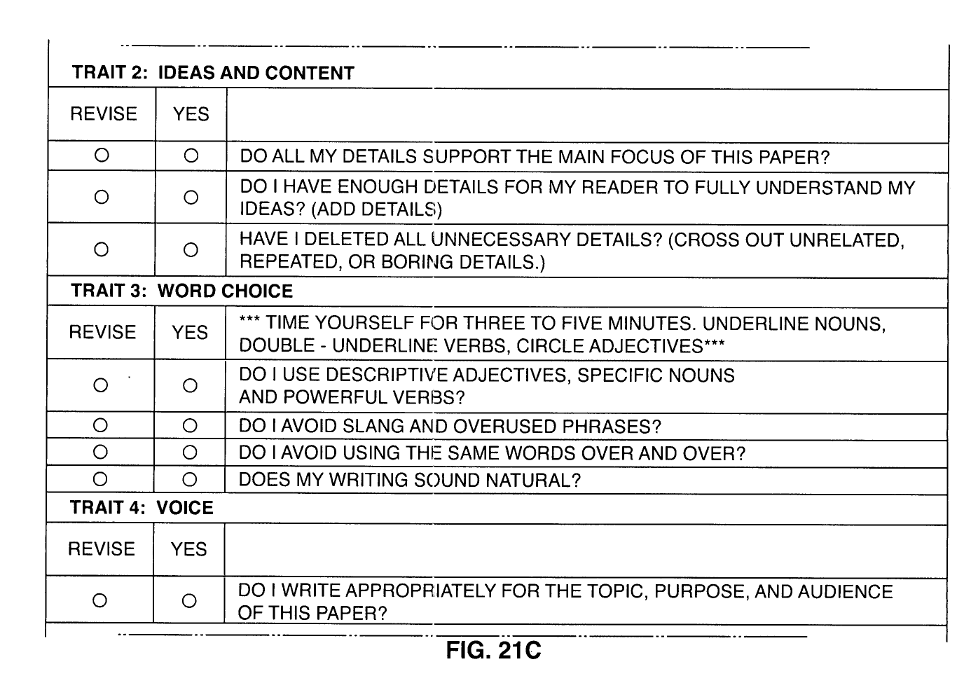

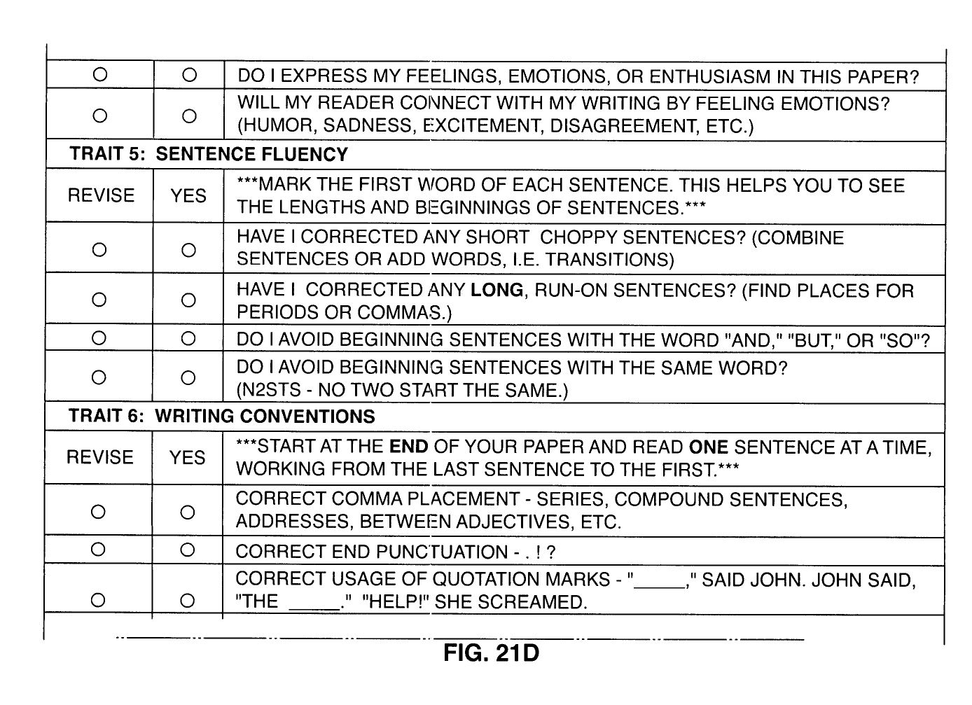

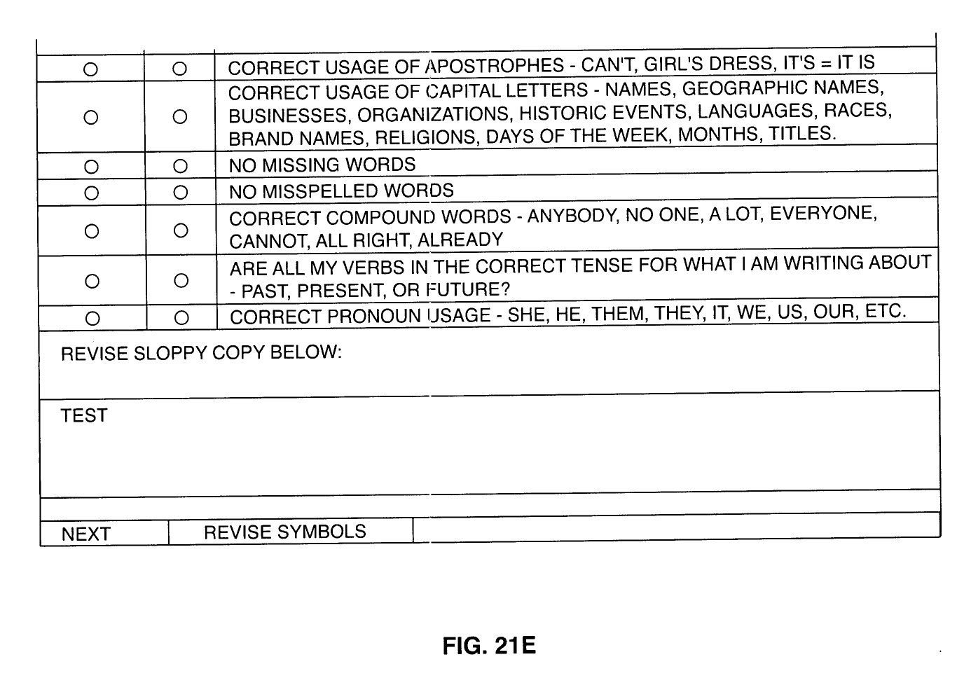

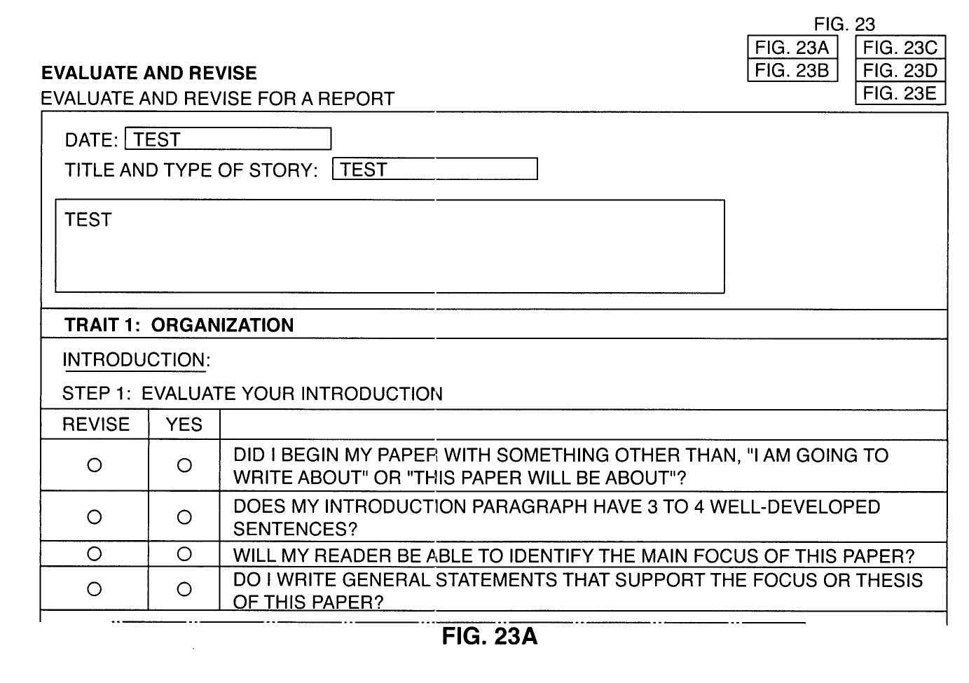

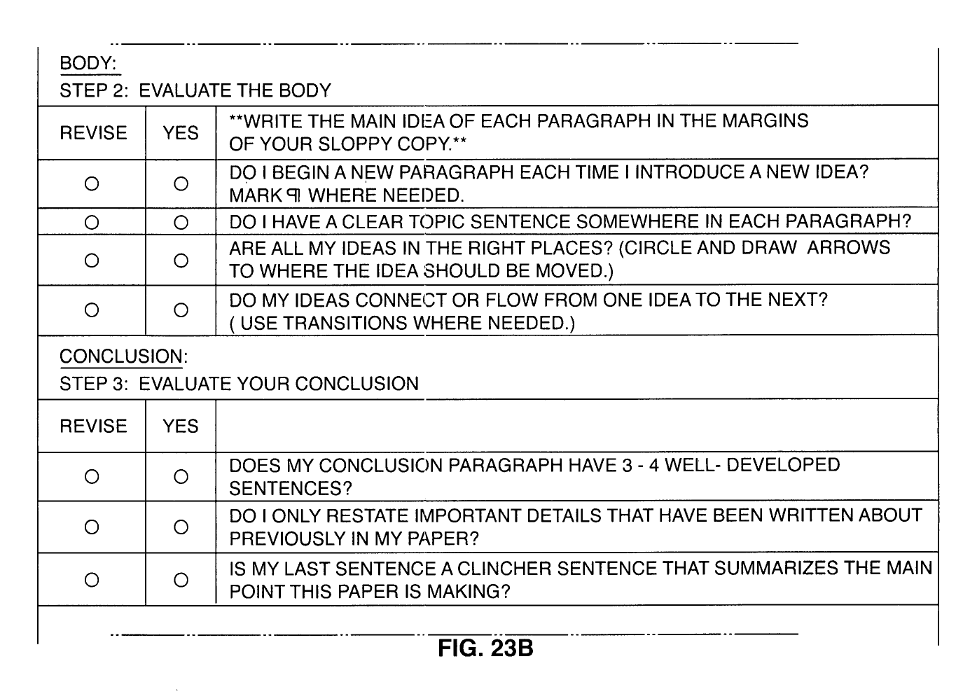

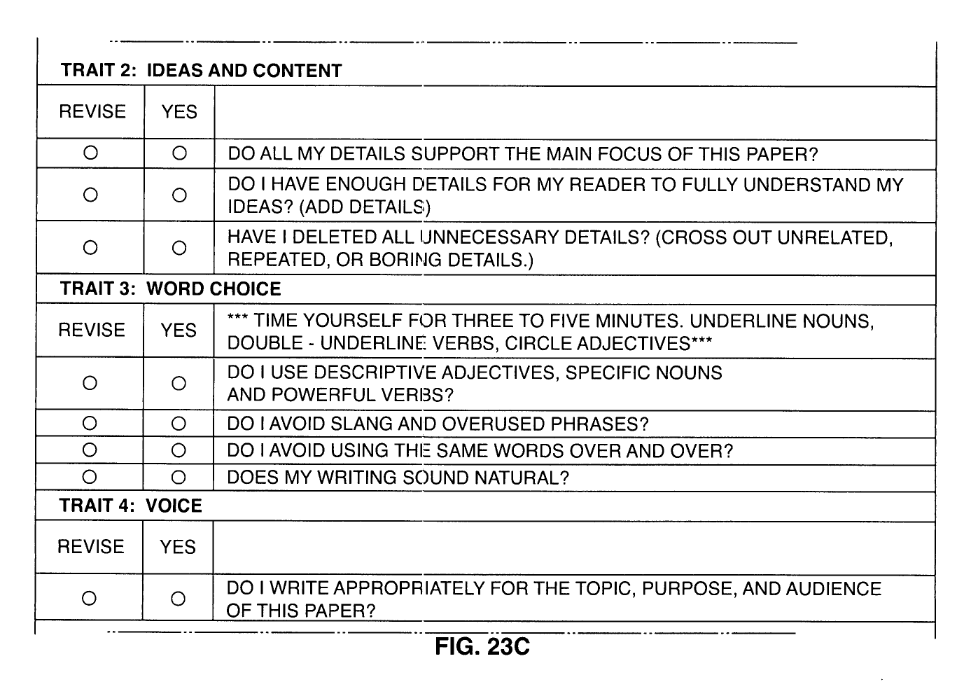

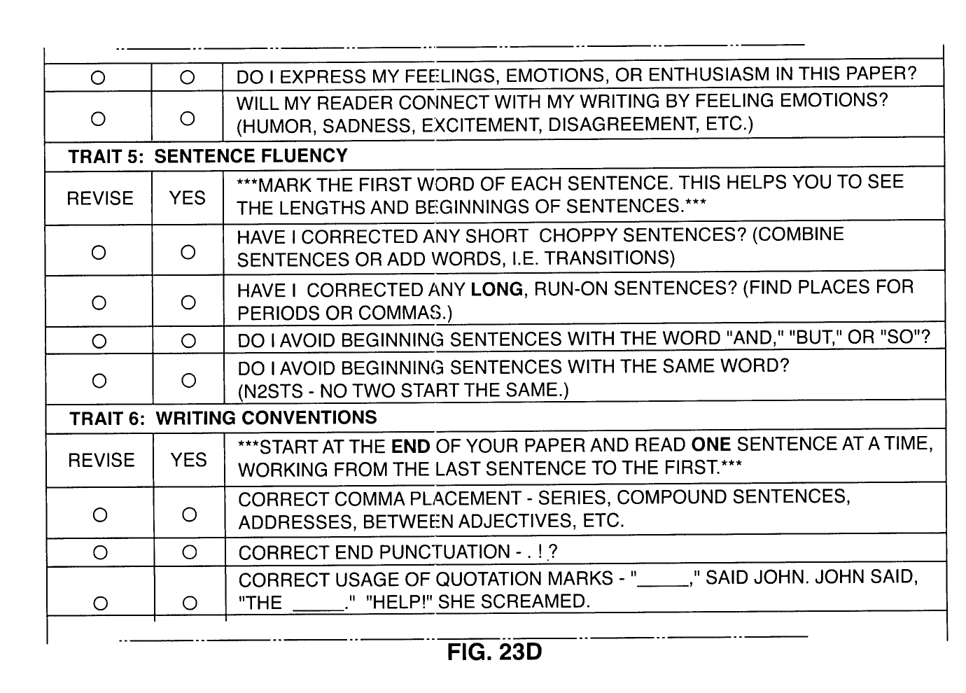

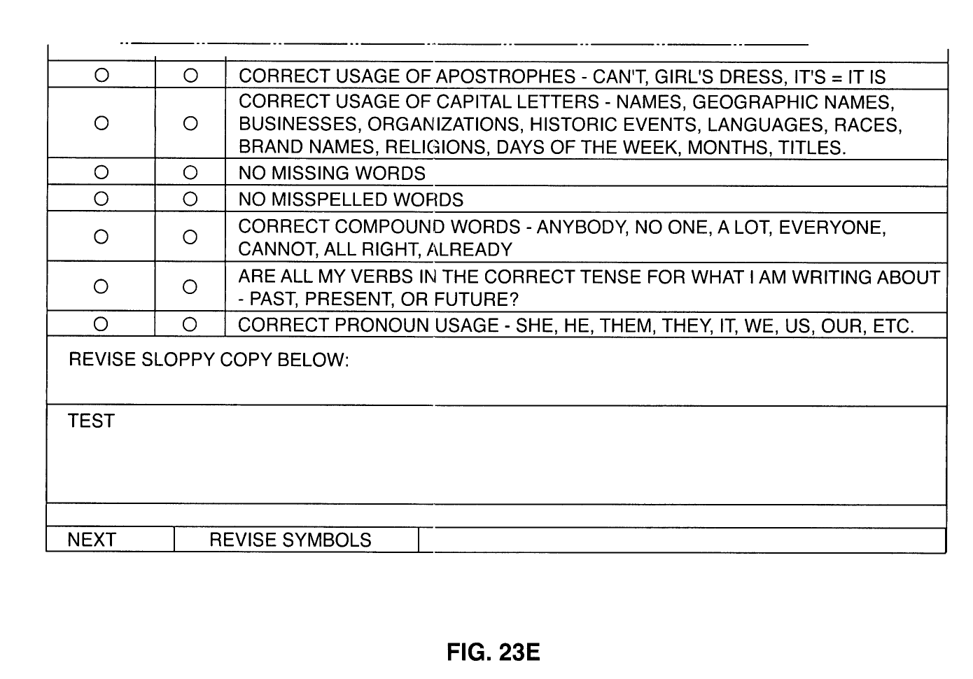

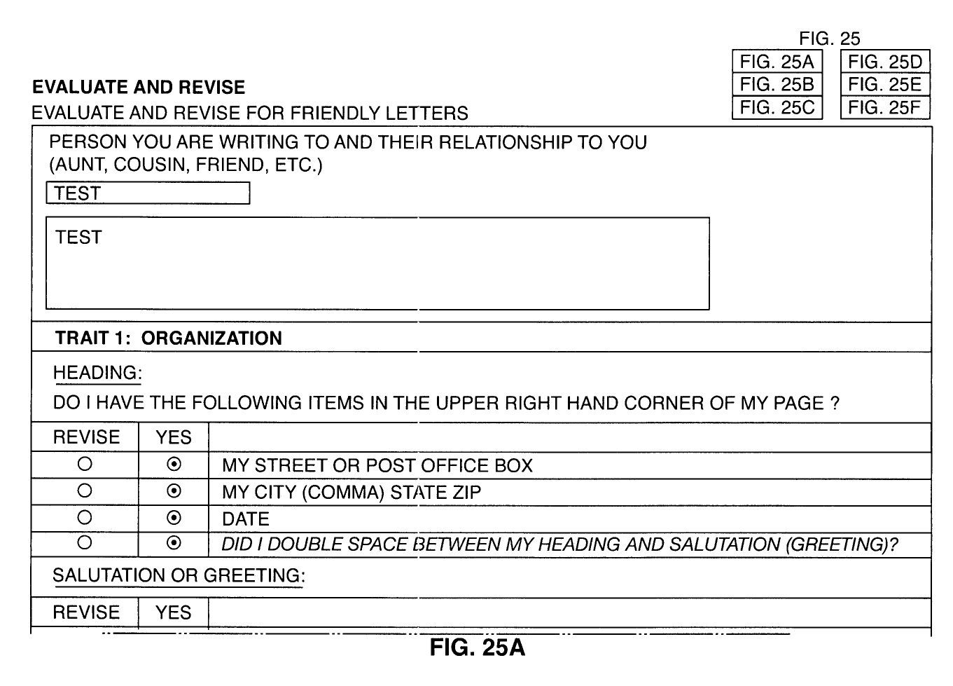

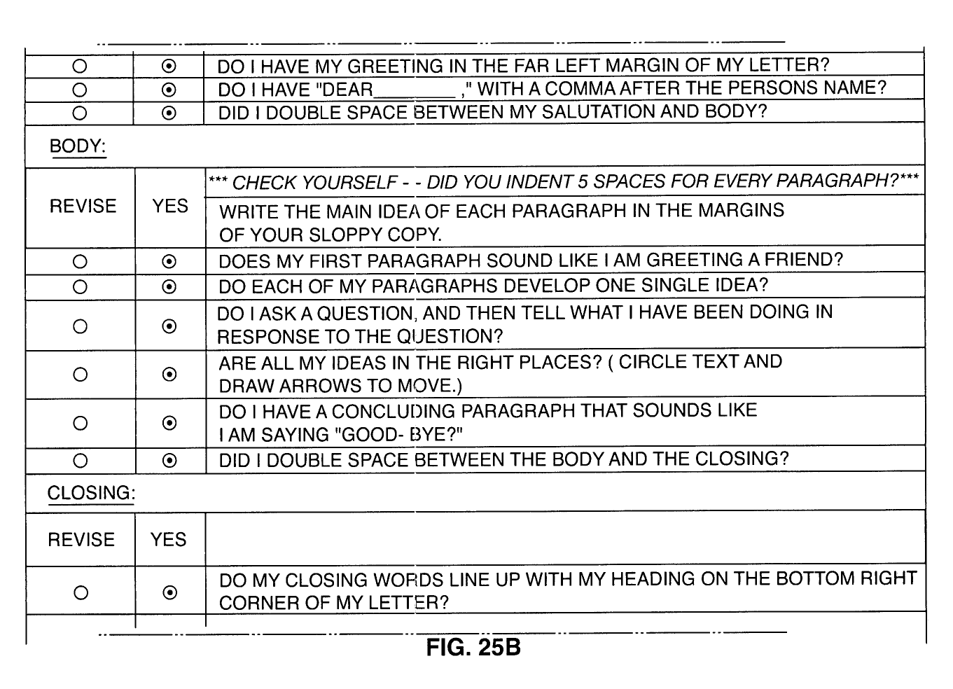

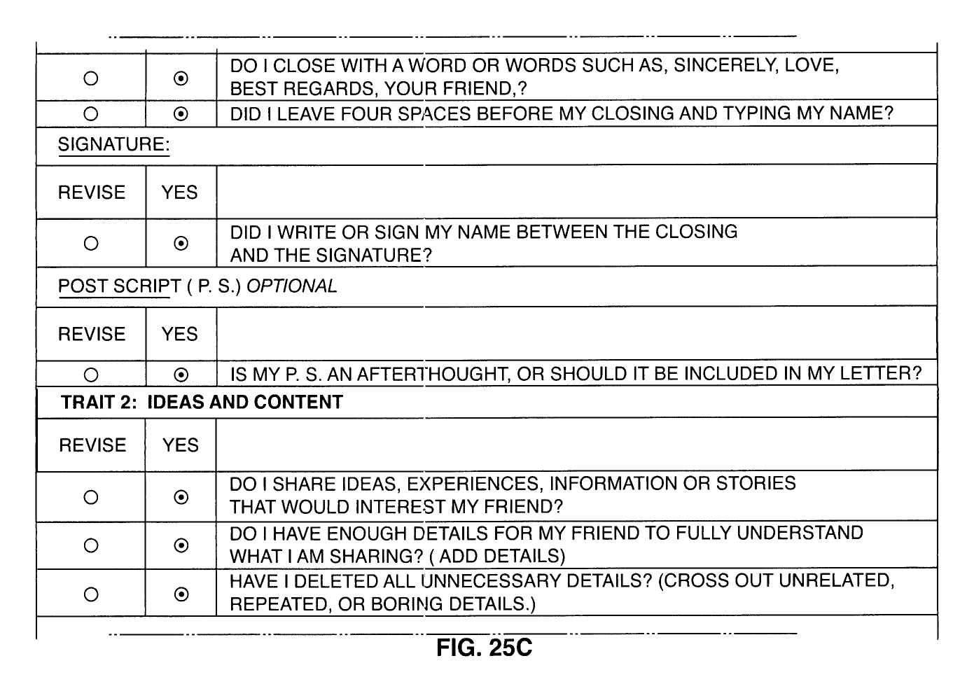

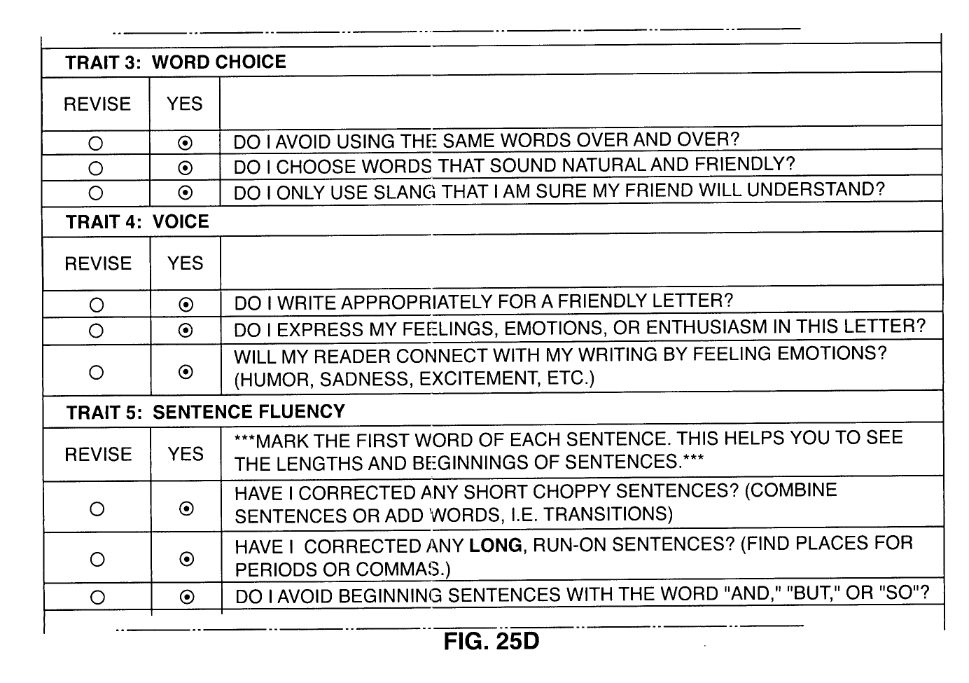

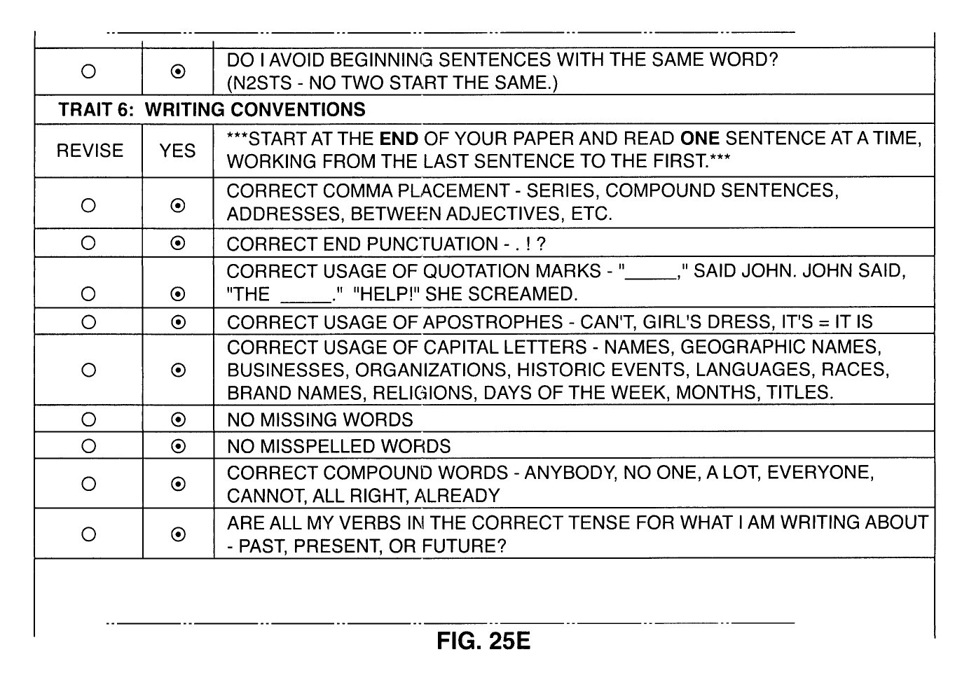

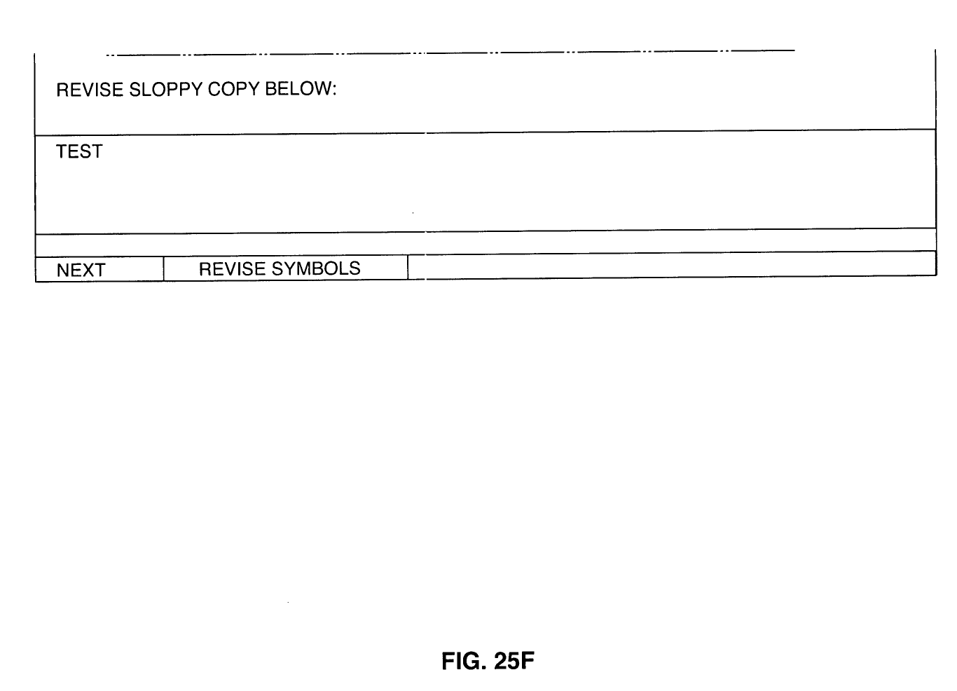

Similar web pages are provided for other nonpoetry writing options. Specifically, a web pages for the evaluate and revise step for a creative story is illustrated by FIGS. 17A and 17B, for a personal narrative is illustrated by FIGS. 19A-19B, for an essay or report is illustrated by FIGS. 21A-21B, for a report is illustrated by FIGS. 23A-23B, and for a friendly letter is illustrated by FIGS. 25A-25B

Again, as is the case with the poetry flow, the system can be configured so that the user's responses to the questions asked in connection with the evaluate and revise step have been validated. For example, the system can be configured so that the user cannot proceed past the evaluate and revise step until all questions are answer properly and/or correctly. For example, referring to FIG. 13A, if the user does not answer “yes” to the question “Does my introduction paragraph have 3-4 well-developed sentences,” the user will not be allowed to proceed unless and until the introduction paragraph poem does have 3-4 well-developed sentences and the user selects the “yes” option in answer to this question.

Returning to FIG. 1, after a user completes the evaluate and revise step (block 124) for the selected nonpoetry writing option, the user may continue to the next step in the processing logic, which is the wait step (block 126). The wait step prompts a user to wait and then review the revised draft. As discussed above, FIG. 8 is a screenshot to an exemplary web page displayed during the wait step, and the same web page for the wait step can be used for all writing options, both poetry and nonpoetry.

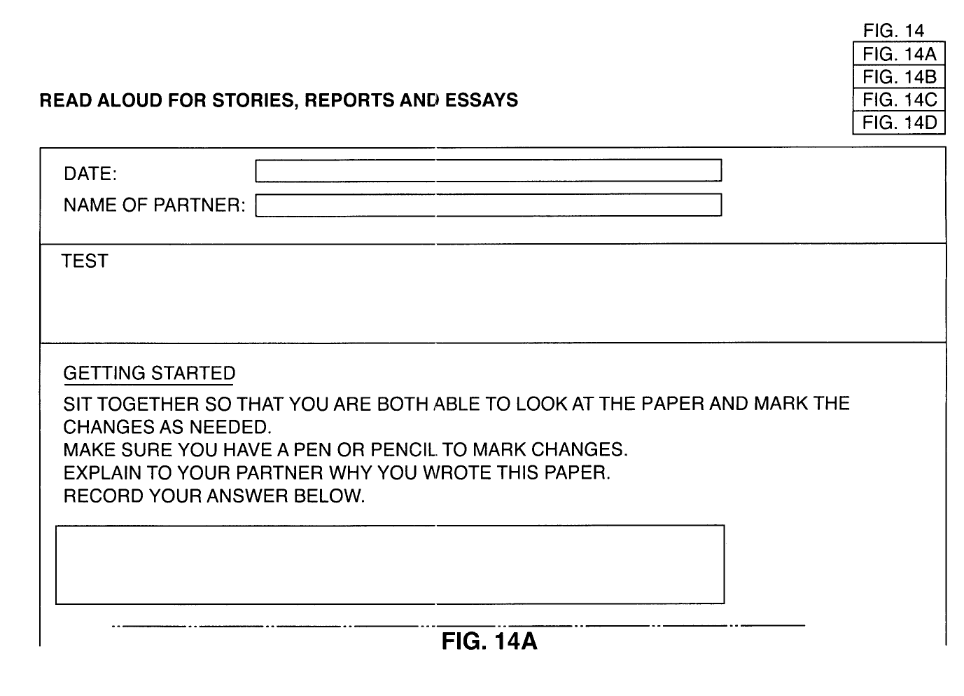

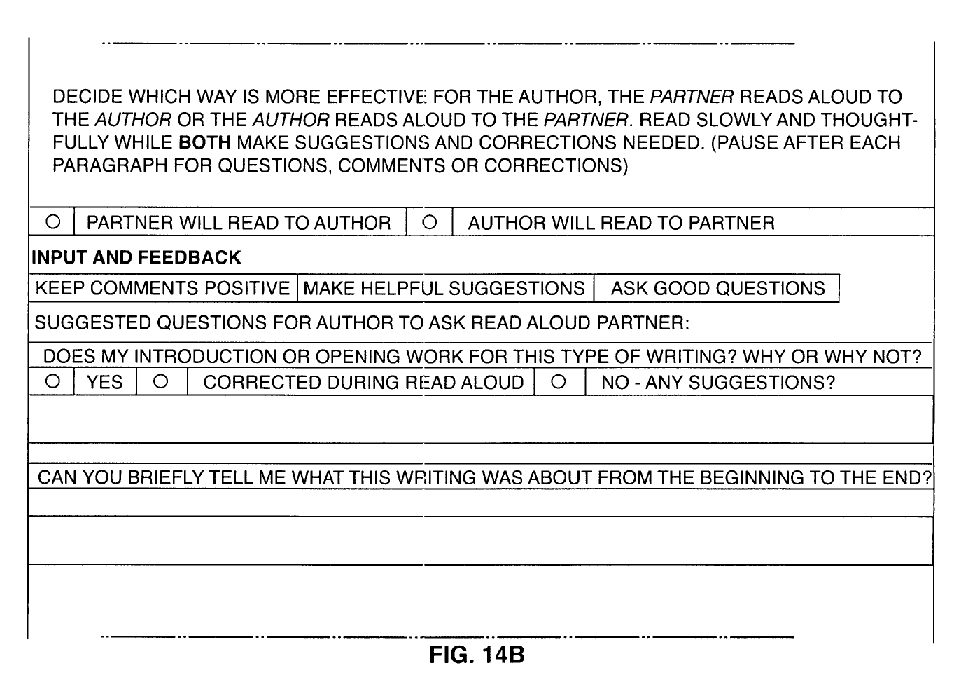

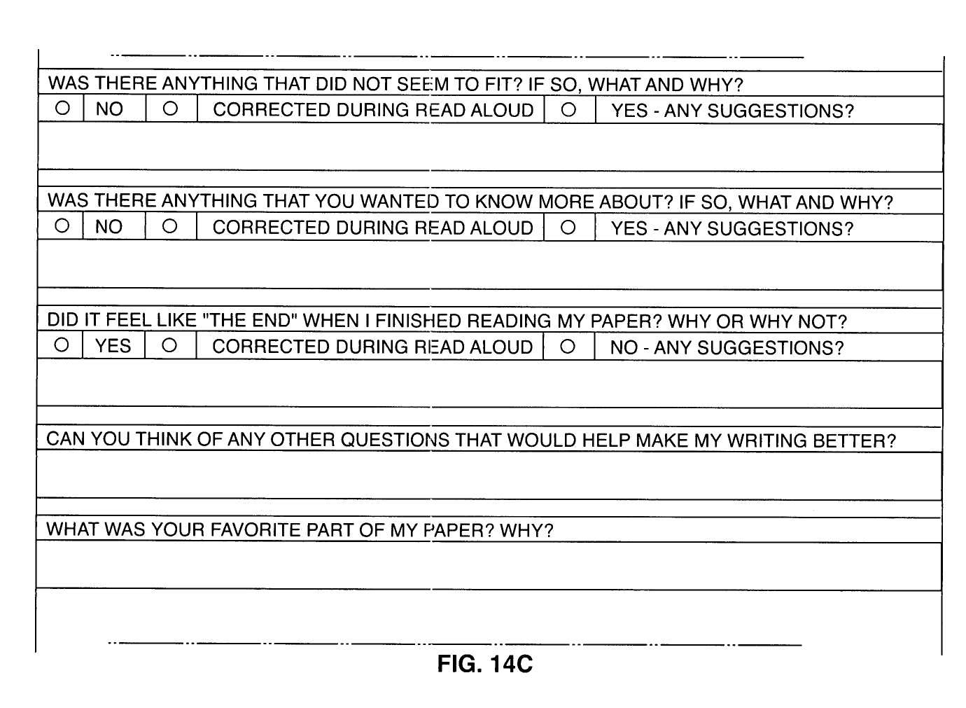

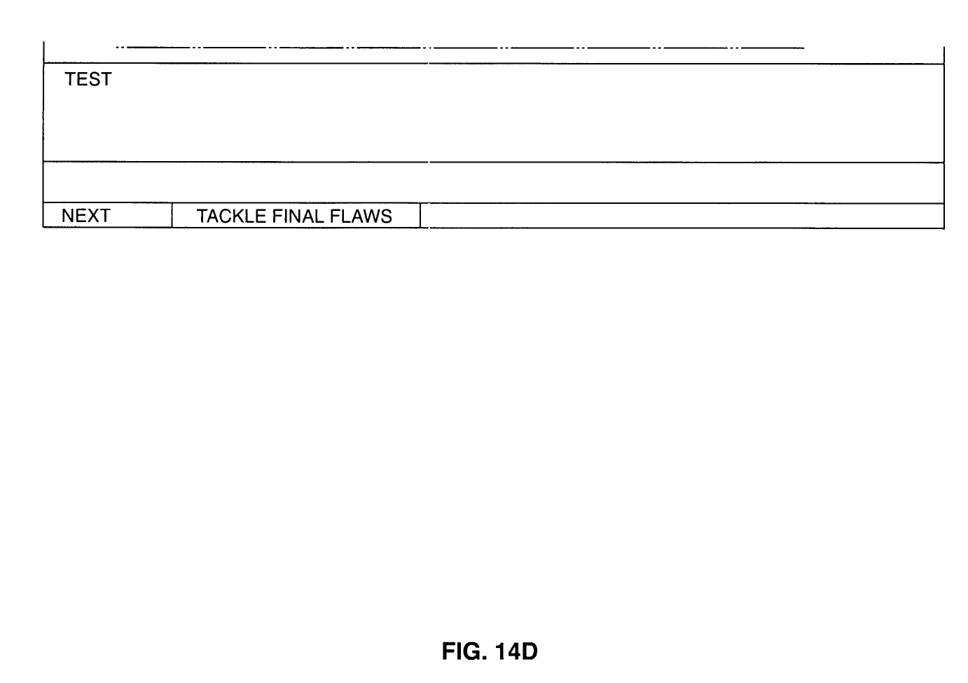

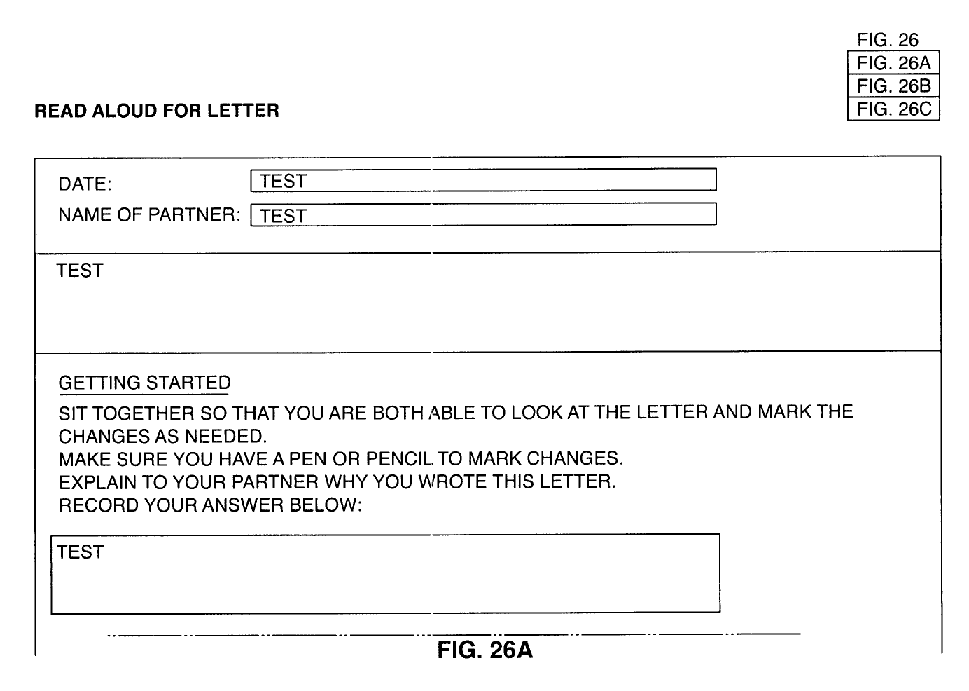

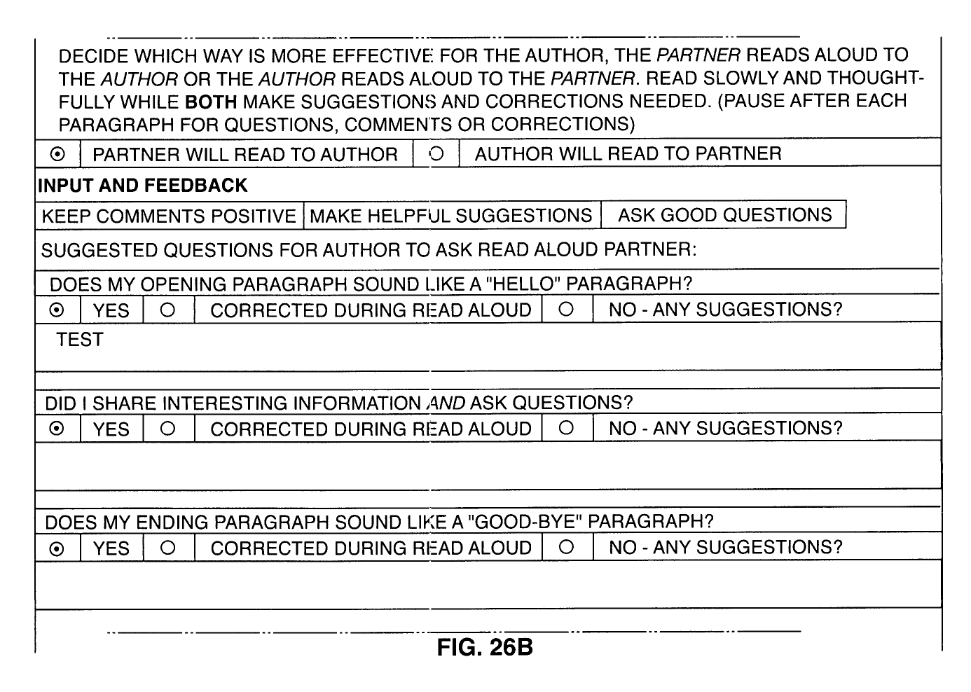

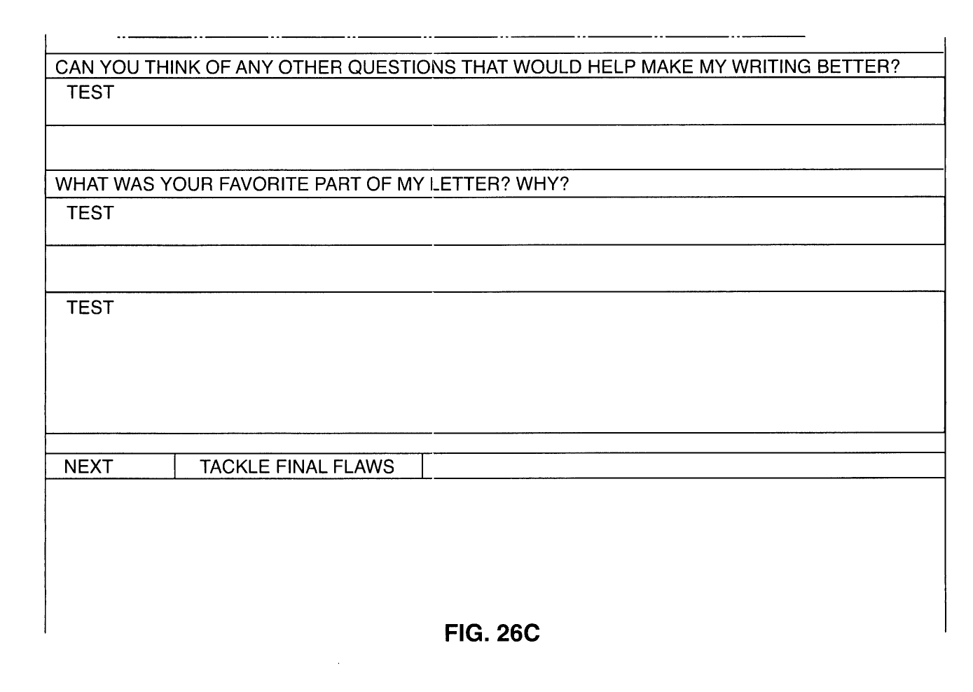

Returning to FIG. 1, after the wait step (block 126), the user may continue to the next step in the processing logic, which is the read aloud and input step (block 128). The read aloud and input step prompts the user to review the non grammatical aspects of the writing by reading the revised draft aloud to a partner and obtaining input and feedback from the partner based on a series of predetermined questions. FIG. 14 illustrates a screenshot of an exemplary web page for the read aloud and input step for nonpoetry writing options, i.e, essays, reports and stories. Correspondingly, FIG. 26 illustrates a screenshot of an exemplary web page for the read aloud and input step for a letter writing option.

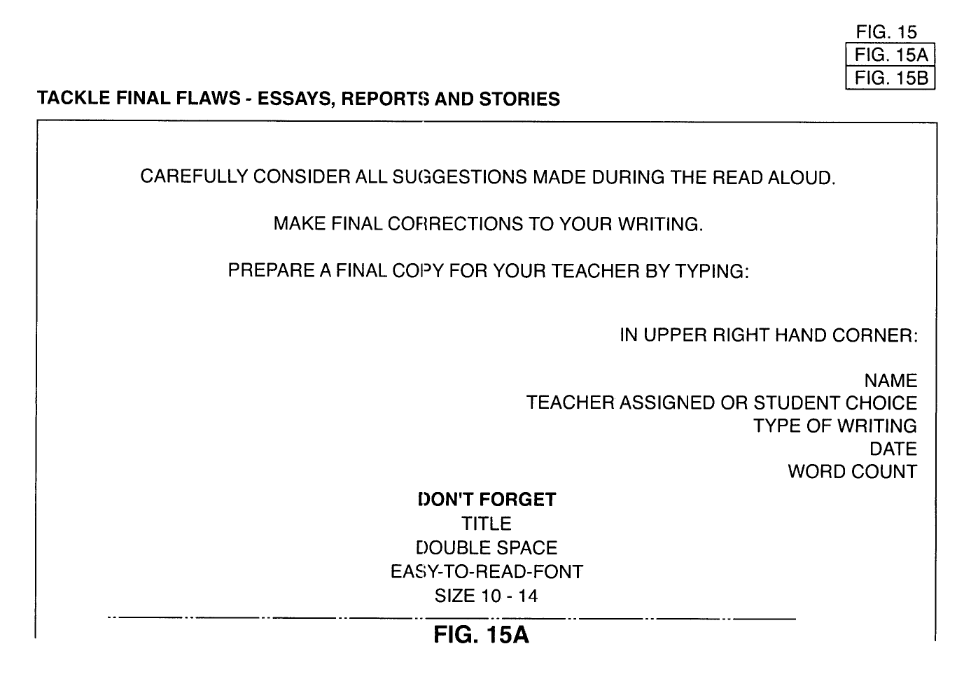

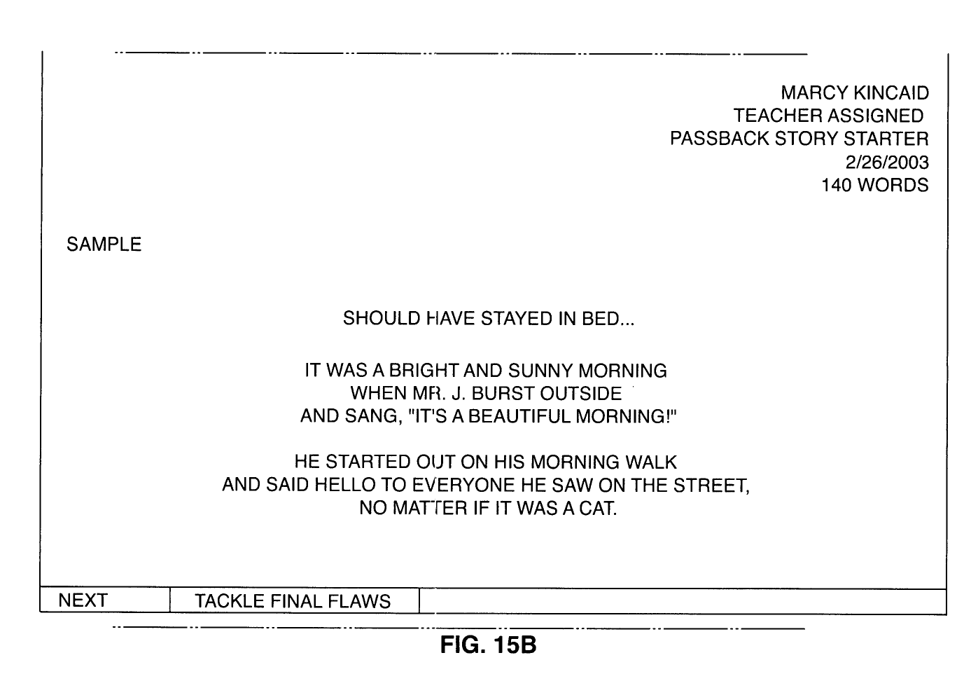

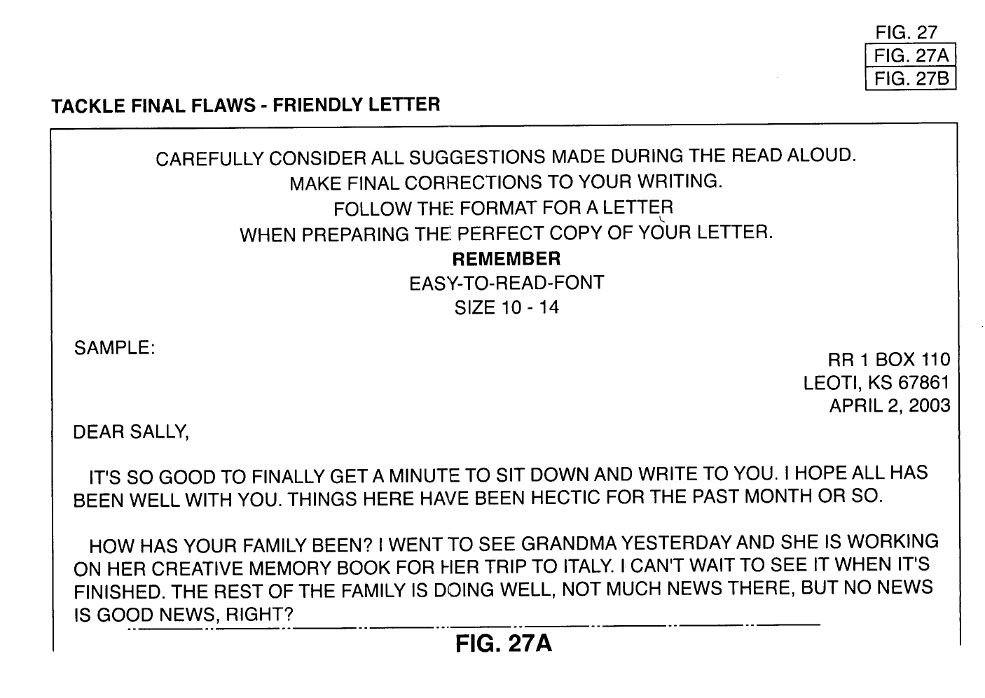

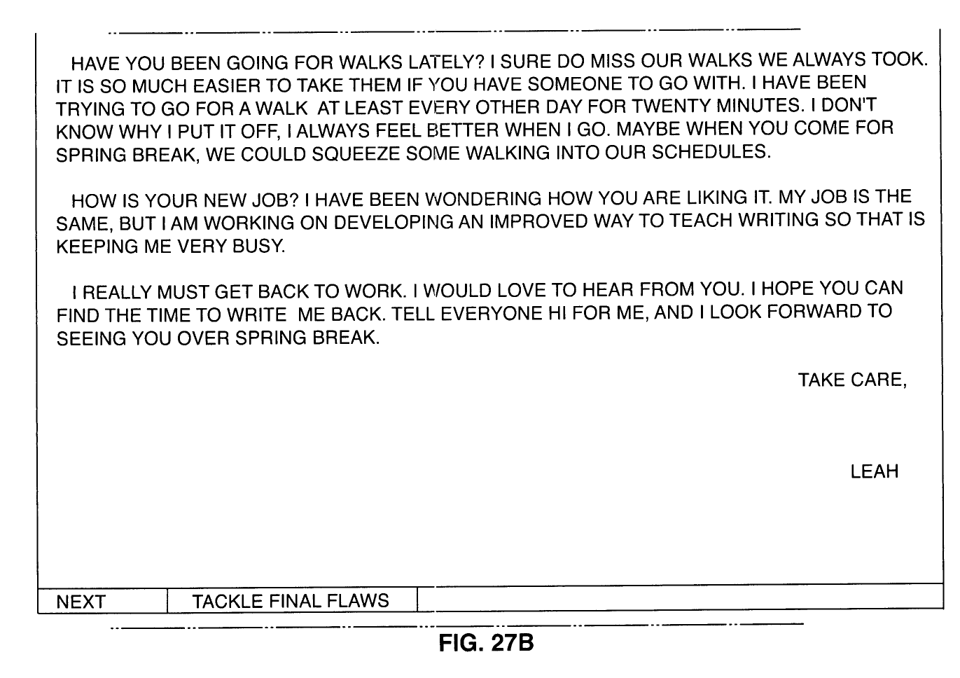

As can be seen from FIGS. 14 and 26, the read aloud and input web pages include a button for tackling final flaws. Selecting the tackle final flaws button may cause a pop up window to be displayed that reminds the user to make final corrections to the writing and to prepare a final draft. FIGS. 15 and 27 are screenshots of exemplary tackle final flaws windows for essays, reports and stories, and a letter, respectively. The tackle final flaws pop-up window also may include suggestions for formatting the final draft of the writing.

The system can be configured so that the user's responses to the questions asked in connection with the read aloud and input step have been validated. For example, the system can be configured so that the user cannot proceed past the read aloud and input step until all questions are answer properly and /or correctly. For example, referring to FIG. 2N, if the user does not provide an answer in response to the question “Does my introduction or opening work for this type of writing,” the user will not be allowed to proceed unless and until the user provides an answer to this question in the designated space.

Returning to FIG. 1, after the read aloud and input step (block 128), the user may continue to the next step in the processing logic, which is the end with perfect copy step (block 130). As discussed above, FIG. 11 is a web page for the end with perfect copy step, and the same web page for the wait step can be displayed for all writing options, both poetry and nonpoetry.

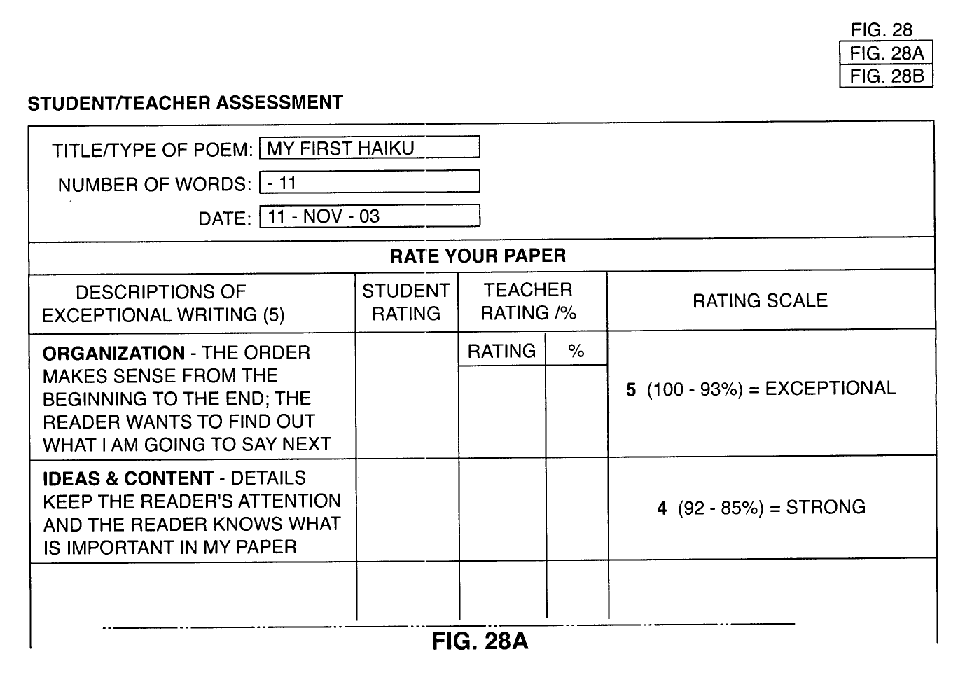

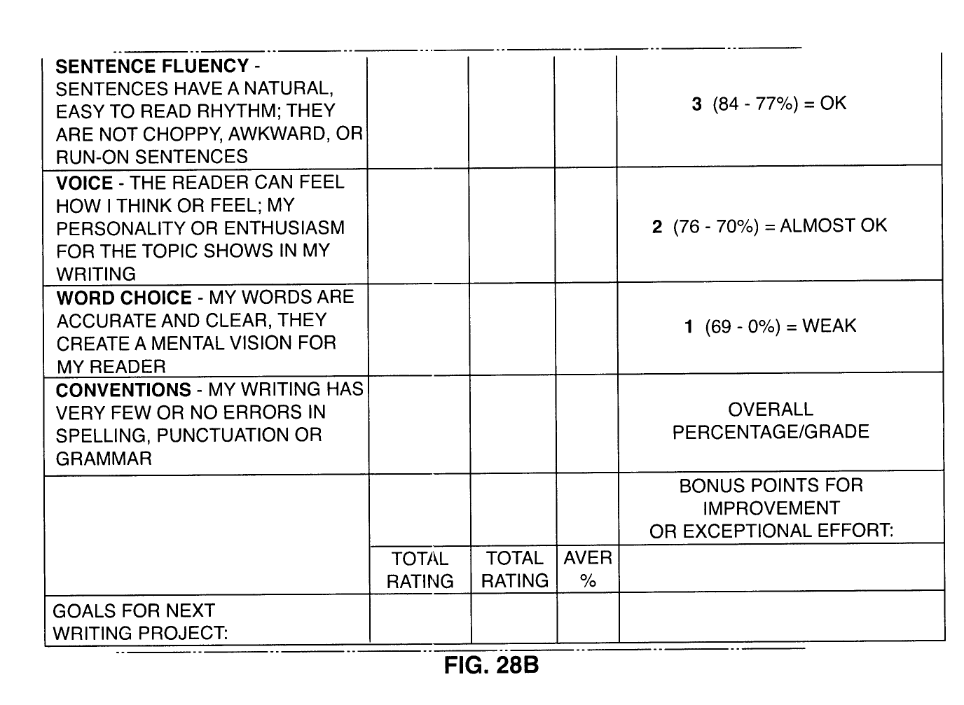

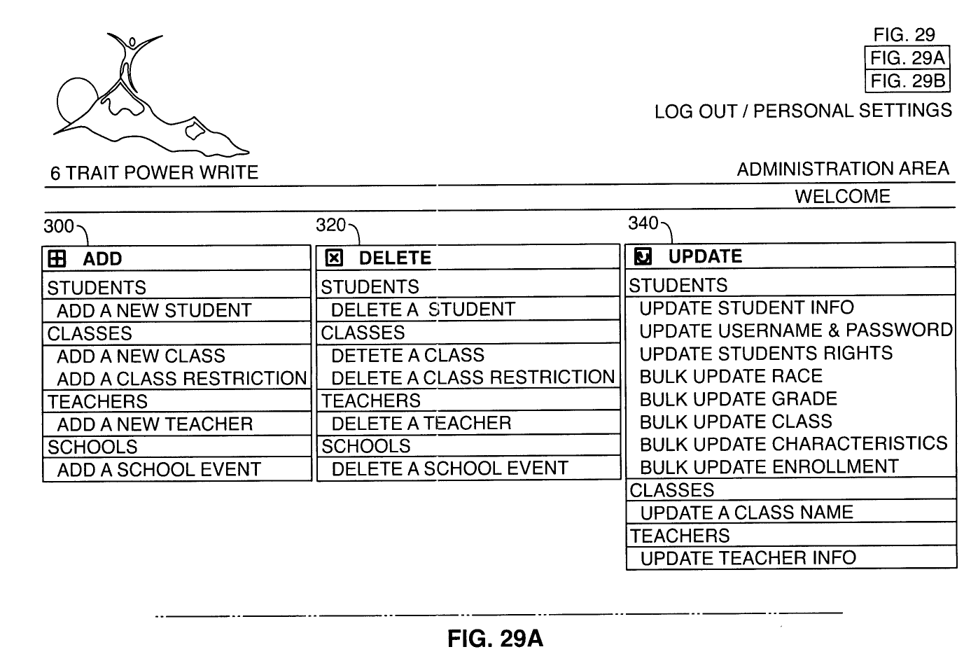

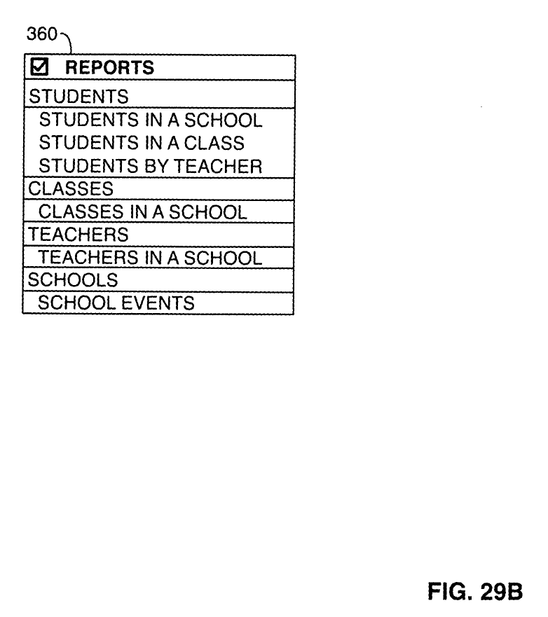

Returning to FIG. 1, after the end with perfect copy step (block 130), the user may continue to the next step in the processing logic, which is the student/teacher assessment step (block 132). FIG. 28 is a screen shot of a web page for the student/teacher assessment step. As illustrated in FIG. 28, the web page for the student/teacher assessment step allows for both a teacher and a user (i.e., student) to evaluate the organization, idea and content, sentence fluency, voice, word choice and conventions of the final daft of the writing using a 1-5 rating scale.

The system and method of the present invention may also include a tool box that includes examples of writing introductions, conclusions, and transitions.

The system and method of the present invention may also include a print feature that allows for printing of any static or dynamic web page. Preferably, a cascading style sheet layout is used to print web pages.

The system and method of the present invention further includes the capability of locally saving dynamic pages and/or user selections. This advantageously allows a user to stop working during the middle of an exercise and save the work product for later use. In an embodiment, the saved information can be stored on a remote host running a database application.

2. The User Management Component

The system and method of the present invention may also include a User Management Component for managing a plurality of users of the system and method of the present invention. The User Management Component may be accessed via a hyperlink on the main menu web page. FIG. 3 is a screenshot of an exemplary main menu to the User Management Component. As can be seen from FIG. 3, the User Management Component is comprised of an Add subcomponent 300, a Delete subcomponent 320, an Update subcomponent 340, and a Reports subcomponent 360. Typically, users such as students are not provided access to the User Management Component. Rather, the User Management Component is intended for access by teachers and/or school administrators in connection with the administration of the system and evaluation of students' writings.

After a setup administrator has accessed the User Management Component, the administrator may change the default class name and add all teachers who will be using the system. The administrator may optionally distribute login information to all added teachers.

There are at least three options for administering a plurality of students. Option 1 allows a Setup Administrator to create a plurality of users (i.e., students) and associate each of the users with a single, general class, for example, ABC School Students. Option 2 allows the Setup Administrator to create multiple classes and to enroll associate each of a plurality of users with one or more classes. Option 3 allows the Setup Administrator to create one or more teachers in a school, and each teacher can associate one or more students with one or more classes.

As shown in FIG. 3, the User Management component can be used to add or delete a student, a class or class restriction, a teacher or a school event. Information can be added via the Add subcomponent 300. If a user selects the Add a New Student link, an Add a Student web page is displayed that allows for the entry of student information, including name, sex, and date of birth. A student can be enrolled, i.e., associated with one or more classes in a school via the Add a Student web page. If a user selects the Add a New Class link, an Add a Class web page is displayed that allows for the entry of class information, including a class name. A listing of all current classes in a school may be displayed via the Add a Class web page. If a user selects the Add a Class Restriction link, an Add a Class Restriction web page is displayed that allows for the selection of a class to which a restriction is to be added. After selecting a class, the user can enter information as to the start and end dates of the restriction, the start time a user can login to the system, the time (in the evening) after which a user can no longer login to the system, and whether a user can login on Saturday and Sunday. A user can also delete a class restriction via the Add a Class Restriction web page. If a user selects the Add a New Teacher link, an Add a Teacher to a Class web page is displayed that allows for the entry of teacher information, including name, sex, date of birth and whether the teacher has administrative rights. A teacher can be associated with one or more classes in a school via the Add a Teacher to a Class web page. If a user selects the Add a School Event link, an Add a School Event web page is displayed that allows for the entry of school event information, including event name, and start and end dates.

A student, class, class restriction, teacher or school event, or any information related thereto, added via the links associated with the Add subcomponent 300 can be deleted via the Delete subcomponent 320.

Information related to a student, class, class restriction, teacher or school event added via the Add subcomponent 300 can be updated via the Update subcomponent 330. In addition, a student's username and password, which may be assigned automatically, can be updated via the Update Username and Password link of the Update subcomponent 330. A students' rights to change username and passwords and/or use a spell check feature on a school wide basis can be updated via the Update Students Rights link of the Update subcomponent 330. Information regarding class names and teacher information also may be updated via the Update a Class Name link and the Update Teacher Info link, respectively, of the Update subcomponent 330 of User Management Component. The User Management Component also allows for bulk entering or updating information regarding a student's race, grade, class or enrollment status via the Bulk Update Race link, the Bulk Update Grade link, the Bulk Update Class link and Bulk Update Enrollment link, respectively. Information regarding certain predefined characteristics of a student, such as whether the student is an ESL student, a free lunch student, a learning disabled student, a special education student, etc., also may be entered or updated in bulk via the Bulk Update Characteristics link. By “bulk update,” we mean updating information about more than one student, for example, without having to access the individual's student's information via a separate web page.

As seen in FIG. 3, various reports also may be accessed via the Reports subcomponent 360 of the User Management Component. For example, reports of students in a school, by class or by teacher can be generated via a Students in a School link, a Students in a Class link and a Students by Teacher link, respectively. Reports can also be generated listing classes in a school, teachers in a school and school events via the Classes in a School link the Teachers in a School link and the School Events link, respectively. The system can also provide usage reports for each student, for a predetermined time period, i.e., the last 30 days, as well a “rolling” usage reports.

The User Management Component also can be configured to generate reports as to active users (i.e., students) by school, class, teacher, etc.; active projects for a user, class or school; all projects opened and inactive for a given time period; most frequently revised or revisited sections; syllabus information; and information as to projects (and/or writing formats) that have been completed and those that have not been completed.

What is claimed is:

1. A method for teaching a writing process, comprising:
providing to a user a plurality of writing type options;
receiving from the user a writing type selection, wherein the writing type
selection is one of the plurality of writing type options;
receiving from the user a writing topic selection for the writing type selection.
receiving from the user a first draft about a writing topic selection;
providing guidance to the user for self evaluating the first draft;
prompting the user to revise the first draft responsive to the user's self
evaluation and receiving from the user a revised first draft about the selected topic;
prompting the user to wait a predetermined period of time;
prompting.the user to read aloud the revised first draft to a second person;
prompting the user to obtain feedback from the second person responsive to the reading aloud of the revised first draft;
prompting the user to prepare a final draft by revising the revised first draft responsive to the feedback obtained from the second person, and receiving from the user the final draft about the selected topic; and
storing the final draft.

2. The method of claim 1, further comprising, prior to the step of receiving a first draft, determining whether the writing topic selection is appropriate.

3. The method of claim 2, wherein appropriateness of the writing topic selection is determined by presenting to the user one or more questions relating to the appropriateness of the topic selection.

4. The method of claim 3, wherein the user's responses to the questions relating to the appropriateness of the writing topic selection are validated before the user self evaluates the first draft.

5. The method of claim 1, further comprising, prompting the user to self assess the final draft.

6. The method of claim 1, further comprising, prompting a teacher to assess the final draft.

7. The method of claim 1, wherein the plurality of writing options are selected from the group consisting of an essay, a story, a narrative, a report and a letter.

8. The method of claim 1, wherein the plurality of writing options are selected from the group consisting of a haiku, a diamante and a limerick.

9. The method of claim 1, wherein the guidance provided to the user for self evaluating the first draft comprises one or more questions relating to organization, ideas and content, word choice, voice, sentence fluency or writing conventions.

10. The method of claim 9, wherein the user's responses to the questions for self evaluating the first draft are validated before the user may proceed to the next step of the writing process.

11. A computer-based system for teaching a writing process, comprising:
a server program, wherein the server program is configured to
provide to a user a plurality of writing type options;
receive from the user a writing type selection, wherein the writing type selection is one of the plurality of writing type options;
receive from the user a writing topic selection for the writing type selection;
receive from the user a first draft about a writing topic selection;
provide guidance to the user for self evaluating the first draft;
prompt the user to revise the first draft responsive to the user's self evaluation and receive from the user a revised first draft about the selected topic;
prompt the user to wait a predetermined period of time;
prompt the user to read aloud the revised first draft to a second person;
prompt the user to obtain feedback from the second person responsive to the reading aloud of the revised first draft;
prompt the user to prepare a final draft by revising the revised first draft responsive to the feedback obtained from the second person, and receive from the user the final draft about the selected topic; and
store the final draft; and
at least one client program, where in the at least one client program is in electronic communication with the server program via a network.

12. A computer readable medium containing a computer software for teaching a writing process, the computer software comprising program instructions that
provides to a user a plurality of writing type options;
receives from the user a writing type selection, wherein the writing type selection is one of the plurality of writing type options;
receives from the user a writing topic selection for the writing type selection;
receives from the user a first draft about a writing topic selection;
provides guidance to the user for self evaluating the first draft;
prompts the user to revise the first draft responsive to the user's self evaluation and receives from the user a revised first draft about the selected topic;
prompts the user to wait a predetermined period of time;
prompts the user to read aloud the revised first draft to a second person;
prompts the user to obtain feedback from the second person responsive to the reading aloud of the revised first draft;
prompts the user to prepare a final draft by revising the revised first draft responsive to the feedback obtained from the second person, and receives from the user the final draft about the selected topic; and
stores the final draft.

13. A computer-based system for teaching a writing process to a plurality of students, comprising:
a writing process component, wherein the writing process component receives a writing topic selection from the user for a predefined writing type;
determines whether the writing topic selection is appropriate;
receives from the user a first draft about the writing topic selection;
guides the user to self evaluate the first draft;
determines whether the user has properly self evaluated of the first draft;
receives from the user a revised first draft about the selected topic, wherein the first draft is revised responsive to the user's self evaluation of the first draft;
prompts the user to obtain feedback from a second person responsive to a reading aloud of the revised first draft;
receives from the user a final draft about the selected topic, wherein the revised first draft is finalized responsive to the feedback obtained from the second person; and
a user management component for managing a plurality of users.

14. The system of claim 13, wherein the plurality of users is managed by associating one or more users with one or more classes.

15. The system of claim 13, wherein the plurality of users is managed by associating one or more users with one or more teachers.

16. The system of claim 15, wherein the plurality of users is managed by associating each of the one or more teachers with one or more classes.

17. The system of claim 13, wherein the plurality of users is managed by adding, deleting or updating student information, teacher information or class information.

18. The system of claim 13, wherein the plurality of users is managed by providing reports containing student information, teacher information or class information.

19. The system of claim 18, wherein the student information is comprised of student identifying information for each of the plurality of students and information identifying each class in which each of the plurality of students is enrolled.

20. The system of claim 18, wherein the teacher information is comprised of teacher identifying information for one or more teachers and information identifying each class that each of the one or more teachers teaches.

21. The system of claim 18, wherein the class information is comprised of class identifying information and class restriction information for one or more classes.

22. The system of claim 21, wherein the class restriction information is comprised of information identifying times during which students enrolled in a class are restricted from accessing the writing process component.

23. A method for teaching a writing process, comprising:
receiving a writing topic selection from the user for a predefined writing type;
determining whether the writing topic selection is appropriate;
receiving from the user a first draft about the writing topic selection;
guiding the user to self evaluate the first draft;
determining whether the user has properly self evaluated of the first draft;
receiving from the user a revised first draft about the selected topic, wherein the first draft is revised responsive to the user's self evaluation of the first draft;
prompting the user to obtain feedback from a second person responsive to a reading aloud of the revised first draft;
receiving from the user a final draft about the selected topic, wherein the final draft is prepared by a user responsive to the feedback obtained from the second person.

24. The method of claim 23, further comprising, prior to receiving a writing topic selection, receiving from the user a writing type selection, wherein the writing type selection is selected from one of a plurality of writing type options that are provided to the user.

25. The method of claim 23, wherein the writing topic selection is received from the user responsive to presenting to the user a plurality of writing topics.

26. The method of claim 23, further comprising the step of storing the final draft.

27. The method of claim 23, further comprising, prior to the step of prompting the user to obtain feedback, prompting the user to wait a predetermined period of time before proceed to the next step of the writing process.

28. A computer-based system for teaching a writing process, comprising:
a server program, wherein the server program is configured to receive a writing topic selection from the user for a predefined writing type;
determine whether the writing topic selection is appropriate;
receive from the user a first draft about the writing topic selection;
guide the user to self evaluate the first draft;
determine whether the user has properly self evaluated of the first draft;
receive from the user a revised first draft about the selected topic, wherein the first draft is revised responsive to the user's self evaluation of the first draft;
prompt the user to obtain feedback from a second person responsive to a reading aloud of the revised first draft;
receive from the user a final draft about the selected topic, wherein the final draft is prepared by the user responsive to the feedback obtained from the second person.; and
at least one client program, where in the at least one client program is in electronic communication with the server program via a network.

29. A computer readable medium containing a computer software for teaching a writing process, the computer software comprising program instructions that
receives a writing topic selection from the user for a predefined writing type;
determines whether the writing topic selection is appropriate;
receives from the user a first draft about the writing topic selection;
guides the user to self evaluate the first draft;
determines whether the user has properly self evaluated of the first draft;
receives from the user a revised first draft about the selected topic, wherein the first draft is revised responsive to the user's self evaluation of the first draft;
prompts the user to obtain feedback from a second person responsive to a reading aloud of the revised first draft; and
receives from the user a final draft about the selected topic, wherein the final draft is prepared by the user responsive to the feedback obtained from the second person.
